(19) United States
(12) Patent Application Publication
(10) Pub. No.: US 2023/0176535 A1
(43) Pub. Date: Jun. 8, 2023

(54) AUTONOMOUS CONTROL OF COMPLEX ENGINEERED SYSTEMS

(71) Applicant: OptumSoft, Inc., Vero Beach, FL (US)

(72) Inventor: David R. Cheriton, Vero Beach, FL (US)

(21) Appl. No.: 17/978,869

(22) Filed: Nov. 1, 2022

Related U.S. Application Data
(60) Provisional application No. 63/287,342, filed on Dec. 8, 2021.

(51) Int. Cl. G05B 15/02

(52) U.S. Cl. CPC G05B 15/02

(57) ABSTRACT

A decided sequence of steps selected from a set of sequences of steps defined for a control system is executed to effect control of by writing a control variable to an actuator. At each timestep, it is redecided whether the decided sequence of steps or an alternate sequence of steps is to be executed.

### CROSS REFERENCE TO OTHER APPLICATIONS

This application claims priority to U.S. Provisional Patent Application No. 63/287,342 entitled AUTONOMOUS CONTROL OF COMPLEX ENGINEERED SYSTEMS filed Dec. 8, 2021 which is incorporated herein by reference for all purposes.

### BACKGROUND OF THE INVENTION

Complex engineered systems, such as those involved in piloting an air-based vehicle, water-based vehicle, space-based vehicle, or ground-based vehicle, were designed for manual/human control. Humans may make operator errors due to the monotony of controlling such systems, inexperience with controlling such systems, and/or human impairment in controlling such systems. Humans may also be inefficient at control because of poor training or impairment. Partial or full autonomous control of complex engineered systems may improve safety, reliability, quality, and/or efficiency for such systems by reducing the need for human involvement, and/or may reduce the cost of running such systems.

### BRIEF DESCRIPTION OF THE DRAWINGS

Various embodiments of the invention are disclosed in the following detailed description and the accompanying drawings.

FIG. 1 is a functional diagram illustrating a programmed computer/server system for autonomous control of complex engineered systems in accordance with some embodiments.

FIG. 2 is a block diagram illustrating an embodiment of a control system as connected into the controlled system, with sensor input and control outputs to actuators.

FIG. 3A is a block diagram illustrating an embodiment of a control system structured as multiple decoupled control systems, one per actuator.

FIG. 3B is a block diagram illustrating an embodiment of a control system structured as less decoupled.

FIG. 4A is a block diagram illustrating an embodiment of a control system with a temporal sequencer and immediate redecider structure.

FIG. 4B is a block diagram illustrating an embodiment of a control system with a partially decoupled TSIR structure.

FIG. 5 is an illustration of an example timeline of a redecider deciding a temporal sequence at each timestep.

FIG. 6 illustrates a tile-based implementation for a simplified three-input/three-dimensional system with inputs labelled X-in, Y-in and Z-in.

FIG. 7 is a flow diagram illustrating an embodiment of a process to select a tile on a timestep.

FIG. 8 is an illustration of boundary tiles for a simplified example of an autonomous aircraft with input logical object “Cruise”.

FIG. 9 is a block diagram illustrating an embodiment of a redecider realized using multiple tilesets.

FIG. 10 is an illustration of an overlap region between take-off and climb for an autonomous aircraft.

FIG. 11 is an illustration of an embodiment of redecider/sequencer pairs structured as a hierarchy.

FIG. 12 is an illustration of a portion of a decision tree mapping inputs to an associated tile label.

FIGS. 13A and 13B are a flow diagram illustrating an embodiment of a process of generating a decision tree from a tileset.

FIGS. 14A and 14B are a flow diagram illustrating an embodiment of a process of extending an input range.

FIG. 15 is an illustration of input dimension range extension.

FIG. 16 is a flow diagram illustrating an embodiment of a process of adding an input to a tileset.

FIG. 17 is an illustration of delegation to simplify complex control.

FIG. 18 is an illustration of a temporal sequencer-immediate redecider delegation-based control to simplify complex control.

FIG. 19 is an illustration of a redecider-sequencer time line.

FIG. 20 is a flow diagram illustrating an embodiment of a process for autonomous control of complex engineered systems.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An engineered system as referred to herein is a physical system that is carefully designed to perform a specific task reliably and efficiently. Each task may be categorized as designed to achieve a logical objective, as required by the application requirements. A logical objective as referred to herein is one of a small number of discrete objectives or goals that the controlled system/engineered system is designed be able to accomplish.

For example, with an autonomous air-based vehicle such as an aircraft, a logical objective is “transit from current airport to airport B”. It is logical in the sense that it is not a specific action or numeric control value but indicates what the control system needs to accomplish. As another example, a lower-level logical objective for an aircraft is the objective of “achieve take-off airspeed”. It is also logical in the sense that it is not a specific numeric value but rather tied to the objective of being able to lift-off from the runway. The exact numeric value is dependent on many factors, including the number of passengers, cargo, altitude of the runway, and even temperature and these factors can also affect the time it takes to achieve this objective. The term objective is used herein because the controller is instructed on what to try to achieve, that is the objective, not “how” to perform this task to achieve said objective.

A complex engineered system as referred to herein reacts to its environment and to faults in sophisticated ways and has multiple actuators that may be controlled to achieve the overall application objectives. For example, an aircraft has actuators to control the power to the engine, the ailerons, the elevators, the rudder, the flaps, the brakes, the landing gear, and possibly other actuators, all required to be controlled to fly the aircraft properly. It also has to react to changes in its environment, such as other traffic in the area, and not simply “shut down”. By contrast, a furnace is an engineered system designed to efficiently heat a given enclosed space. However, this is a simpler complex system because it has essentially one control or actuator, namely to turn the furnace on or off, and just reacts to its environment by turning on and off.

An engineered system is designed with a specified operating domain and thus may be expected in general to have what is referred to herein as a normal mode or normal modes during which it is carrying out its task. For example, autonomous air-based, water-based, and ground-based vehicles are all designed to transport people and/or goods. For each of these applications, the normal mode is cruising between the starting point and the destination. Similarly, a manufacturing line is designed to produce a large number of a given product so the normal mode is when the manufacturing line is running smoothly. That is, the normal mode is the state in which it is performing this task without interference from exception conditions, such as faults. This normal mode is specified as part of the engineering design process.

An engineered system is typically designed to allow manual control, which as referred to herein is manual operation by the setting of controls by a human. This manual operation requirement means that it is engineered to allow predictable, stable, and accurate control. In particular:
1. there is a predictable model of control within its defined operating domain;
2. in its typical operating domains, it is stable, that is, small changes in inputs do not require immediate significant changes in the control. That is, as referred to herein, it mostly exhibits continuous behavior; and
3. the exceptions to the normal case, referred to herein as discontinuities or singularities, are properly characterized, relatively small in number, known to the operator/control system designer, and often characterized by operational constraints to avoid these singularities.

With an aircraft as an example, predictability means, for example, that increasing the angle-of-attack increases the rate of climb. To illustrate stability in this example, small changes in the pitch or airspeed do not require sudden changes in the controls. As an example of a singularity in this domain, when the airspeed is low relative to the angle-of-attack, the aircraft is going to stall. The stall conditions are well-known to the aircraft designer and to the pilot and are an example of an exception to the normal case of smooth behavior because the lift from the wings immediately drops.

Note that if there were a large number of such singularities or the singularities were not known, a human operator would be unable to reliably operate the controlled system. Stated another way, the operating domain in which the controlled system is predictable and stable and the prediction is known and the domain in which its behavior is unpredictable or discontinuous is also known.

Beyond this basic characterization of predictability, there is typically some means of predicting the behavior of the engineered system in more detail, that is more accurately. This more accurate prediction may be based on mathematical formulae and/or computer simulation. For example, in the case of an aircraft, simulation of the aircraft that is sufficiently accurate is needed to validate the design before manufacture and later to train human pilots, that is, an associated flight simulator. That is, this detailed simulation is an important part of the engineering process as well as the training of the control system to a pilot.

Automatic control of a system reduces the cost of running the system and often improves the reliability and efficiency by reducing the need for human involvement. For a simple familiar example, a thermostat automatically controls a heating system to turn the furnace on when the temperature is low and turn the furnace off when the temperature is high enough without requiring human involvement. Manually operating even this simple system would cost time and effort and would likely be less efficient.

As a more complex example, an airplane autopilot reduces the demands on the pilot during normal flight and often improves the efficiency of the airplane in flight. It may also provide better/safer operation during low-visibility landings. A fully autonomous aircraft would eliminate the overhead of having a pilot altogether. However, these benefits rely on the automatic control functioning correctly in all situations in its operating domain and calling for, and allowing for, intervention by an operator when outside of its operating domain.

In non-trivial systems, testing ensures correct and safe operation. It is established best practice to design software for testability, sometimes referred to as test-driven development. This is similar to the hardware notion of design for testability. With safety-critical systems such as with an autonomous aircraft, extensive testing is important. In fact, aerospace standards such as DO-178B/C “Software Considerations in Airborne Systems and Equipment Certification” specify testing and documentation to be provided in order to achieve certification as avionics software.

The complex control systems of interest herein are ones that support “autonomous” operation. An autonomous control system as referred to herein is a system able to operate without intervention over a significant operating domain such that the system may detect when it is outside its operating domain, and enable intervention when it is outside that domain. For example, with an aircraft, the operating domain is often referred to as its “flight envelope”.

This definition of “autonomous” differs from a dictionary definition because an engineered system is realized to perform a task or tasks and rarely has “free will”. Therefore, it is designed for human intervention to first define the task or tasks it is to perform. For example, an autonomous aircraft should be instructed on where to fly.

Also, an engineered system may have internal failures or experience external conditions that it is not able to handle. These are cases that call for human intervention during the operation of the controlled systems. The control system should be able to take the system into some safe state, if at all possible, when it ends up outside its operating domain, allowing time for the operator to be notified and take control, except in the case of catastrophic situations. The advances in computer technology and reduction in costs of this computing and sensors have made autonomous control cost-effective for many applications with disclosed techniques to structure software in order to implement this complex control.

The predictability and control become complicated because the environment of a controlled system may change significantly. For example, with an autonomous aircraft, the position and velocity of other aircraft around this controlled system may be continuously changing and their location may be important for the control system to properly react to. Also, one or more of the controlled system components may fail or become miscalibrated. The control system should handle these situations, at least to the extent of recognizing that one of these situations has arisen and seeking operator intervention. As evident with the autonomous aircraft case, it is not adequate to just shut down the controlled system in response to a failure. Even in the context of a simpler controlled system like an HVAC system, the environment may be dynamic and components may fail, yet there are risks and costs associated with simply shutting down the system in cases that could be reasonably handled with sufficient “intelligence” in the control system.

Control theory formalizes how to control dynamical systems in engineered processes and machines. These systems are intrinsically continuous because physical systems do not make discrete changes in behavior. For example, increasing the throttle of an aircraft continuously increases the thrust from the engine which in turn continuously increases the speed of the aircraft, up to the engine and aircraft limits. Control theory as a field of continuous mathematics provides a basis for the design of control systems for a physical plant as referred to in the art and herein. It relies on setting control variables to exert this control. In closed loop control systems, it may use feedback input as well as a transfer function based on differential equations to one or more output control values that are expected to control the plant to achieve predictable, stable, and efficient performance and minimize overshoot/undershoot. As referred to in control theory art and herein, the transfer function is a continuous function in one or more input parameters that computes the new value of the control value. A simple control system that has a single input and single output is referred to in control theory art and herein as a SISO system. For example, a PID (proportional-integral-derivative) controller is appropriate for many SISO systems.

The control systems of interest herein require complex control, dealing with multiple inputs or sensors and producing multiple outputs to control the multiple actuators required to control the controlled system. They may also require multiple inputs to monitor the behavior of the controlled system. A system that has multiple inputs and outputs is referred to in traditional control theory art and herein as a MIMO system. An autopilot, for example, a full-function autopilot, is an example of a MIMO system, as it has numerous inputs, including airspeed, angle-of-attack, target trajectory, and/or altitude. It also has multiple outputs, including those to the actuators for throttle, stick position, and/or rudder angle. That is, these outputs correspond to the different actuators that control the controlled system.

A problem of designing a MIMO system may be transformed into that of designing multiple MISOs, referred to herein as multiple-input single output control systems, by decoupling thus having a separate control system/subsystem for each actuator. Decoupling MIMO systems to MISO systems solves a problem of complexity in the design of MIMO control in terms of design understanding. For instance, a PID controller may not be used as a solution to a MIMO control problem because a PID controller only handles a single input and a single output. At the same time, traditional control theory does not handle MISO systems well either, especially when they have discontinuities in behavior, as all real-world complex systems do.

Another issue with traditional control is that many engineered systems have singularities or discontinuities that are hard/impossible to handle with continuous models of control. As described in the above example with an aircraft, increasing the angle-of-attack increases the rate of climb except when there is a discontinuity when the aircraft stalls, at which point, it loses all lift and its rate of climb can suddenly go negative.

Even worse discontinuities may be caused by unpredictable and uncontrolled elements outside of the controlled system. For example, an autonomous aircraft needs a control system that quickly detects and reacts to a fault arising in the aircraft which may cause a discontinuity in the flying behavior/capability of the aircraft. For example, a sudden down draft or wind shear may suddenly change the altitude or attitude of the aircraft. As an another example, an unexpected headwind may cause the flying time to the destination to exceed the fuel available to reach that destination, causing a discontinuity in the control at the point it crosses this threshold. In such cases, an autonomous control system needs to significantly and quickly, and thus discontinuously, change behavior. For instance, if the aircraft is flying over mountains or oceans when it runs low on fuel, it may need to reverse direction and fly to another airport, not simply incrementally selecting a slightly closer destination, because there is not in general an incrementally closer landing strip or airport with a source of fuel over mountain/ocean terrain.

A further improvement for realizing autonomous control is discretization. With a computer realization, a control system may at best re-evaluate the inputs at discrete time intervals, so the control system implementation may use/rely on continuous time. In particular, the computer control program invokes a control decision procedure every T seconds which takes inputs reflecting the current state and returns a control vector indicating the values to which the control variables of the plant are to be set. Therefore, revising the control formulae and extending the theory to work properly when implemented with discretized time is disclosed.

Traditional work in discretization describes the conversion from a continuous model to a discretized model, for discretized time, both for the step-invariant and ramp-invariant models, and also describes the inverse, from discretized to continuous. However, such a traditional conversion still requires the use of continuous values in the computation in the control decision procedure and such conversion may only apply to linear models.

A further need for discretization of the inputs arises because a digital computer can only deal with digital inputs, that is, discrete values. Therefore, computer control systems may use analog-to-digital converters (ADC) that convert analog input into digital inputs. This conversion is traditionally designed to provide a digital output that approximates the continuous/analog input with accuracy matching the capability of the associated sensor, and thus provides an approximation to the continuous value. The ADC may only provide a sample of the continuous input value at discrete time intervals, the sampling period. Similarly, the digital output is converted to analog by a digital-to-analog converter (DAC) because the computer control can only directly provide a digital output whereas the controlled system or actuator may require an analog value. It also may only update the digital output at discrete time periods, namely the periodicity of the computer process. Therefore, this conventional form of discretization of discrete time with continuous formulae is referred to herein as “partial discretization”.

Other approaches—LUT. Discretization of control may be achieved using look-up tables (LUTs), and in some cases handles partial linear (PL) controlled systems. The LUT approach has traditionally been used to replace an expensive or inflexible computation with a table/empirical result that provides similar outputs. As a table in memory, it may be modified dynamically. However, applying the LUT approach to deciding on a control action leads to an exponential explosion in space and processing cost, thus limiting its application to controlled systems where a small number of input dimensions are adequate. Therefore, it cannot be applied to complex control systems with many different inputs, and therefore many dimensions.

Other approaches—ML. So-called machine learning (ML) is an approach that may be used to address the challenge of determining the transfer function for more complex control systems. In this approach, the control decision procedure is implemented as a neural network of floating-point values with weights associated to inputs for each node or neuron. The neural network is then trained to determine the appropriate tuning of weights by using training sets of input data that are labelled with the expected behavior. After sufficient training, the neural network may exhibit reasonable behavior in many cases. However, the training does not guarantee anything about its behavior on input data that is even slightly different from that contained in the training set, as arises in the real world. Moreover, because the inputs are continuous, it is infeasible/impossible to exhaustively test such a system constructed in this way. A well-trained control system may be expensive to generate, needing a large amount of training data, yet may not necessarily be adapted to another controlled system with somewhat different behavior. For example, the control decision procedure for an autopilot developed for one aircraft may not be usable or even adapted to a different aircraft with different flight characteristics without retraining. Thus, ML may address the difficulty of explicitly programming a control system to some degree, albeit replacing it with the cost and difficulty of coming up with a data training set, but does not address the testability issue, and thus does not provide the required reliability.

Overview. Structuring and implementing an autonomous control system for a complex engineered system that provides adequate control is disclosed. The autonomous controlled system is testable, predictable, and adaptable to different instances of the controlled system. The autonomous controlled system may be implemented in the discretized reality of a digital computer system, may handle a dynamic environment and certain failure cases, and may be extended to address new requirements and functionality without invalidating a previous control system and its testing. Adequate control as referred herein is control such that the controlled system reacts quickly and appropriately to discontinuities, avoids false positives on discontinuities, and provides efficient stable operation in the absence of discontinuities.

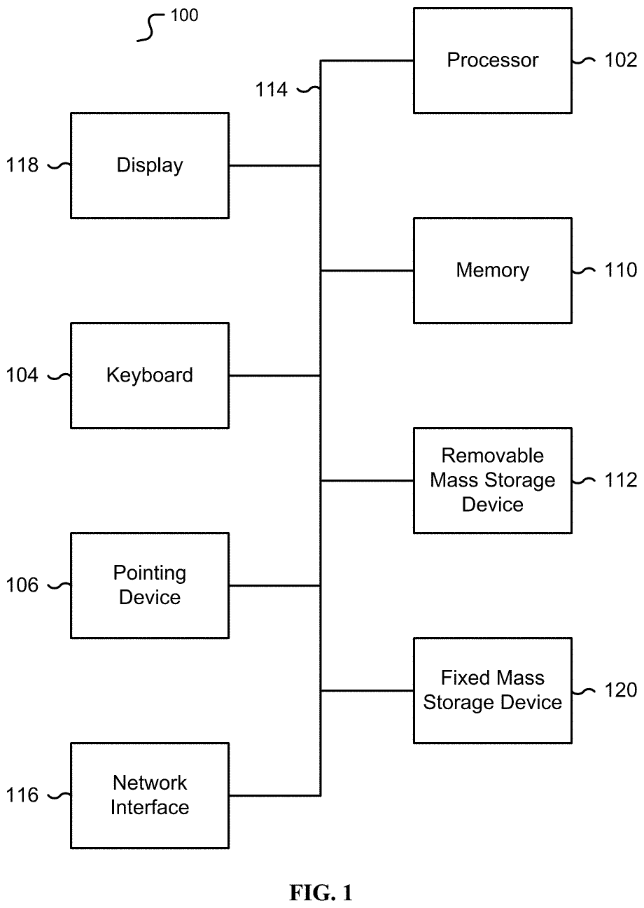

FIG. 1 is a functional diagram illustrating a programmed computer/server system for autonomous control of complex engineered systems in accordance with some embodiments. As shown, FIG. 1 provides a functional diagram of a general-purpose computer system programmed to provide autonomous control of complex engineered systems in accordance with some embodiments. As will be apparent, other computer system architectures and configurations can be used for autonomous control of complex engineered systems.

Computer system 100, which includes various subsystems as described below, includes at least one microprocessor subsystem, also referred to as a processor or a central processing unit (“CPU”) 102. For example, processor 102 can be implemented by a single-chip processor or by multiple cores and/or processors. In some embodiments, processor 102 is a general purpose digital processor that controls the operation of the computer system 100. Using instructions retrieved from memory 110, the processor 102 controls the reception and manipulation of input data, and the output and display of data on output devices, for example display and graphics processing unit (GPU) 118.

Processor 102 is coupled bi-directionally with memory 110, which can include a first primary storage, typically a random-access memory (“RAM”), and a second primary storage area, typically a read-only memory (“ROM”). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as well known in the art, primary storage typically includes basic operating instructions, program code, data, and objects used by the processor 102 to perform its functions, for example, programmed instructions. For example, primary storage devices 110 can include any suitable computer-readable storage media, described below, depending on whether, for example, data access needs to be bi-directional or uni-directional. For example, processor 102 can also directly and very rapidly retrieve and store frequently needed data in a cache memory, not shown. The processor 102 may also include a coprocessor (not shown) as a supplemental processing component to aid the processor and/or memory 110.

A removable mass storage device 112 provides additional data storage capacity for the computer system 100, and is coupled either bi-directionally (read/write) or uni-directionally (read-only) to processor 102. For example, storage 112 can also include computer-readable media such as flash memory, portable mass storage devices, holographic storage devices, magnetic devices, magneto-optical devices, optical devices, and other storage devices. A fixed mass storage 120 can also, for example, provide additional data storage capacity. One example of mass storage 120 is an eMMC or microSD device. In one embodiment, mass storage 120 is a solid-state drive connected by a bus 114. Mass storages 112, 120 generally store additional programming instructions, data, and the like that typically are not in active use by the processor 102. It will be appreciated that the information retained within mass storages 112, 120 can be incorporated, if needed, in standard fashion as part of primary storage 110, for example RAM, as virtual memory.

In addition to providing processor 102 access to storage subsystems, bus 114 can be used to provide access to other subsystems and devices as well. As shown, these can include a display monitor 118, a communication interface 116, a touch (or physical) keyboard 104, and one or more auxiliary input/output devices 106 including an audio interface, a sound card, microphone, audio port, audio input device, audio card, speakers, a touch (or pointing) device, and/or other subsystems as needed. Besides a touch screen, the auxiliary device 106 can be a mouse, stylus, track ball, or tablet, and is useful for interacting with a graphical user interface.

The communication interface 116 allows processor 102 to be coupled to another computer, computer network, or telecommunications network using a network connection as shown. For example, through the communication interface 116, the processor 102 can receive information, for example data objects or program instructions, from another network, or output information to another network in the course of performing method/process steps. Information, often represented as a sequence of instructions to be executed on a processor, can be received from and outputted to another network. An interface card or similar device and appropriate software implemented by, for example executed/performed on, processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Throughout this specification, “network” refers to any interconnection between computer components including the Internet, Bluetooth, WiFi, 3G, 4G, 4GLTE, GSM, Ethernet, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, HomePNA, Optical Fibre, G.hn, infrared network, satellite network, microwave network, cellular network, virtual private network (“VPN”), Universal Serial Bus (“USB”), FireWire, Serial ATA, 1-Wire, UNI/O, or any form of connecting homogenous and/or heterogeneous systems and/or groups of systems together. Additional mass storage devices, not shown, can also be connected to processor 102 through communication interface 116.

An auxiliary I/O device interface, not shown, can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: flash media such as NAND flash, eMMC, SD, compact flash; magnetic media such as hard disks, floppy disks, and magnetic tape; optical media such as CD-ROM disks; magneto-optical media such as optical disks; and specially configured hardware devices such as application-specific integrated circuits (“ASIC”s), programmable logic devices (“PLD”s), and ROM and RAM devices. Examples of program code include both machine code, as produced, for example, by a compiler, or files containing higher level code, for example a script, that can be executed using an interpreter.

The computer/server system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

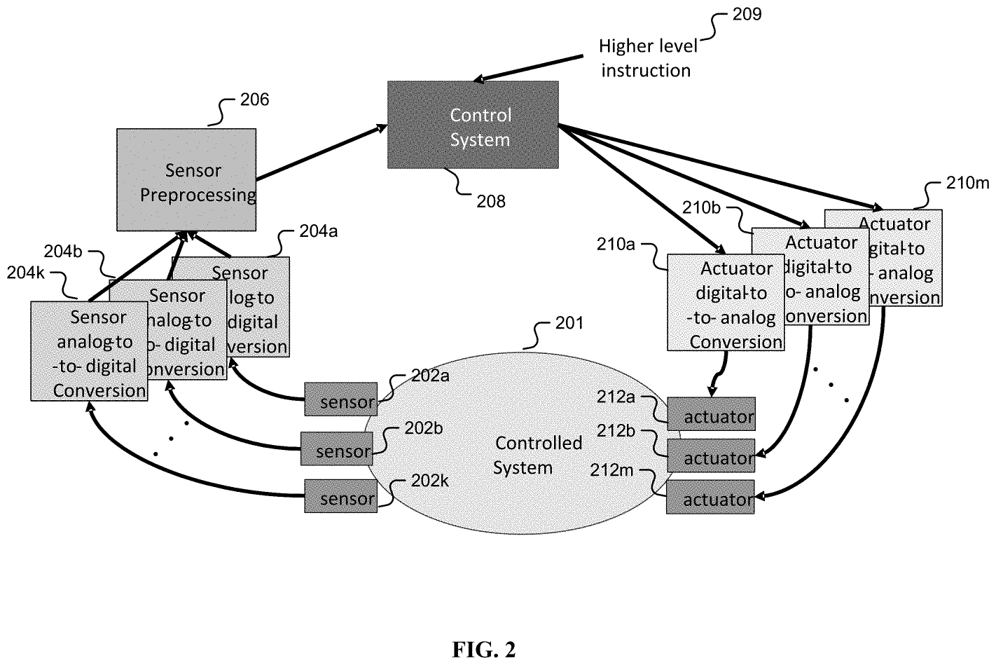

FIG. 2 is a block diagram illustrating an embodiment of a control system as connected into the controlled system, with sensor input and control outputs to actuators. In one embodiment, the control system (208) of FIG. 2 may be a programmed computer/server system as shown in FIG. 1.

A controlled system (201) is coupled to one or more sensors (202a), (202b), . . . (202k). Examples of these sensors may be an altimeter, a rudder position sensor, and an airspeed detector. Said sensors (202a), (202b), . . . (202k) report readings through ADCs (204a), (204b), . . . (204k). These readings are preprocessed through a sensor preprocessing unit (206), and then provided to a control system (208), such as an autonomous control system for complex engineered systems. The control system (208) may accept intervention (209), for example, a higher-level instruction such as “fly the plane to LAX” or human intervention in case of a rare emergency event. The control system (208) outputs a digital control value to each of a plurality of DACs (210a), (210b), . . . (210m), which in turn each control an actuator (212a), (212b), . . . (212m).

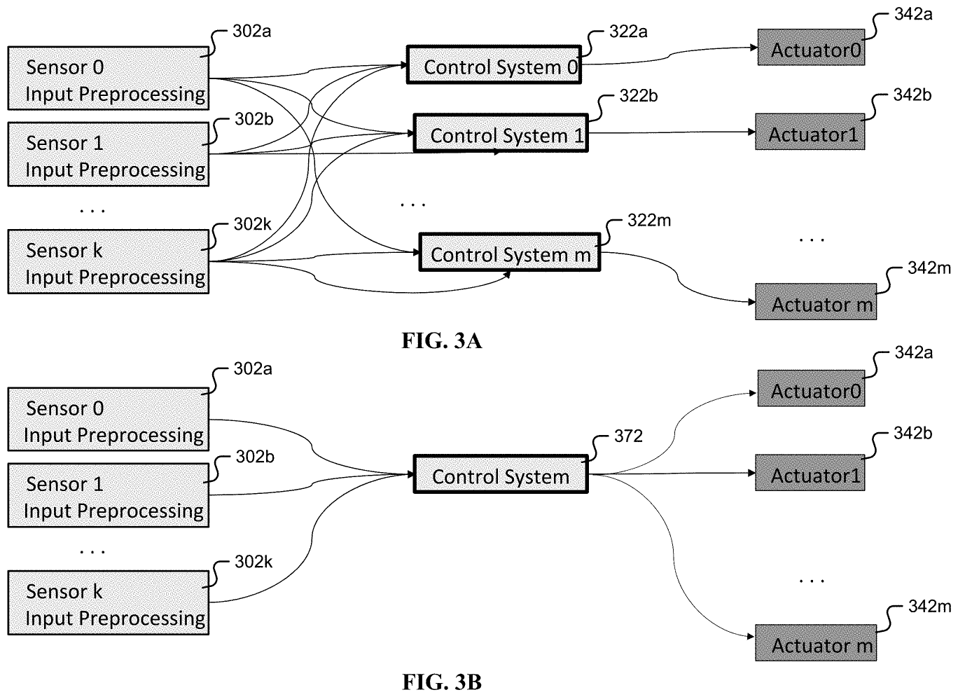

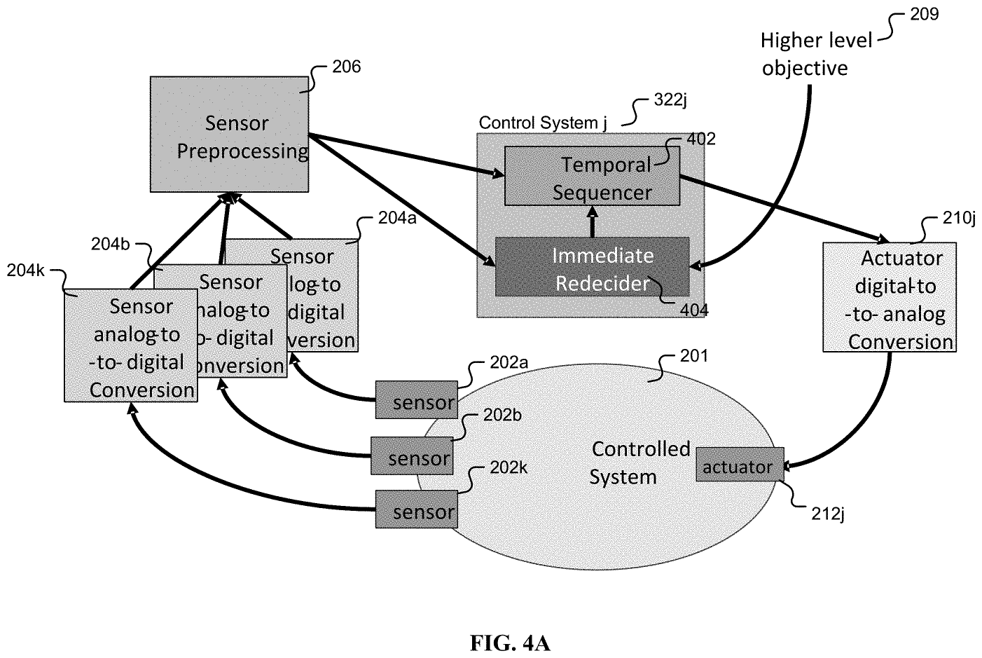

FIG. 3A is a block diagram illustrating an embodiment of a control system structured as multiple decoupled control systems, one per actuator. In one embodiment, the diagram of FIG. 3A is associated with sensors (202a), (202b), . . . (202k) and actuators (212a), (212b), . . . (212m) of FIG. 2. In one embodiment, one or more of the control systems (322a), (322b), . . . (322m) of FIG. 3A may be a programmed computer/server system as shown in FIG. 1.

As shown in FIG. 3A, for k inputs there are k sensors/ADCs/pre-processing (302a), (302b), . . . (302k), which in turn are coupled to m control systems (322a), (322b), . . . (322m), one per-actuator (342a), (342b), . . . (342m) for m actuators. Each control system (322a), (322b), . . . (322m) writes values to its associated control variable/variables periodically to control its associated actuator (342a), (342b), . . . (342m). The inputs from the sensors and sensor preprocessing (302a), (302b), . . . (302k) are provided to each control system instance (322a), (322b), . . . (322m) that requires that input.

For example, with an autonomous aircraft, the airspeed value e.g. (302b) may be provided to both the control system for the throttle e.g. (322a) as well as the control system for the elevators e.g. (322b). These common inputs allow coordination between these decoupled control systems to achieve coordinated control of the controlled system. For example, with an autonomous aircraft, the airspeed e.g. (302b), as a common input, allows the elevator control e.g. (322b) to determine the safe rate of climb and also allows the throttle control system e.g. (322a) to adjust the throttle to maintain speed during a climb.

FIG. 3B is a block diagram illustrating an embodiment of a control system structured as less decoupled. In one embodiment, the diagram of FIG. 3B is associated with sensors (202a), (202b), . . . (202k) and actuators (212a), (212b), . . . (212m) of FIG. 2. In one embodiment, the control system (372) of FIG. 3B may be a programmed computer/server system as shown in FIG. 1.

Decoupling as shown in FIG. 3A may be optional, for example, in one embodiment, to avoid having multiple queries to a decision mechanism. As shown in FIG. 3B, for k inputs there are k sensors/ADCs/pre-processing (302a), (302b), . . . (302k), which in turn are coupled to less than m control systems, for example one control system (372) which controls (342a), (342b), . . . (342m) m actuators. As in FIG. 3A, the one or more control systems (372) write values to their associated control variable/variables periodically to control associated actuators (342a), (342b), . . . (342m).

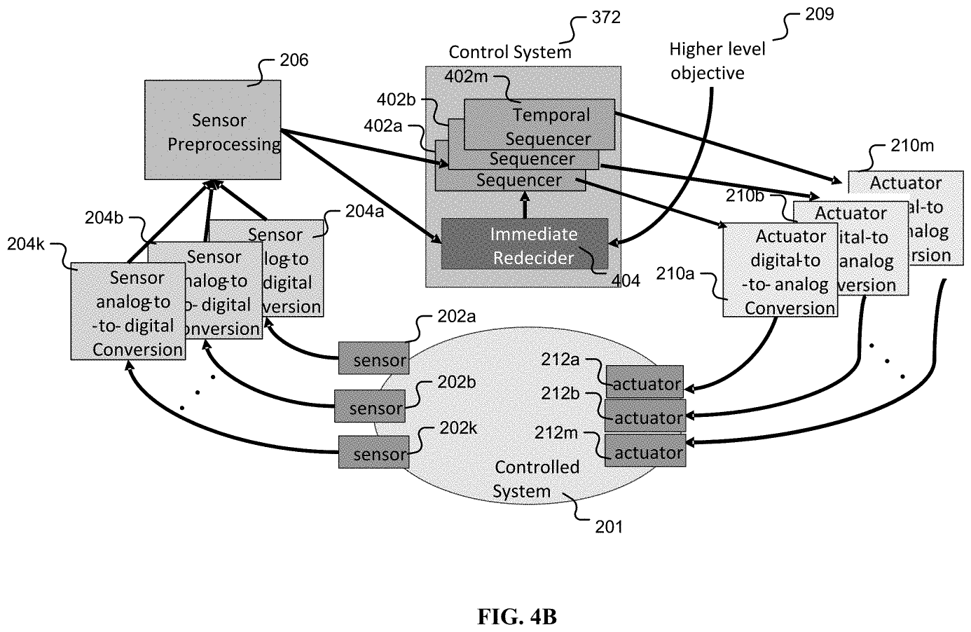

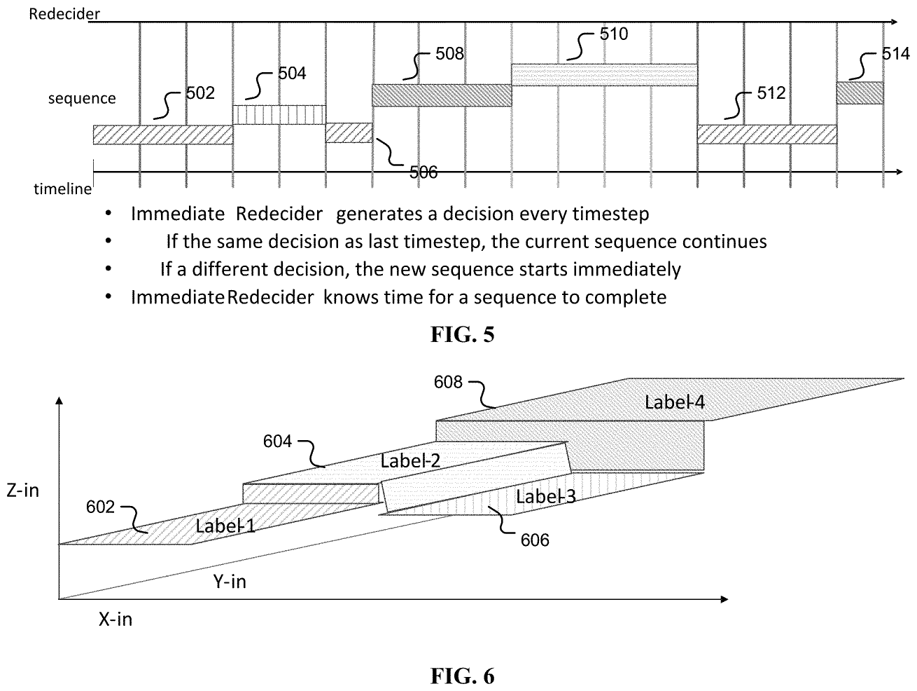

FIG. 4A is a block diagram illustrating an embodiment of a control system with a temporal sequencer and immediate redecider structure. In one embodiment, the structure of FIG. 4A is a type of autonomous control system shown in FIGS. 2 and 3A. In one embodiment, the control system (322j) of FIG. 4A or one or more of its subsystems may be a programmed computer/server system as shown in FIG. 1.

In one embodiment, a control system j (322j) from FIG. 3A is structured as a temporal sequencer, immediate redecider (TSIR) with at least one temporal sequencer (402) and at least one immediate redecider (404). A temporal sequencer (402) refers herein to any system that implements a sequence of “steps” over time that at each step provides control values to control its associated actuator (210j), (212j). For example, if a step is “bank the controlled aircraft” the step provides at least in part control values to control one or more aileron. An immediate redecider (404) refers herein to any system that redecides on which temporal sequence the sequencer should execute on each timestep, either continuing with the current one or switching to a different sequence. As used herein, the term redecider is used to indicate that this component (404) makes a new decision, potentially on each timestep, so is repeatedly and immediately redeciding what sequence to execute. As referred to herein, immediate is “as soon as new inputs are available”, that is each timestep. Thus, the redecider “redecides” a subsequent temporal sequence when there is a temporal sequence currently being executed, should conditions warrant doing so.

As illustrated in FIG. 4A, for a control system j (322j), each of these layers (402), (404) receives sensor inputs (202a), (202b), . . . (202k) in a manner similar to that of FIG. 2. The redecider (404) uses these inputs (202a), (202b), . . . (202k) as the basis for its decision. The sequencer (402) uses these inputs (202a), (202b), . . . (202k) to decide when it can move to the next step and how it is progressing in achieving the objective of the current step. It also uses these inputs (202a), (202b), . . . (202k) to revise the control values it provides to its actuator (210j), (212j) in order to try to achieve its input objective.

In one embodiment, the redecider (404) specifies a logical objective to the sequencer that directly or indirectly selects the sequence for the temporal sequencer (402) to execute. Because the redecider (404) is outputting a logical objective, it is simply responsible for determining at the present time the right objective for the controlled system (201) based on a higher-level objective/instruction/intervention (209) and its inputs (202a), (202b), . . . (202k) from the controlled system and/or the environment. Outputting an objective rather than indicating a specific sequence gives the temporal sequencer (402)/immediate redecider (404) more flexibility in determining the best way to achieve the specified objective.

In one embodiment, the role of the temporal sequencer (402) is to implement temporal sequence control, that is to execute a sequence of steps over time according to a predefined sequence, namely the sequence selected directly or indirectly by the redecider (404). There may be a plurality of sequences implemented by the sequencer (402). Each sequence implemented by the sequencer (402) is executed when that sequence is selected by the redecider (404) or appropriate for the input logical objective from the redecider (404).

At each timestep, the sequencer (402) provides, directly or indirectly, revised control values to the actuator (212j) as part of executing a sequence. These sequences, or some abstraction of same, are specified to some degree as part of the engineering design of the controlled system. That is, the design/designer/engineer of the controlled system (201) may specify a temporal sequence to achieve each application objective in order to ensure that the controlled system (201) is able to achieve required application-level objectives. For example, ensuring that a new aircraft design leads to an aircraft that can land on conventional runways requires a specification, sometimes parameterized, of the landing sequence of inputs such as airspeed and altitude, and actuator outputs such as throttle control and elevator settings.

By implementing multiple sequences, the “decisions” in the sequence are simplified in contrast to attempting to handle different behaviors with one sequence. For example, an aircraft take-off sequence only need be concerned with sequencing an aircraft through the take-off sequence. It does not need to be concerned with decisions involved with aborting take-off, climbing to a higher altitude, and/or changing the aircraft heading. This simplification may be the same reason these sequences are separately identified for human pilot instruction. In one embodiment, a sequence is a single set of steps with the only “decision” for the temporal sequencer (402) being when it is able to proceed from one step to the next. That is, the three possibilities for the temporal sequencer (402) are: to stay with the current step; proceed to the next step; or have the redecider (404) switch to a different sequence. The TSIR structure relies on the redecider (404) switching the current sequence in order to implement complex control behavior such as, for example, aircraft take-off, take-off abort, obstacle avoidance, and other behaviors required of an autonomous aircraft. This delegation to the redecider (404) simplifies the temporal sequencer (402) for simpler control and decision making.

In one embodiment, this temporal sequencing is required because the controlled system (201) may in general only achieve an objective over time and through a number of steps; it may be necessary to sequence the changes to the control values (210j), (212j) over time based on constraints or requirements of the controlled system (201). For example, if an aircraft is stopped on the runway, going instantaneously to full throttle in a single step when the logical objective for airspeed is changed to take-off speed may be inefficient/harmful to the engines and/or uncomfortable for passengers. Thus in this case, the sequencer (402) is responsible for implementing the steps that incrementally increase the throttle to avoid such problems. The sequencing is performed as a sequence of discrete steps compatible with a computer implementation. That is, the processing is invoked at discrete intervals, so the processing is performed at these discrete steps.

In one embodiment, the role of the immediate redecider (404) is to: rapidly redecide on the temporal sequence to execute; select a given sequence out of the set of sequences that the sequencer (402) implements; and/or indicate its selection as input to the sequencer (402). The redecider (404) typically re-evaluates its decision on each redecider timestep (404). Therefore, if conditions change in the controlled system or its environment (201) as indicated by its inputs (202a), (202b), . . . (202k), it can produce a different decision and thus select a different sequence for the sequencer (402) to perform with very little delay.

For example, an aircraft autonomous pilot may re-evaluate its decisions every 50 milliseconds so that it detects and reacts to changes in at most 50 milliseconds from the time that the revised inputs (202a), (202b), . . . (202k) are available to it. In this example, a redecider (404) in the autonomous pilot may detect there is a problem with the aircraft during the take-off sequence and/or the higher-level intervention (209) may change to indicate aborting the take-off. The redecider (404) then may change the logical objective being provided to the sequencer (402). The sequencer (402) is then required to immediately change to the sequence of steps associated with the new logical objective. That is, the sequencer (402) supports immediately preemptable sequences, replacing the current sequence in execution with a different one when so indicated by the redecider (404). The sequencer (402) may also restart a sequence if some parameter to the current sequence changes significantly. For example, if the target airport to which an aircraft is cruising changes, the sequencer (402) may restart the cruising sequence, even though the logical objective of cruising did not change.

However, if the redecider (404) does not change the logical objective or associated parameters, the sequencer (402) continues with the current sequence at the current step in that sequence, typically performing multiple subsequent timesteps to achieve its logical objective. That is, it continues from the current step it is processing without being disrupted. This continuation with the current temporal sequence is important for efficient stable operation. Frequent reactions to phantom discontinuities such as false positives would cause unnecessary sudden changes in control that would be undue strain on the controlled system (201) and its processing. Also, even restarting a temporal sequence unnecessarily may result in unnecessary control variability and/or extra control processing.

FIG. 4B is a block diagram illustrating an embodiment of a control system with a partially decoupled TSIR structure. In one embodiment, the structure of FIG. 4B is a type of autonomous control system shown in FIGS. 2 and 3B. In one embodiment, the control system (372) of FIG. 4B or one or more of its subsystems may be a programmed computer/server system as shown in FIG. 1.

As shown in FIG. 4B, a single redecider module (404) may be used that provides a result to a plurality of temporal sequencer modules (402a), (402b), . . . (402m), rather than fully decoupling one per-actuator as shown in FIG. 4A. Such a decoupling is optional as two or more actuators may be controlled by one redecider.

In contrast to FIG. 4A, the system of FIG. 4B has fewer control systems, here shown as one control system (372), than there are actuators, here shown as m actuators (212a), (212b), . . . (212m). The control system (372) has its plurality of temporal sequencer modules (402a), (402b), . . . (402m) coupled to respective DACs (210a), (210b), . . . (210m) which are then coupled to respective actuators (212a), (212b), . . . (212m).

For FIG. 4A, full decoupling may have an advantage to avoid having multiple decisions in one lookup in a decision tree for the redecider module (404) in each control system (322j). In the embodiment illustrated in FIG. 4B, such an issue may be handled by having a decision result map to a vector of decision values, one entry for each actuator (212a), (212b), . . . (212m).

In one embodiment, the system of FIG. 4B may have an advantage in certain domains where each separate control agent may want some indication of what other control agents are likely to do. There may be dependencies between different control agents in how effective each is towards an objective based on what the other control agents do. For example, the elevator agent may like to know if the throttle agent is increasing the throttle.

In one embodiment, an extended redecider provides a range of reasonable parameters to each control agent. For example, the throttle may be changed plus or minus 10 percent and/or the ailerons may be adjusted by +10/−10 degrees. The temporal sequencing may refine the actual throttle value to use based on a simulation of the controlled system over a relevant period of time, for example, by simulating over the next five seconds. Thus, the redecider provides a restricted range of values to try, so the temporal sequencer only has to try a few values rather than all possible values. This simulation may reuse the dynamic simulation used by a designer of the engineered system of interest. Thus, each temporal sequencer may use this simulation and/or a refinement of this simulation rather than having to carefully program the parameters for each temporal sequence.

A simulation approach may encounter a larger cost of running the simulation with many different choices of parameters. Thus, restricting the range of values to try is a practical improvement to reduce the cost of simulation on each timestep, in part by providing a range of parameters for each actuator to simulate with. For example, if the logical objective is to climb but there is a high positive vertical speed already, the range for the throttle and elevators is more or less the same as currently. However, if there is no vertical speed or a negative vertical speed, the range for the throttle and elevators is much higher.

In any case, the range specified for each actuator is much smaller than the total possible range for each control variable, so each control agent may simulate far fewer possibilities. For example in the last case, it does not simulate reductions in throttle or elevators at the very least. The throttle agent may use a mid-point of the ranges provided to the other control agents or what each other agent set its control variable to in the previous timestep if contained in the current range. For example, it may assume that the elevator agent is setting the elevators the same as the last timestep or to the midpoint of its new range. Thus, each control agent may not have to run a cross-product of simulations across all the control value ranges, but doing so for the possible values within its range.

In this approach, the temporal sequencer still provides the temporal sequence and the redecider still provides an indication of the logical objective. The redecider has a decision result that maps to a vector of ranges for the control variables, not just a logical objective. And, with the vector of ranges, one redecider for all the control agents may be practically adequate.

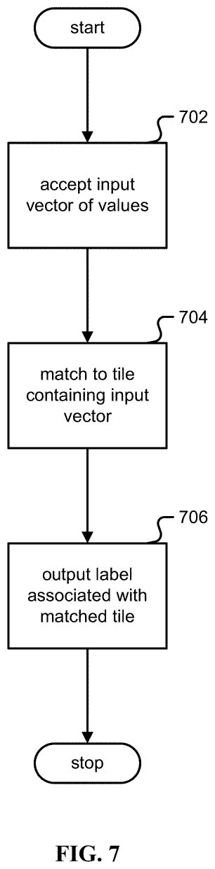

FIG. 5 is an illustration of an example timeline of a redecider deciding a temporal sequence at each timestep. In one embodiment, the illustration of FIG. 5 is carried out by a programmed computer/server system as shown in FIG. 1.

As shown in FIG. 5, an immediate redecider (404) of FIG. 4A or FIG. 4B re-evaluates its decision at each timestep, allowing a temporal sequencer (402) of FIG. 4A or (402m) of FIG. 4B to: continue with an existing sequence if this re-evaluation does not change its decision, representing the same logical objective or sequence for the sequencer (402)/(402m); or change the sequence being executed immediately if the redecider (404) does change its output logical objective.

An improvement of control simplicity is the advantage of partitioning the control functionality into a decision module (404) that redecides rapidly while delegating the simple decisions involved with temporal sequencing to a set of preemptable sequences where the sequencer (402)/(402m) “decision” comprises typically simply deciding when the particular sequence in execution should proceed to the next step in the sequence. That is, decision conditions are specialized to a particular sequence, and therefore further simplified. Thus, the complex decision making is localized in the redecider (404) but the temporal sequencing and fine-grain decisions/micro-decisions are off-loaded to the temporal sequencer (402)/(402m).

As referred to herein, preemptable means to suspend a current task/sequence and switch to executing a different task/sequence. This normally entails saving the state associated with the current task so that it may be resumed later. However, as discussed herein, the state that is relevant to a sequence is primarily that of the controlled system (201) of FIG. 2 as reported by sensors (202a), (202b), . . . (202k) so it is not specific to the sequence and is preserved independent of the sequence.

Furthermore, a preempted sequence is rarely resumed as such, for example, if an autonomous aircraft is executing a take-off when an obstacle appears in the runway, causing it to preempt that sequence in order to begin aborting the take-off because there is no need to provide for resuming the take-off sequence at the same point it was when preempted, as the aircraft is not physically in the same state. In the event the obstacle is immediately cleared away such that the aircraft redecided to resume the take-off sequence, the take-off sequence may be re-decided to start again, acting based on the current state of the aircraft, which would be slower and further down the runway than when the previous instance of the take-off sequence was executing. Thus, the take-off sequence available is improved with a large enough operating domain to be invoked even if the aircraft has already significant airspeed. In general, each sequence may be designed to take over in a wide range of scenarios to support its immediate redeciding, which could suddenly invoke the sequence in different scenarios. Therefore, designing a sequence to be preemptable is primarily designing it to be invocable across a reasonably broad and specified operating domain and also, to not leave residual state that is specific to the sequence when preempted.

The redecider (404) effectively characterizes a scenario in which the current sequence is selected based on its decision criteria for selecting this sequence. The decision criteria then provides a basis for the redecider (404) to determine at the next timestep whether the new situation at this next timestep matches this characterization and thus the current sequence should be allowed to continue or whether the redecider (404) needs to select a different sequence based on the changes in the new situation.

The logical objective output by the redecider (404) provides a simple criterion to determine if the new scenario fits the characterization that was the basis of the previous selection of the current sequence: if the same logical objective is as the previous timestep, then the same characterization; and otherwise not. By contrast, a traditional sequence-based control has no mechanism to redecide and a conventional AI (artificial intelligence) planning approach has little characterization of the previous input scenario so there is little clear criteria on which to determine if the previously generated plan is still valid to use as of the next timestep or subsequent timesteps in general.

In one embodiment, a redecider (404) overrides the higher-level intervention (209) that it receives as input. For example, with an autonomous aircraft, the redecider (404) may decide against take-off even when manually instructed/authorized if it detects via one of its inputs that there is an obstruction on the runway or a problem with the aircraft. It may also redecide against take-off if there is not enough time to reach take-off speed, given the short length of this particular runway or excessive cargo weight.

As described in the art of artificial action selection and herein, the action is selected on each timestep by determining a logical objective, and then, in the sequencer (402)/(402m), mapping that logical objective to a temporal sequence, and then performing an action at the current or next step of this sequence, which could be the first step in the case of a new sequence being selected. This action may simply be updating the control values to its associated actuator (212j). Effectively implementing this is disclosed by simply partitioning between an immediate redecider (404) and temporal sequencer (402)/(402m).

The redecider (404) is often a challenging aspect to implement since the temporal sequencer (402)/(402m) is often largely specified as part of engineering of the system and the training of a human operator, especially when the system may also accommodate manual operation. Traditional artificial action selection has left unsolved both: reacting immediately to significant changes in input; and the need to smoothly execute temporal sequences of control.

As stated earlier, the temporal sequencer (402)/(402m) is typically simpler to implement, given it is implementing control sequences that may have been specified as part of the engineering design of the controlled system. For example, a training manual for an aircraft may describe how to land an aircraft based on feedback from the engineer who built the aircraft. The temporal sequencer (402)/(402m) takes as input one of a relatively small number of logical objectives designating one of a plurality of sequences and proceeds to execute a sequence associated with that input logical objective.

For example, an autonomous aircraft may have the logical objectives: park, taxi, take-off, climb, descend, align for landing, and land. Each can be coded as a coroutine/sequence, namely a procedure that is able to perform a step and then wait/suspend as needed for specified conditions to be true before proceeding to the next step. For example, the take-off coroutine for elevator control may wait for the aircraft to reach take-off speed before raising the elevators to increase the pitch to actually lift-off. More realistically, the coroutine would wait for a time period and re-check the airspeed to determine if the aircraft is making adequate progress towards the required airspeed. In one embodiment, the sequencer (402)/(402m) is both responsible for: implementing the sequence of actions over time; and detecting if the sequence is not proceeding adequately over time to meet the temporal requirements of the input logical objective. The wait condition may be relatively simple to implement because it typically only determines whether conditions are met to proceed from the specific current step to the next step. It may not have to be concerned with whether this current sequence is still the right temporal sequence to be executing, given changes to the state of the controlled system and the environment, which is instead delegated to the redecider (404).

In one embodiment, the sequencer (402)/(402m) has a fixed set of procedures or processing sequences to verify, making it feasible to test. Stated another way, an engineered system, such as an aircraft, is designed with a relatively small number of logical objectives and thus, a small fixed number of coroutines are sufficient. Note that if an engineered system does not have a relatively small number of sequences/coroutines required to control it, it would be challenging for a typical human operator to know all the sequences and be able to select and execute the right sequence as needed, thus the disclosed techniques may be used for systems driven by typical human operators.

In one embodiment, a coroutine sequence dynamically determines when to perform the next step but the “decision” on which step is typically simple by design. For example, if the coroutine is iterating, incrementally increasing the target airspeed at each iteration, the “decision” to terminate the iteration is a simple “if” condition on the aircraft reaching the target speed and a condition that checks whether the sequence is taking too long to reach the target speed. If a more complex decision is required, the redecider (404) is expected to handle redeciding and thus change the current sequence/sequences being executed. For example, if the aircraft fails to increase in airspeed in a timely way to get to take-off speed, the redecider (404) would make the decision to pick an alternative sequence based on its inputs. In this example, the airspeed sequencer (402)/(402m) may simply indicate as feedback to the higher-level that it is not achieving the target airspeed as fast as expected. Because of this deferral of decisions to redecider (404), the sequencer (402)/(402m) is comparatively simpler to implement.

Realizing an automatic control system using the TSIR structure is disclosed, wherein complexity is partitioned between immediate redecider (404) and temporal sequencer (402)/(402m). In one embodiment, a key challenge is implementing the redecider (404), as each decision it makes is based on a complex set of inputs (202a), (202b), . . . (202k) and is important to be a correct decision.

For example, the decision to abort a take-off versus continue with the take-off when there is some problem with the aircraft depends on many factors, such as the current airspeed, the distance/time remaining on the runway, and/or the nature of a mechanical problem that is detected and its effect on the airworthiness of the aircraft. Making the wrong decision may be extremely dangerous.

In one embodiment, implementing the redecider (404) includes designing each decision to map onto an efficient predictable stable control of the continuous system being controlled while still being highly responsive to changing conditions. In particular, the redecider (404) may allow the current temporal sequence to continue whenever appropriate to achieve efficient stable control and yet immediately cause the temporal sequence to change when necessary. For example, an autonomous autopilot may react to changing conditions if its previous decision is no longer consistent with the constraints. However, it should be designed not to oscillate rapidly between deciding to abort versus continue with the take-off.

In one embodiment, implementing the redecider (404) includes allowing the control system to evolve to expand its operating domain. That is, each redecider (404), as a software module, is designed to be efficiently and safely evolved or extended over multiple releases to handle more and more inputs and thus make more complex decisions. For example, an aircraft autonomous autopilot may need to be evolved/extended to handle a new input indicating loss of cabin pressure. The method for doing so needs to be implemented without compromising the presumably well-tested handling of the situations it currently handles.

As the example shows in FIG. 5, the redecider (404) may select one of a plurality of sequences for the temporal sequencer (402)/(402m), with each type of sequence shown in a different cross-hatch pattern in FIG. 5. For an aircraft example following FIG. 5, the diagonal “///” pattern may indicate a take-off sequence for step (502), and the vertical “|∥” pattern may indicate a collision avoidance sequence step (504), which when resolved returns the aircraft to a take-off sequence (506). Once the aircraft has successfully taken off, it may go to a cruising sequence (508), then landing sequence (510). After landing the aircraft may return to take-off (512) and subsequently cruise again (514). In one embodiment, the immediate redecider (404) knows the time it takes for a temporal sequencer (402)/(402m) to complete a given sequence.

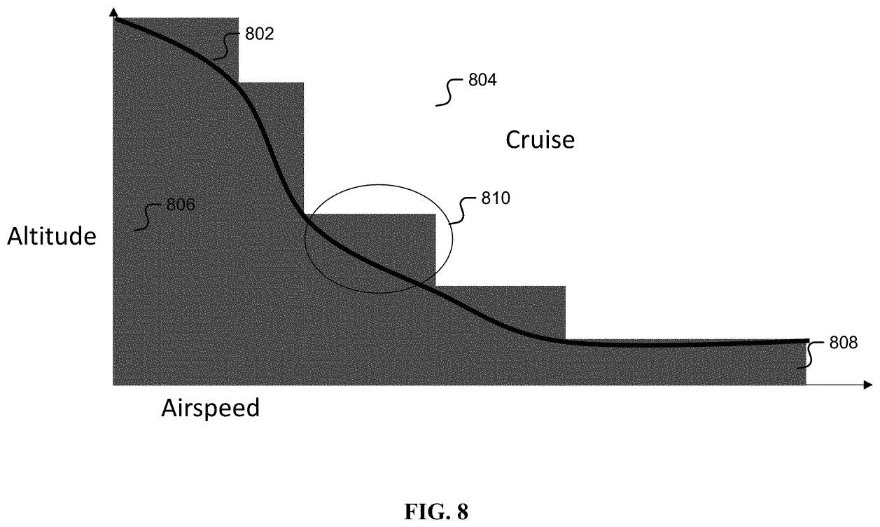

Tile-based Implementation. FIG. 6 illustrates a tile-based implementation for a simplified three-input/three-dimensional system with inputs labelled X-in, Y-in and Z-in.

In one embodiment, a redecider (404) is implemented using an associated set of predefined K-dimensional tiles, and a decision procedure. As described herein, a tile refers to a K-dimensional enclosed shape such that any point in the K-dimensional space is either inside the shape or outside the shape. The decision procedure takes as input a set of K input values indicating the state of the controlled system at the current time and matches those values to one or more predefined tiles in the associated K-dimensional tileset. In particular, the K input values match a tile T if the K-dimensional point corresponding to those K-input values is contained in T, e.g. if tiles are restricted to hyperrectangles, the first value is within the range of the first dimension range of the tile, the second value is within the range of the second dimension range given the first dimension, and so on to the K-th input value.

Each tile may be labelled to indicate an associated decision value, indicating a logical objective. The label of the matched tile may be used to indicate the logical objective decision and potentially some of its parameters to provide to the sequencer, which then executes the sequence corresponding to that objective, either starting a new sequence or continuing with the existing sequence if that is the correct one.

In such a tile-based approach, each input may have an allowed total range. For example, with an autonomous aircraft, the range for airspeed may be 0 to 500 km/h, the range for altitude may be 0 to 15000 meters, and the range for roll may be 0 to 359 degrees. The K-dimensional space of inputs is the cross-product of these allowed total ranges.

Continuing the previous example, the input combination [200,1500,0] where the 3-tuple is [airspeed, altitude, roll] is a point in this input space, a normal combination for a cruising aircraft. However, other input combinations such as [0, 14000, 90] are also contained in this input space. This case of zero airspeed at a high altitude and perpendicular to the ground is well outside the normal operating domain for the aircraft, also referred to herein as a flight envelope. However, an aircraft can have zero airspeed on the ground, fly in some cases in a high altitude, or be perpendicular to the ground when doing a descending tight turn. That is, each of these extreme values may occur individually in a normal operating domain, but the combination is what is outside of the normal operating domain.

The tileset, referred to herein as the set of tiles used by the redecider, covers this K-dimensional input space. In particular, every input value combination that occurs in the cross-product of allowed total ranges of the inputs matches to a corresponding tile.

In one embodiment, each tile has a label, typically static at least for a decision period, so the set of possible labels is restricted to a small set of discrete values or identifiers, that is an enumeration of sequences/parameters. For example, tile labels for the airspeed may indicate one of the five values corresponding to the objectives/sequences: stopped, taxi, take-off, cruising, and fast cruising. That is, a sequence is identified by specifying its associated objective.

FIG. 6 illustrates four tiles in a simple three-input/three-dimensional system labelled X-in, Y-in, and Z-in, and K equals to 3. Tile 1 (602) generates an output Label-1 when the inputs are within the boundaries of the X, Y and Z values for Tile 1. Tile 2 (604) generates an output Label-2 when the inputs are within the boundaries of the X, Y and Z values for Tile 2. Tile 3 (606) generates an output Label-3 when the inputs are within the boundaries of the X, Y and Z values for Tile 3. Tile 4 (608) generates an output Label-4 when the inputs are within the boundaries of the X, Y and Z values for Tile 4.

As shown in FIG. 6, these tiles may be of different lengths, widths, and heights, or the K-dimensional equivalent. For example in FIG. 6, Tile 4 (608) has a larger X dimension than the other tiles. There is a tile for every possible input value combination, namely of X-in, Y-in, and Z-in in this figure. That is, the tiles “cover” the K-dimensional input space, so there is a tile and a tile label for every legal set of input values.

As denoted herein, the use of a parenthesis in a range indicates an open interval that is strictly less than the maximum value. As denoted herein, the use of a square bracket in a range indicates a closed interval that is greater than or equal to the minimum value.

To illustrate further, consider an example of a decision module for controlling roll in a simple aircraft that has as inputs: intended maneuver, airspeed, and altitude. These three inputs define a three-dimensional input space. Suppose the integer/discrete input value indicating a rapid right turn is 13. As a particular tile definition, if there are airspeed thresholds at 150 km/h and 200 km/h and altitude thresholds at 200 feet and 500 feet, there is a three-dimensional tile corresponding to the dimensions: maneuver [13,14), airspeed [150,200) and altitude [200,500). This tile is labelled with the roll output value associated with this tile, say “hard roll”. Thus, if the input is, for example, (13,175,375), these inputs are contained within the boundaries of this tile, so the decision module outputs the logical objective as “hard roll” which might be mapped to 30 degrees for this aircraft, as appropriate for the requested rapid right turn indicated by the intended maneuver value, that is 13 in this example. The sequencer (402)/(402m) then invokes a sequence to achieve this specified roll angle over the appropriate period of time.

There are combinations of input values that may not be part of the normal operating domain of the controlled system. For example, with an autonomous aircraft that is instructed via a higher-level objective (209) to cruise, there is a trade-off between airspeed and altitude to some degree. In particular, the higher the airspeed the greater the ease for the controlled system to get from low altitude to proper cruising altitude. Similarly, the higher the altitude, the greater the ease for the aircraft to get to a proper airspeed from very low airspeed. For example, the control system may just orient the aircraft nose-down to pick up significant speed if it is at a high altitude. On the other hand, it is not reasonable to expect a “cruise” sequence to handle extreme and dangerous situations such as when the airspeed and altitude are both low or for the airspeed to be very high at very low altitude. Therefore, boundary tiles may be designed that match input situations that are outside of what a sequence can handle/its operating domain. As described herein, a boundary tile is a tile that designates a portion of the K-dimensional input space that is outside the operating domain of the controlled system, provided to ensure that there is a decision label that matches every possible input value combination. These tiles are labelled with an indication to seek an intervention, either by a separate emergency sequence or a human operator, often logging an error indication. These boundary tiles explicitly define when the inputs indicate that the controlled system appears to be outside of its operating domain for the input logical objective.

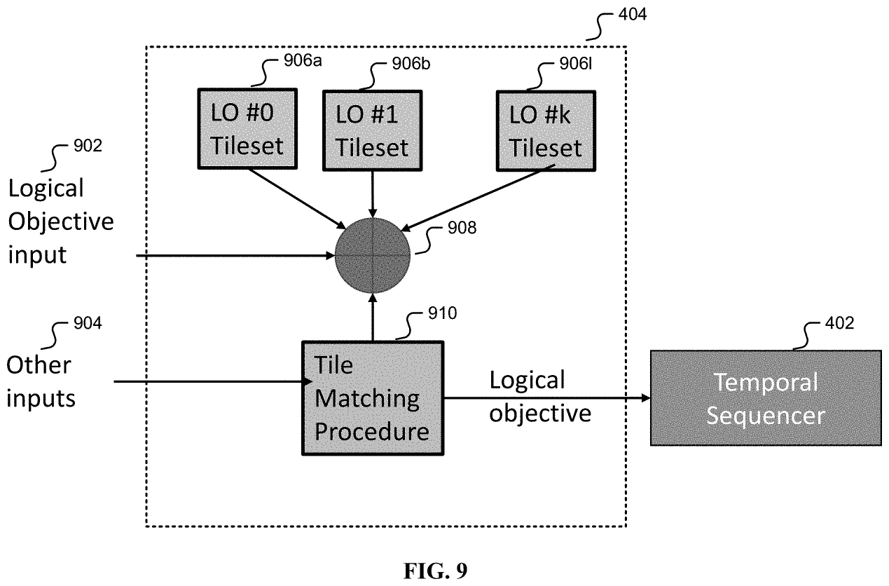

FIG. 7 is a flow diagram illustrating an embodiment of a process to select a tile on a timestep. In one embodiment, the flow of FIG. 7 is carried out by a redecider/decision module (404) of FIG. 4A and FIG. 4B. In one embodiment, the flow of FIG. 7 is carried out by a programmed computer/server system as shown in FIG. 1.

As shown in FIG. 7, processing may be feasible. In step (702), an input vector of values is accepted. In step (704), the input vector of values is matched to a tile containing said input vector. This matching step may be performed by iterating over all the tiles, checking if the K-dimension point defined by the input values falls within a tile, and returning the associated label if so. In one embodiment, an optimized approach is used, as described below using traditional decision trees. In step (706), an associated label with the matched tile is output.

In one embodiment, implementing the redecider is defining the associated tileset, namely: the dimensions; the tile boundaries; and the label associated with each tile, such that there is a practical number to store and an efficient means to match against, and limiting the number of matches required. On limiting the number of matches, a decision tree or equivalent if-then-else structure requires that there be a single decision per matching.

In one embodiment, the tileset of K-dimensional tiles for a given actuator is specified by thresholds for each of the input dimensions, that is parameters. That is, each tile is a K-dimensional hyperrectangle/orthotope. That is, each tile is specified by its minimum and maximum value for each dimension. For example, if airspeed is an input dimension/parameter and includes the thresholds 0, 3, 100, 200 and 300 KMPH, then the ranges 0 to 3, 3 to 100, 100 to 200, 200 to 300, and 300 and higher define tile boundaries in the associated tileset. The 0 to 3 range is included in this example to handle the case of the aircraft being essentially stopped.

As another example, a specific tile T may have its angle-of-attack dimension specified as a minimum of 5 degrees and a maximum of 21 degrees. Therefore, if the angle-of-attack input value is greater than or equal to 5 degrees and less than 21 degrees and the other input values are contained within their corresponding dimensions of the tile T, then the tile T is matched. The output of the decision module is then the label associated with tile T. This label indicates to the associated sequencer/sequencers the logical objective or sequence to execute.

By using these thresholds, the resulting tileset covers all possible input value combinations. Continuing the above example, the legal airspeed range is 0 to some large value, such as the 500 km/h used earlier. The first range starts at 0, and each range is necessarily consecutive based on the thresholds, and the last range is between the largest threshold and the maximum allowed value for that input type. Given this is true for each input dimension, any legal input value combination maps to a tile. Here, legal refers to herein a value that is allowed in the input for that input source.

In one embodiment, one dimension of the tiles in the tileset is time, indicating for each tile the amount of time that may be available to have the decision associated with this tile be a good choice. For example, for an autonomous aircraft autopilot, it does not make sense to redecide to take off if the time required to reach take-off speed exceeds the time before reaching the end of the runway. Because of the multi-dimensional aspect of a tile, the temporal requirement for a given decision/tile is specific to the input values in the particular ranges dictated by the tile. For example, the time required to reach take-off speed indicated by a tile is qualified by the airspeed and the acceleration. This handles the aspect that this time requirement is different depending on these factors and others.

In one embodiment, an input dimension is treated as continuous even if its values are discrete or categorical by treating any value greater than or equal to some integer value I but less than I+1 as corresponding to I. That is, the integer value is treated as the lower bound of a continuous interval. For example, suppose the enumeration of the six values of airspeed: stopped, slow-taxi, fast-taxi, take-off speed, landing speed, and cruising speed are represented as the value 0, 1, 2, 3, 4 and 5 respectively. If this enumeration is provided as an input to a decision module, that is the target airspeed, then any value in the range 3.0 to 3.9999 is mapped to take-off speed. Thus, in the tileset for airspeed, there is a tile with the dimension corresponding to logical objective that is in the range 3.0 to 3.9999. Conversely, for the process variable for airspeed, this input is discretized in effect by mapping the actual airspeed to one of several ranges, where the ranges are defined in terms of thresholds that cause different decisions. As referred to herein and in the art, a process variable refers to a measure of a quantity that is controlled by a particular actuator.

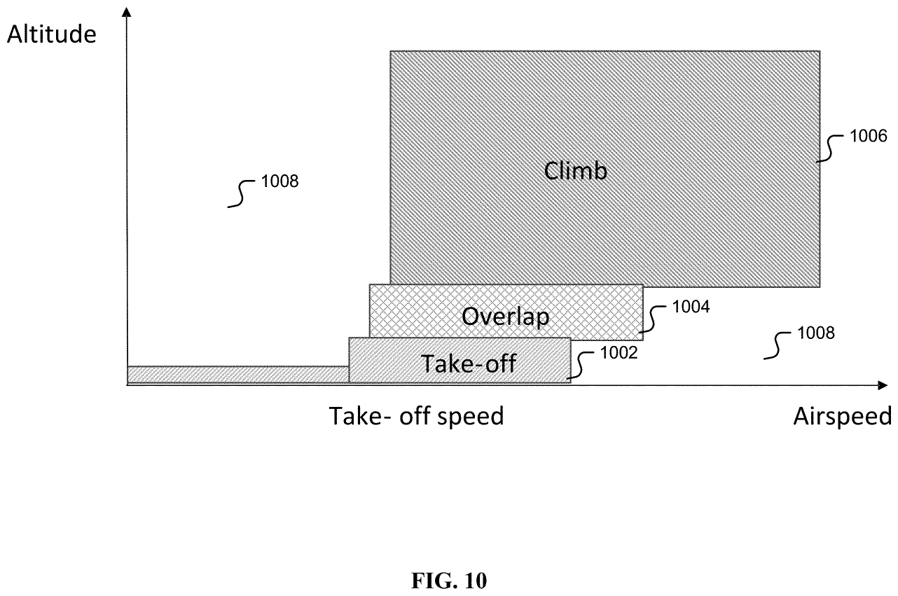

FIG. 8 is an illustration of boundary tiles for a simplified example of an autonomous aircraft with input logical object “Cruise”. FIG. 8 illustrates the boundary between the Cruise operating domain and outside of the operating domain considering two dimensions of altitude and airspeed. The curve line (802) indicates the actual boundary, computed using a continuous function. The clear area (804) is covered with tiles indicating Cruise.

As shown in FIG. 8, higher airspeed allows the Cruise logical objective to take over at lower altitudes whereas lower airspeed requires a higher altitude. In a completed tileset, a very low airspeed tile (806) may require an intervention by selecting a “StallHandling” sequence. Similarly, in a completed tileset, a very low altitude at high airspeed tile (808) may require an intervention by selecting an “EmergencyClimb” sequence.

As shown in FIG. 8, shaded tiles indicate boundary tiles that approximate curve (802). As rectangular tiles, they may provide an approximation to this curve. As an approximation, there are values for airspeed and altitude that the aircraft and Cruise sequence could actually handle but are not allowed by the tile-based approach. These areas are indicated by the areas where the tiles are above the curved line, for example, that shown with element (810).

As shown in FIG. 8, there are regions of airspeed and altitude in which switching to Cruise is not allowed with the tile-based decision approach yet would be actually acceptable to the aircraft. Note this may result in a non-optimal control in some sense. However, note further a controlled system is improved when operating away from these boundary cases, especially in a dynamic environment with on-going risk of component failure or miscalibration. Also note there is relatively little difference in efficiency between the sequence that is selected in the boundary cases versus selecting the Cruise logical objective. For example, at a high altitude and low airspeed, both a StallHandling and Cruise sequence would pitch the aircraft nose-down to reduce altitude and gain airspeed. It is just that the StallHandling sequence is expected to do so more aggressively.

In one embodiment, finer-grain boundary tiles are used to more closely approximate the actual continuous curve if a better approximation of this curve is warranted. However, note finer-grain tiles increase the cost of storing tiles and matching to them, so there is a trade-off to be made between these costs and the benefits of more accurate control.

Tileset Reduction. The disclosed tileset-based approach provides predictable/deterministic behavior as an immediate redecider comes to a same decision each time that inputs are within the parameters of a given tile. Making the tiles as large in the K-dimensional space as possible while providing acceptable control stabilizes control over most of a range of input values corresponding to the vertices of the selected tile. That is, the immediate redecider re-selects the same logical objective most of the time and selects the same logical object if that is the right decision to make. Avoiding an exponential explosion of tiles compared to the conventional lookup table controller approach is disclosed. In a decoupled system such as that described in FIGS. 3A and 4A, each tileset produces a single output so they may be compiled into a decision tree for efficient lookup to determine the new logical objective. In a partially decoupled system such as that described in FIGS. 3B and 4B, a decision tree may be used wherein the decision result maps to a vector of decision values, one entry for each actuator.

In a general case, for an immediate redecider module for a given actuator, there are NK-dimensional tiles and M possible tile labels. Without tileset reduction, the number of tiles may be larger to specify, to store, and to match against. For example, with conventional 16-bit ADCs, 2-bit ranges and I inputs, the number of input value combinations is 24, which for values of I larger than three is larger than may be practical, both in memory space to store the tiles and in matching overhead to match inputs to the tiles. Note that as referred to herein, a “2-bit range” is that each range corresponds to 4 different digital values. In one embodiment, memory space and matching overhead may be reduced over LUT controllers by using per-input combination thresholds and by the delegation to the sequencer.

Reducing the number of tiles and tile labels required and facilitating generation of reduced tilesets is disclosed. Techniques disclosed reduce the number of tiles required per decision module while still providing adequate control such as safe efficient control of a continuous controlled system. Decoupling as described in FIGS. 3A and 4A reduce the number of inputs, outputs, and tileset sizes by focusing the inputs and input thresholds and the output logical objectives relevant to the actuator. This decoupling also allows a single output value to be sufficient, allowing more efficient tile matching. An instance of a per-actuator TSIR structure is referred to as a tactical control module (TCM), wherein tactical as referred to herein means the control module is directly controlling an actuator. In decoupled control, there is one TCM per actuator in the control system for each actuator required of the controlled system. Note that this decoupling differs from some traditional partitioning of the control, for instance, by velocity, both horizontal and vertical, in which the associated control module controls multiple actuators.

In one embodiment, the immediate redecider simply has to redecide on the logical objective and thus directly or indirectly the sequence to execute and thus its parameters may simplify the tileset. By contrast, note that if a tileset was used to decide on next control values to write to the actuator, it may require more inputs and finer-grain thresholds, significantly increasing the number of tiles.

Several additional techniques may be used to reduce the size and complexity of each tileset, including:
1. dynamically adaptive temporal sequencing;
2. partitioning the control decision mechanism based on different logical objectives to reduce the tileset complexity;
3. current state-based decision making;
4. delegating the damping out of potential rapid oscillation of control decisions to a pre-matching step;
5. delegating to input preprocessing to produce “need-to-know” inputs for decision making;
6. defaulting some combinations of inputs by recognizing that operational constraints make these combinations of inputs not allowed; and/or
7. using a decision tree representation of each tileset, to reduce space and lookup cost.
   Such techniques may be used to further reduce the number of input value combinations, that is by widening input ranges that need to be individually labelled as well as reducing the number of output tile labels required, and thus the number of tiles required for each control module, and consequently, the number of test cases. They also facilitate first-match semantics that then allow for efficient mapping of inputs to a matched tile.

Dynamically Adaptive Temporal Sequencing. In one embodiment, a temporal sequencer, such as (402)/(402m) in FIGS. 4A/4B respectively, implements dynamically adaptive temporal sequencing. As referred herein, dynamically adaptive temporal sequencing means that sequencer (402)/(402m) may change specific parameters and the state of the temporal sequence to adapt to a particular situation, before and as a sequence is executed.

For example, with an autonomous aircraft, the immediate redecider (404) of FIGS. 4A/4B may decide to fly from airport A to airport B, and pass that logical objective to sequencer (402)/(402m). The sequencer (402)/(402m) then maps that objective to a sequence that flies through a sequence of waypoints with each step or step subsequence being from one waypoint to the next. The sequencer (402)/(402m) may compute what those waypoints are, based on a routing method to find the shortest path that meets certain application criteria. The method may be to compute various paths between airport A and airport B and pick one with a lower cost. Therefore, the “decision” on which path to take may be feasible and easy to implement.

With dynamically adaptive temporal sequencing, the sequencer simply has to implement a single sequence for each logical objective. Continuing the above example to illustrate, there may be a single Cruise sequence that steps through a parameterized list of waypoints. This contrasts with less dynamically adaptive sequencing, having to implement a sequence that is specific to each starting airport and destination airport pair. Thus, dynamically adaptive temporal sequencing may require far fewer sequences. As a consequence for the redecider (404), there are fewer sequences that it needs to decide between, and thus fewer tiles required. In particular, in this example, the current airport and the destination airport may be parameters to the sequencer (402)/(402m) that do not constitute additional dimensions for the tileset for redecider (404).

As another example with an autonomous aircraft, the controller portion for controlling roll, upon receiving an input logical objective to change heading, may have its sequencer (402)/(402m) pre-compute the aileron angles to take at each of a series of steps in order to carry out a turn in an aircraft, then executing each step by providing the associated value to the aileron actuator. This might be regarded as micro-navigation by analogy to actual navigation where the route to the destination is determined as a sequence of waypoints, and may be referred to herein and in the art as trajectory planning. Here, the “route” to changing the heading is determined as a set of roll “waypoints.”

The temporal sequence is thus adaptive because it adapts the control values it provides according to the behavior of the controlled system, as indicated by the sensor feedback on the controlled system state. For example, with an autonomous aircraft, the controller adapts the values it indicates to the aileron actuator in order to achieve and maintain a target roll, reacting to the actual roll over time, as indicated by the associated sensor/sensors.

In one embodiment, sequencer (402)/(402m) also selects among a subset of sequences that are suitable to achieve a specified logical objective. For example, if the input logical objective indicates climb rapidly, the sequencer (402)/(402m) may decide whether that objective is best achieved by a normal climb sequence or by a separate emergency climb sequence. This dynamic adaption is based on a form of extrapolation. For instance, in the first example, each path is extrapolated to the destination, with the shortest one being picked. In another example, at the roll actuator level, the extrapolation is used to determine a path and its associated waypoint settings of control values required to execute the turn.

In this embodiment, the temporal sequencer (402)/(402m), besides precomputing the parameters for steps in the sequence, may determine the time/expected time to perform the sequence by combining the estimates of the time to perform each step. For example, the precomputing of the waypoints provides an estimate of the time to fly to the specified destination and also possibly the amount of fuel required. As another example, the plotting may determine whether the aircraft may achieve the take-off speed within the limited length of the runway as well as achieve a certain altitude after the end of the runway to avoid obstacles.

Given a mechanism to pre-compute sequence parameters, it is simpler to use this mechanism during the execution of the sequence to make it even more dynamically adaptive. In particular, the sequence values may be pre-computed at a step in the sequence to update the parameters for the rest of the sequence, as required to achieve the objective. Consequently, the parameter values determined by the pre-computation may be updated during the execution of the sequence to reflect the actual state of the controlled system as it progresses through the sequence. For example, if the aircraft encounters a strong headwind, it may use more fuel and take more time to complete getting to the next waypoint than at previously determined. That results in the estimated time of flight to be updated.

In general, precomputing of the parameters to use in a temporal sequence has several improvements:
1. It allows a temporal sequence to be more highly parameterized, reducing the number of temporal sequences required and simplifying the steps. Each step may use these pre-computed values. For example, rather than a separate sequence per destination, an autonomous aircraft may have one waypoint-following sequence, with the pre-computation filling in the exact waypoints;
2. It allows the time, and potentially other resources such as fuel, required by the temporal sequence to be estimated in advance; and/or
3. It allows the refinement of an extrapolation/estimation mechanism used to pre-compute the sequence parameters, both at the time of sequence execution as well as for subsequent sequence executions. The extrapolation mechanism reduces the dependence on fast corrective feedback during sequence execution.

In one embodiment, the precomputing and updating of sequence parameters provides values that are then input back into the redecider (404). For example, the amount of fuel required for a flight may be computed and fed back to the redecider, allowing it to determine if the flight is feasible given the amount of fuel available. In particular, an indication of whether the delta between the amount of fuel required and that available in the aircraft is positive may be provided as an input to the redecider. If this input indicates a negative delta, the redecider may redecide on continuing with the current flight plan and seek out a close airport because it is low on fuel. This situation can also arise because there is a leak in the fuel tank.

This embodiment may be an improvement over a traditional PID controller because it provides the above improvements, and also because the extrapolation may be corrected over the many timesteps of the sequence, making it more resilient, including resilience to feedback latency. Moreover, the extrapolation may be coupled to a specific sequence, for example, specific to the aircraft performing a banking turn. By contrast, a traditional PID controller may simply correct its error on each timestep based on an updated process variable. Therefore, it may overshoot if the process variable is not updated in time and tends to get misled if there is any misreading of the process variable.

In one embodiment, a sequencer (402)/(402m) uses a conventional adaptive controller component to provide the actual control values as output rather than specifying them directly. For example, in an airspeed control subsystem, the control values may be implemented by a PID controller. The PID controller setpoint (SP) is specified to this controller by the sequencer based on the current step in the sequence it is on. The process variable is the actual airspeed as measured by an airspeed indicator.

Partitioning Per-redecider Tilesets based on Logical Objective. In one embodiment, tilesets for a redecider (404) are partitioned based on logical objective. For example, with an aircraft, the Taxiing logical objective is quite distinct from the Take-off logical objective and from the Stopped logical objective. An autonomous aircraft autopilot may use one instance of the tileset for control while Taxiing and then switch to another when Taking off. This transition between tilesets may take place at the point the aircraft is positioned on the runway and cleared for take-off because the expected state of the aircraft for take-off after taxiing into position is the same as that achieved by taxiing, that is stopped or slow and aligned at the start of the runway.

This logical objective partitioning may be realized by a traditional “switch” statement that branches on the input value of the logical objective, exploiting the fact that the logical objective may be indicated by an integer in a relatively small range. Thus, the redecider (404) may be realized with a tileset per input logical objective.

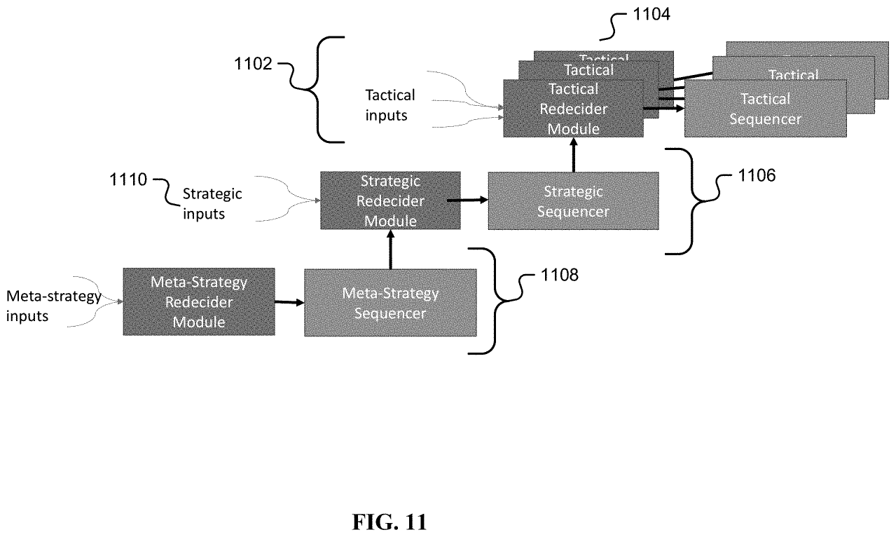

FIG. 9 is a block diagram illustrating an embodiment of a redecider realized using multiple tilesets. The redecider (404) accepts as input a designation of the logical objective (902) and other inputs (904). The redecider (404) then selects out of a multiplicity of tilesets (906a), (906b), . . . (906l) one that corresponds to the input logical objective (908). It then uses this tileset to match the other inputs to a tile to generate the decision (910), that is the tile label which determines the sequence to use. Its associated sequencer (402) then executes the sequence indicated by the generated decision.

A single sequencer (402) is shown in FIG. 9, which may be appropriate because in many applications, the same sequence may be selected with different logical objectives, such as in the case of the decision overriding the input logical objective. In particular, it may still be possible for the tileset for one logical objective to select a sequence that is normally selected by another tileset. For example, with an autonomous aircraft, the tileset for the logical objective of climbing may redecide, for certain inputs, to override that objective in order to avoid a stall and instead redecide on the sequence that handles level flight. However, it is a matter of engineering choice on whether to provide separate sequencers or a single shared sequencer in each TCM.

In logical objective partitioning, the tiles that are duplicated are ones where a tile is not specific to a particular logical objective. In some applications, this leads to a low degree of tile duplication. For instance, with an autonomous aircraft, climbing is substantially different from descending. The former is working against gravity while the latter is working with gravity or benefitting. In the case of an autonomous vehicle, accelerating is using a separate system like a throttle system, then slowing down which uses the braking system.

In logical objective partitioning, a tileset may not need to handle all the inputs that are relevant to the overall redecider. For example, altitude as in distance off the ground may not be relevant for being stopped or taxiing. However, altitude may be relevant to performing banking turns and landing when in the air. Reducing the number of inputs to a per-logical objective tileset further reduces the complexity of this tileset.

The code that switches on the input logical objective checks that the transition to this logical objective is allowed, given the previous logical objective and the state of the controlled system. For example, with an autonomous aircraft, the transition from taxiing to climbing may not be allowed whereas take-off to climbing is allowed if the take-off has put the aircraft in the air at a reasonable airspeed. As another example, a manufacturing line may transition from initial state to starting up to running, but not directly from the initial state to running. In general, a controlled system may have the notion of adjacent logical objectives like the above examples and only allows transitions from one logical objective to an adjacent logical objective. An adjacent logical objective is adjacent as referred to herein in the sense that the operating domain for the tileset of one overlaps with the tileset operating domain of the other. The transition is only allowed when the controlled system is in this overlap region.

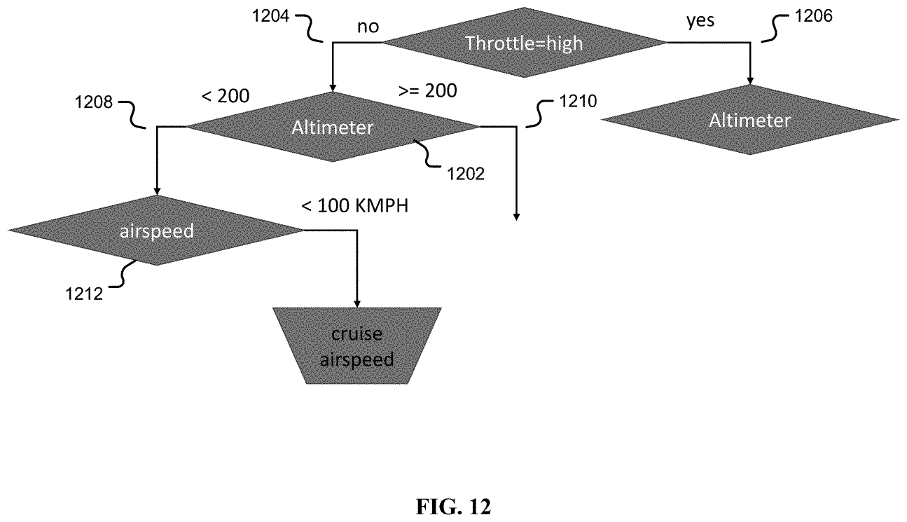

FIG. 10 is an illustration of an overlap region between take-off and climb for an autonomous aircraft. The diagonal “///” patterned portion (1002) indicates the operating domain for take-off, covering from 0 airspeed and no altitude/on the ground up to take-off speed and then to higher altitudes, to allow the Take-off objective to be used when aborting a landing.

The diagonal “\\\” patterned portion (1006) indicates the operating domain for Climbing, wherein the altitude is for example at least 200 meters and the airspeed is at or above take-off speed.

The crosshatched patterned portion (1004) indicates the area of overlap between the tilesets/operating domains. The unpatterned portions (1008) are boundary tiles for both tilesets. As shown in FIG. 10, the airspeed at the take-off speed overlaps with the minimum airspeed required to climb, and the same is true of the altitude. Therefore, the switch from Take-off to Climb logical objective is allowed in this overlap region. Similarly, a Take-off Abort logical objective tileset overlaps with that of the Take-off logical objective, at least in the early to middle part of take-off, allowing the aircraft to make the transition to aborting the take-off.

In one embodiment, the next logical objective may be indicated in advance yet takes place when a lookup in the tileset of the next logical objective indicates that the controlled system is within its operating domain, that is not matching to a boundary tile. In this embodiment, the module providing the next logical objective simply needs to know the adjacencies at the logical objective level, not the specific regions in which the transition is allowed.

This logical objective partitioning of tilesets described herein may be applied to other distinct scenarios of control. For example, a separate tileset may be used with a TCM and a given input logical objective when the fault detection system provides input that there is internal fault to contend with. For example, a two-engine aircraft may switch to a separate tileset if one of the engines has failed or been shut-down, thereby dealing with the different flight characteristics.

In one embodiment, an instance of a redecider (404) redecides based on one or more inputs of which actual tileset to use. For example, with an aircraft autopilot, this instance may select between normal cruising and handling a stall. This preselection of a tileset reduces the number of tiles to consider in the matching, thereby reducing the matching cost. For example, the system disclosed herein supports an engineering choice between either changing between redecider instances on a change of scenario, or switching the tileset being used within a redecider instance as shown in FIG. 9.

By contrast with modularizing in typical software engineering, suitable modularization as disclosed has a significant impact on the ability to handle more than a small number of inputs, a limitation of prior art LUT controllers. The modularizing also improves the complexity, evolvability, and testability of the control system. Therefore, it is important to the utility of the disclosed in many domains of interest.

Current State-based Decisions. Without limitation, for clarity of example it is assumed there is a separate tileset for each different logical objective in a given redecider (404) of FIGS. 4A, 4B, and 9. This does not exclude using the same tileset for two or more logical objectives when appropriate. In one embodiment, the redecider (404) makes decisions based on the current state of the controlled system and its environment, not on the past. This contrasts with a planning approach in which decisions are based on a previously generated plan. Such a current state decision approach is made more practical by having a sequencer (402)/(402m) implement, for every multi-step sequence S, a subsequence SS that corresponds to the steps of S starting at Step i, continuing to the end of S. That is, it is a suffix of S in terms of steps.

For example, an autonomous aircraft may have a sequence Si to fly above a storm, involving climbing to a suitable altitude above the storm, passing over the storm, and then descending to a preferred altitude. However, it should also have a sequence Sj to handle the situation in which it is above the preferred altitude but over a storm (or other obstacle), so needs to get past this obstacle and then descend to the preferred altitude. Therefore, the redecider (404) may just switch to Sj once Si has completed the first step and still complete the original objective. That is, the redecider (404) need not distinguish between being part way thru the Si sequence versus simply finding itself above a storm with the preferred altitude being lower than its current altitude.

Note that re-deciding on the sequence is consistent with the overall requirement of being prepared to change the sequence at any time based on changing situation. The extra decision logic required to stay with Si rather than switch to Sj may add complexity and risk; it adds risk because it would introduce the case of deciding something different for a given situation based on what was redecided earlier. There is a risk to the redecider decision considering the past beyond that encoded into the current state because that consideration may interfere with the redecider (404) reacting immediately to the current conditions, as required in certain changes of scenarios.

Continuing the earlier example, the storm may dissipate or move away so the current conditions are different from those that prompted and justified the selection of sequence Si. In this case, the redecider (404) selects a different sequence, independent of what was redecided at earlier timesteps except for its effect on current state, namely the aircraft being at a higher altitude.

From a complexity aspect, it is an improvement to simplify redecision based simply on the current state and the expected future state, and not consider the past. The past is adequately encoded in current conditions, such as current airspeed, climb rate, and so forth. Past state may also add extra input dimensions to the redecider (404), increasing the number of tiles required.

Note that subsequences are important to provide in the sequencer (402)/(402m) in some cases because it is possible for the controlled system to end up in a particular state in many cases for reasons other than executing a particular multi-step sequence. For instance, as in the earlier example, the aircraft may end up above a storm and at higher than the preferred altitude because the preferred altitude changed and a storm moved in under the aircraft; it is not necessarily the case that the redecider (404) previously selected sequence Si above. Nonetheless, it may be possible in some controlled systems that the only way the controlled system should end up in a given current state is by executing an initial M steps in a multi-step sequence Sk. There still needs to be a tile that corresponds to this current state that indicates that the current state is consistent with continuing with this sequence Sk.

Note that given the continuation subsequence is a suffix of the steps in Sk, there may be relatively little implementation difference between continuing with Sk in step M+1 versus executing a new sequence Sl that implements the Sk steps from step M+1 to the end. Providing the subsequence in this case also avoids having to determine with complete certainty that the associated conditions may rarely arise without being in the midst of the current sequence. Therefore, it is an improvement to have every subsequence and a tile for each step of a multi-step sequence.

Note that a subsequence approach relies on having the next step being chosen based on the current state and objectives independent of the original logical objective, assuming the conditions have not changed to invalidate this choice. The only way to have a sequence of actions in which the next step is only compelling in terms of an original objective is for there to be a “hidden” cost of doing otherwise or a “hidden” benefit to continuing with the original sequence.

For example, if an autonomous aircraft finds itself above a storm at a high altitude, it should fly over the storm and then descend if that is warranted by current conditions whether it ended up in this state by following the sequence described in the above example or by the storm moving into position under it when it was at this altitude and the altitude ended up being high because the target altitude changed. Normally, the costs and benefits of previous decisions and sequences are encoded in the current state. For example, the fuel expended to get to a higher altitude is represented in the aircraft being at the higher altitude. In some cases, such as a financial investment control system, the “sunk” costs are implicit in the benefit or return on an investment, factoring in the costs incurred to acquire the investment as well as the costs to sell it. Overall, using subsequences as described herein ensures costs and benefits of selecting a given logical objective being determined from the current input state and the selected logical objective, with little or no hidden costs or benefits.

Damping Oscillation with Pre-Matching. A risk with current state deciding is that slight oscillation by an input across a threshold may cause oscillation in the decision from one timestep to the next. With a stricter application of discrete input thresholds, a control system implemented using tilesets as described in FIG. 6 may be at risk of oscillating between two or more tile matches by slight variation in one or more inputs.

For example, if a controlled system is an aircraft and one of the inputs is airspeed, the airspeed could oscillate around 500 km/h because of variation in headwind, variation in reading from the airspeed sensors, or true variation in the speed of the aircraft. If there is a tile threshold on this input at 500 km/h, this slight variation in airspeed may cause oscillation, described herein as rapid switching between two or more tiles, between a tile matched for 500 km/h or greater versus that matched for less than 500 km/h, from one timestep to another. This may cause different tile labels to be output from one timestep to the next, and thus may cause a rapid change in the logical objective specified to the sequencer (402)/(402m).

This behavior of oscillation may be destabilizing, potentially inefficient, or even dangerous if there is a significant difference in the control settings between these tiles. Stated another way around, the tileset approach without further mechanism may require far more thresholds and thus more tiles so that the difference between adjacent tiles is minimized in order to achieve acceptable behavior in the case of oscillation.

In one embodiment, when a single tile match is expected, the damping is provided by a prematching step, preceding the matching of the current input values to a tile in the tileset. This step determines whether the current input values are within the tile boundaries of the tile from the previously matched tile, extended with a margin on one or more of its dimensions.

For example, the airspeed thresholds for a current tile may be 300 km/h as the minimum and 500 km/h as the maximum. In this pre-matching step, the maximum may be extended with a margin of 50 km/h, so the input airspeed continues to match this current tile until it exceeds 550 km/h.

If a previously matched tile is matched using this extended boundary during a prematching step, the tile label on this previously matched tile is output and the input values are not matched against the full tileset. Otherwise, the processing continues to do a match of the current inputs to the tileset in the usual way. The pre-matching is straightforward to implement because it just entails retaining an indication of the tile boundary of the tile matched in the previous step, expanding the boundaries of that tile to allow for the associated margin, and then determining if the current input values are contained within the expanded tile boundaries. With this prematching step, small oscillations in the airspeed around 500 km/h do not cause matching to a different tile.

If the airspeed does exceed 550 km/h, pre-matching fails and the input values are matched to a separate tile with a minimum airspeed threshold of 500 km/h. However, once this occurs, the pre-matching would again introduce a margin so that if the margin for this minimum threshold is say 20 km/h, the matching may not switch back to the other tile until at least the airspeed was measured at below 480 km/h. Therefore, the airspeed would have to oscillate by more than 70 km/h to cause oscillation in the tile matching, and it may have to do so rapidly in order to cause harmful oscillation.

In one embodiment, the margin is determined per input dimension and may be a function of whether it is a minimum threshold or a maximum threshold. It also may be a function of the threshold value or the threshold range and the actual input values. For example, the margin for 500 km/h as the airspeed maximum threshold for a tile may be computed as 10 percent of its value, so 50 km/h as above. However, at 200 km/h maximum threshold, the margin is 20 km/h, as 10% of 200.

Although these above examples without limitation have focused on just one dimension, the pre-matching step may use a separately computed margin on each one of the input dimensions, which may be potentially separate for the minimum and maximum margins for each input dimension.

In one embodiment, this margin is not applied when an adjacent tile represents a singularity situation. For example, with an aircraft, if the input airspeed is less than the minimum that puts the aircraft into a stall situation, the margin may not be applied on the boundary. Therefore, once the input indicates the adjacent tile, the control responds immediately with a corrective action.

Conversely, a singularity tile may have margin to overlap with a non-singularity tile or another singularity tile. Thus, control may act to get the controlled system significantly out of the singularity situation, rather than changing behavior when just barely out of the situation. This approach may not tend to lead to oscillation between the non-singular state and the singularity because, as defined herein, the singularity produces a non-continuous transformation of the state of the controlled system. Consequently, when this new state is reflected into the input to the decision module/modules, it maps to non-adjacent tiles to the original tile. Moreover, using the margin for singularity tiles means that the controlled system has to get significantly outside the singularity state before matching to a tile that handles a non-singular situation.

In one embodiment, multiple matches are allowed in the same tileset per timestep, and the matched tiles from the previous timestep are used to suppress matched tiles in the current timestep after this new matching. A new tile Tj is suppressed if its label corresponds to the same control as a previously matched tile Ti and the input is also matched to Ti with the expanded margin. For example, if the tileset provides overlapping tiles and uses multiple tile matches to handle both airspeed and roll at the same time, a previously matched tile for airspeed can suppress a new tile for airspeed, but not one whose label corresponds to roll angle.

Using a pre-matching step with margins is an improvement because it avoids rapid oscillation between tiles/different logical objectives. Therefore, the logical objectives may be significantly different while still achieving smooth, efficient, and safe control. This also avoids the full cost of matching input values to a tile on every timestep, assuming reasonably-sized tiles relative to the normal dynamics of the controlled system. Consequently, in the expected case, the same tile is matched across multiple consecutive timesteps.

The above techniques may produce a smaller number of discrete output values/labels per redecider (404). With a redecider per sequencer and per actuator as described in FIG. 3A, the number of tiles required to output these different discrete output values is not large. That is, if there are D discrete output values, D is a lower bound on the number of tiles required and it is small, for example, in the count of tens rather than millions for some practical complex systems. Note instead, it is the input value combinations that tend to be large, potentially driving up the number of tiles required significantly.

Delegating to Input Preprocessing to Provide “Need-to-Know” Redecider Inputs. In one embodiment, each tileset is further simplified by having input preprocessing that produces values that are designed to be specifically and minimally what the tileset needs as input to make its decision.

For example, to decide whether an aircraft has enough runway in front of it to take off, one approach is to provide its position on the runway, the length of the runway, the current airspeed, the rate of acceleration, and the required take-off speed. However, instead, the selected take-off temporal sequence can provide an estimate of the time required to reach take-off speed as feedback, the input preprocessing for tileset can pre-compute the time before reaching the end of the runway, assuming acceleration to take-off speed and the preprocessing can provide the delta value between these two values as a single input to the redecider. It may even simply provide as input an indication of whether this delta is positive or negative.

Consequently, this input preprocessing may reduce the number of inputs required by the tileset down to a much smaller number and to a coarser range, thereby significantly reducing the tileset complexity. Moreover, some portion of this input preprocessing may be specific to the TCM and to a tileset being used, that is the tileset in the module for the current input logical objective.

For example, continuing the above, the indication of having time to complete take-off is only computed when the take-off sequence has been selected. On the other hand, the delta of the amount of fuel left versus that required to reach the destination may only be computed when the aircraft has taken off and is cruising to the next waypoint.

The sensor preprocessor (206) in FIGS. 4A and 4B illustrates one embodiment with this actual sensor input data being preprocessed from its raw input data form into more suitable forms for the redecider (404) decision making. This may be considered extended analog-to-digital pre-processing/processing. There are traditional examples of this preprocessing. For example, a RADAR sensor provides a point cloud of data as its raw input data. These data points may be preprocessed into range detection in different directions, indicating the distance to an object from the controlled system. Distance from the controlled system may be discretized into multiple ranges by thresholds to fit into the tile approach. For example, an object at 1050 meters may correspond to the range 1000 to 1100 meters away. The inputs may also be pre-processed into a difference or percentage difference before being input to the tile matching procedure.

Another traditional input preprocessing example is systems with redundant sensors for reliability. In this case, the value provided to the control system is a value computed from the set of redundant sensors. For example, in an embodiment with three redundant airspeed sensors, the airspeed reported as an input to the control decision procedure is the average of the actual sensor values, after discarding any outliers that are far outside the expected range. For example, if the previous airspeed was 200 km/h, and at the current time, sensor 0 is reading 202 km/h and sensor 1 is reading 204 km/h and sensor 2 is reading 50 km/h, the sensor 2 reading is discarded as erroneous and the average of sensors 0 and 1, namely 203 km/h, is passed to the tileset matching.

In general, traditional input preprocessing to provide resulting values to the redecider (404) makes data more reliable and in a form best suited for decision making. This input processing is generally a translation of the actual sensor inputs. It may also provide protection against mistuned and erroneous sensors. There are fewer redecider (404) scope decisions, other than deciding to ignore certain sensor values as erroneous. Therefore, per-sensor input preprocessing is required in most, if not all, real control systems.

Two delegations to input preprocessing to provide “need-to-know” inputs to the redecider (404) include:
A. delegating root cause fault analysis and perception to separate subsystems; and/or
B. delegating preprocessing of inputs to separate layers and stages based on, in part, the temporal scope of the decision.

Delegating Root Cause Fault Analysis to a Separate Subsystem. In one embodiment, determination of fault indications in a controlled system is delegated to a separate automatic root cause analysis system, viewed as input preprocessing. This subsystem may receive a large number of inputs that allow it to detect important symptoms and thereby determine the root cause faults, if any.

U.S. Pat. No. 10,761,921 entitled AUTOMATIC ROOT CAUSE ANALYSIS USING TERNARY FAULT SCENARIO REPRESENTATION filed May 8, 2018 which is incorporated herein by reference for all purposes is one embodiment of such an automatic root cause analysis system. The output of this separate system may be a discrete set of current root cause faults that are then provided to the control system, in particular, to the redecider tilesets to which a fault is relevant. The same analysis mechanism may also provide impacts of the fault, that is the effect of a root cause fault that is relevant to the control system.

Delegating the determination of root cause faults to a separate subsystem reduces the number of inputs to a tileset. In particular, rather than having all the inputs required to do this root cause analysis, the decision mechanism instead has an input that provides the indication of the root cause faults or implications that are relevant to each redecider tileset.

For example, on an aircraft, if the actuator for the rudder fails, this has implications on the control of the aircraft in performing a turn. It may also mean that the aircraft needs to use engines and banking to maintain its flight path while cruising. Therefore, the control system needs an input indicating this failure. However, it does not require all the inputs that are needed in order to detect this failure and the myriad of other potential faults. Moreover, it simply needs to provide a specific fault indication to the tilesets to which the specific fault is relevant. The number of inputs required to detect some failures with confidence may be significant because there is not a direct sensor to detect every possible failure. For example, a rudder fault may require tracking deviations in the flight path that should not be arising, both on straight flying as well as on turns. Moreover, experience shows that sensors may be a major source of failures, so extra/redundant inputs may be required to avoid reacting to the resulting false positives.

Delegating Perception to A Separate Subsystem. In one embodiment, perception is delegated to a separate subsystem, as there are potentially a large number of inputs required to perceive a relevant condition in the environment. For example, an autonomous aircraft may have several RADAR, cameras, and LIDAR units to detect other traffic when in the air. It also needs to detect ground obstacles when on the ground.

Rather than having a redecider (404) receive those sensor inputs directly, a separate perception system may “decide” what is indicated by these inputs and provide a simplified summary in a smaller number of inputs to redeciders (404) in the control system.

For example, with an autonomous aircraft, the perception system in flight may simply provide an indication of any closing traffic in each of the four quadrants around the aircraft, at the same altitude as well as at the next adjacent altitudes, and at different distances. As referred to herein, “adjacent” refers to the next higher and next lower as defined by the air lanes that the aircraft are expected to follow and “closing traffic” refers to traffic whose distance to the aircraft appears to be reducing over time. For instance, the aircraft simply needs to know there is traffic in the quadrant at the front-left that it is overtaking rapidly in order to take evasive action. By delegating the processing of faults and environmental conditions to separate subsystems, an actuator tileset may be significantly reduced in size and complexity.

The same approach of delegating to a localization subsystem may be used if localization is separate from perception. That is, the localization of the aircraft relevant to a given tileset may be provided by a separate subsystem with further pre-processing in the module to provide the minimal “need-to-know” information to the tileset. Referring back to the above preprocessing example, preprocessing provides the delta between the time to the end of the runway versus required time to reach take-off speed, based in part on the localization of the aircraft on the runway.

Delegating based on Temporal Scope. In one embodiment, determination of strategy as longer-term behavior is delegated to a separate subsystem that provides strategic input to the “real” control system. The term real control system as referred to herein is the portion of the control system actually setting control values in actuators. This reference is in part because controlling the actuators is a true control of the controlled system. This layer, consisting of a TCM for each actuator, is considered the tactical and operational level, because it reacts in a short timeframe to short timeframe input changes. For example, with an autonomous aircraft, the tactical level needs to be redeciding every 50 milliseconds based on changes in the environment immediately around an aircraft, such as an approaching other aircraft.

This strategy information is considered as input to the real control system because the control system does not necessarily carry out strategy indicated by this input. That is, the strategy subsystem does not dictate or control what the tactical/operational layer does; it only “suggests” actions. This is because short timeframe considerations may force an override of the strategy being indicated by this input.

For example, with an autonomous aircraft, the strategic subsystem may provide input that “suggests” executing a change in heading, but the TCM layer may override that suggestion if the aircraft is dealing with a potential stall or collision or mechanical failure which makes this suggestion unsafe to attempt. This suggestion structure is consistent with a view that the tactical layer is delegating the processing of some inputs to these other layers, treating the result of this delegated processing as just another input to the tactical layer.

By delegating the determination of strategy to the strategy layer, the tactical layer is improved because the tactical tilesets simply need as input the resulting strategic recommendation rather than all the inputs associated with determining this strategy. The latter inputs are not applicable to the tactical layer in general because they are longer timeframe inputs and often coarser grain inputs than what is needed for the tactical layer. This delegating to the strategy subsystem therefore reduces the size of each tileset at the tactical layer.

Delegating to the strategy subsystem may allow the strategy subsystem to be shared across multiple TCMs that arise from decoupling across the multiple actuators. Sharing is feasible because the strategy normally applies to the whole controlled system, not just one actuator. For example, with an autonomous aircraft, the strategic subsystem may provide input that suggests revising the trajectory to fly around a storm rather than strictly following the shortest path “sequence” to the next waypoint. This strategy applies to the whole aircraft and calls for coordinated action across all the TCMs. Thus, a single strategy subsystem is appropriate.

The inputs to the strategy subsystem are necessarily longer timeframes than those at the tactical/operational layer because the strategic objectives take longer to achieve. Continuing the previous example, the strategy of flying around a storm may take minutes whereas reacting to close inbound traffic may need to take place in subseconds. A different temporal perspective is thus used, recognizing a suitable time in advance that this strategy is appropriate and feasible to execute in the time available.

As another example, illustrating the opposite, an autonomous vehicle may have a strategy to pass a slower vehicle in front on the left and then merge back. However, this strategy may not be appropriate to apply in the situation that the autonomous vehicle needs to take an exit on the right before this strategic maneuver can be safely completed. To make the correct decision, the inputs to the strategy subsystem need to indicate condition minutes in advance in some cases, such as the time to the next exit. By contrast, at the tactical level, the times typically are subsecond and in finer-grain units than “kilometers to the next exit” for example. Because of the difference in the temporal timeframe that each portion deals with, separating the strategy portion from the tactical portion avoids complicating the longer timeframe with excessively fine-grain time measures relative to its requirements, and avoids complicating the shorter scope with a longer time horizon than needed by its requirements.

In one embodiment, a strategy subsystem is implemented using a TSIR structure. In particular, for a given controlled system and environment, there are typically a bounded number of strategies. For example, with an autonomous aircraft flying into a significant storm system, one strategy is to turn around and go back. Another is to land as soon as possible. Another is to fly around or above the storm. Each of these strategies requires a sequence of steps that may therefore be implemented by a strategy sequencer. The strategy parameters may be adjusted during the execution of the strategy by the sequencer or the redecider deciding a different sequence or different sequence parameters. Finally, the strategy redecider is tasked with receiving inputs and deciding on the best strategy to execute. For example, with an autonomous aircraft, the conditions at one point may indicate to fly over a storm whereas the environmental conditions may change, so the strategy redecider decides on a new strategy/temporal sequence that corresponds to flying around it to the east. The tileset/tilesets used by the strategy subsystem may re-decide on a different strategy by matching to a different tile, based on the changed inputs, the same processing as that used at the tactical level.

In one embodiment, the sequencer portion of the strategy module provides different input logical objectives to different TCMs. For example, with an autonomous aircraft, the strategy layer may instruct the airspeed TCM to increase, the flaps TCM to half-deploy, and the roll TCM to go to a slight roll to the left in preparation for landing. By providing these separate objectives, the strategy layer further simplifies the TCM layer redecider and tilesets because each TCM only has to decide how to carry out its specific objective, not what its objective should be from the higher-level objective that the strategy agent decides on or how to coordinate with other TCMs.

Thus, when instructing two or more TCMs differently at a step, the step translates the logical objective of the step to a logical objective for each TCM. For example, with an autonomous aircraft, if the sequence is to perform a turn and climb, the steps may be specifying the logical objective in terms of airspeed, roll, and pitch to coordinate the tactical TCMs. The strategy module is thus not decoupled in the way that the tactical layer is. However, this coupling may not complicate the strategy redecider tileset/tilesets because the coupling is strictly in the sequencer. The individual actuators may be relatively independent in how they are set and their associated TCMs receive relatively low-level objectives that are relatively independent so the coupling may not be handled in the sequencer portion. Therefore, a coupling at the tactical layer would typically require the input logical objective that is effectively the cross-product of the input logical objectives of two coupled actuators, significantly complicating, and thus increasing the memory size and processing cost of the tilesets.

The strategy layer itself may delegate further to a separate meta-strategy subsystem. Such a layer is concerned with a higher-level strategy of how to get the controlled system to operate according to application objectives, outputting to the strategy layer a path from the current state to some identified end goal state. For example, with an aircraft autopilot, it determines how to fly from the current location to a designated destination by providing a sequence of waypoints to the strategy layer.

In one embodiment, this layer includes a redecider and a sequencer that executes the sequence that is designed to achieve the logical objective selected by the redecider, the TSIR structure.

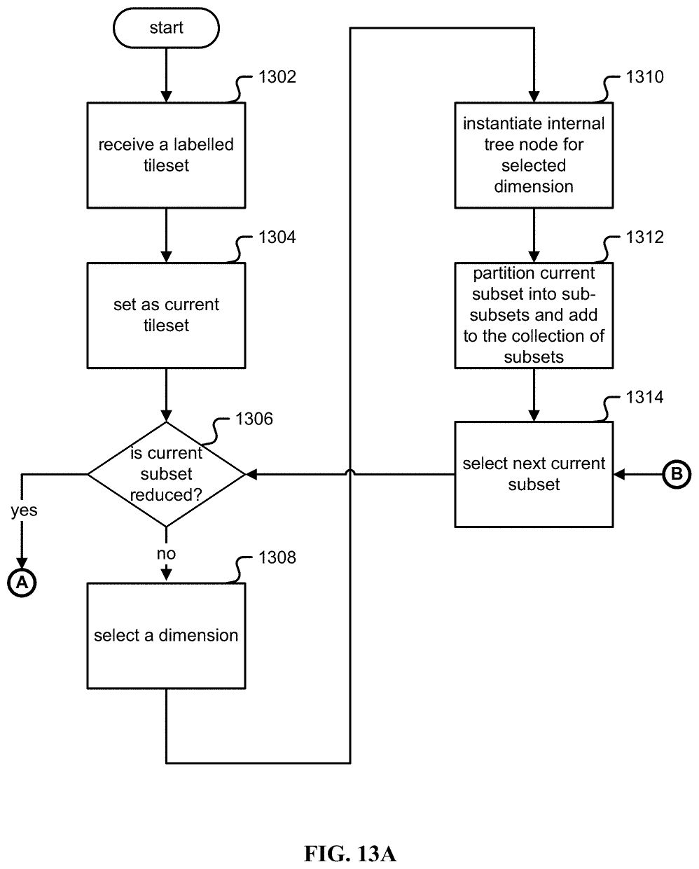

FIG. 11 is an illustration of an embodiment of redecider/sequencer pairs structured as a hierarchy. As shown in FIG. 11, the hierarchy comprises a tactical layer (1102) with multiple instances of TSIR structure, that is TCMs (1104) receiving input from a strategy layer (1106), and the strategy layer receiving input from a meta-strategy layer (1106). Recall from FIGS. 4A/4B that each sequencer may also have additional inputs which are not shown in FIG. 11 without limitation for clarity. FIG. 11 indicates two layers of strategy, namely a base strategy and a meta-strategy, but without limitation this is for simplicity and clarity of presentation. A control system using the disclosed may have more than two layers of strategy, and multiple strategy modules per layer if appropriate, extending the example structure in FIG. 11. That is, a strategy module at layer m may provide input to a strategy module at layer m−1 or less.

Note that FIG. 11 may be different from a traditional philosophy, which views meta-strategy as a higher-level than strategy which is a higher-level than tactical/operational. For example, a traditional AI subsumption architecture puts the lower-level behaviors corresponding to operational at the bottom, with the higher layers such as strategy inhibiting or blocking, that is controlling the lower layers.

In the disclosed delegation model, placing tactical/operational at the top is more appropriate because the tactical level (1102) makes the ultimate control decisions and treats the strategy input (1106) as just another input which it may use or override as conditions warrant. For example, an autonomous aircraft tactical control should not follow the strategy to climb if its inputs indicate that the aircraft airspeed is close to a stall condition. That is, the tactical level (1102) need not synchronously wait for the strategic level (1106) or the meta-strategy (1108) module to provide its input to the tactical layer, unlike a traditional staged calculation. Furthermore, the strategy (1106) and meta-strategy (1108) modules may execute at a lower frequency than the tactical/operational layer because the tactical layer (1102) provides a much faster response.

Note that a key aspect in the structure described in FIG. 11 is that the strategy (1106) and meta-strategy (1108) layers need not “command” the tactical-level modules but rather “suggest” in their inputs what the tactical layer (1102) should try to accomplish, recognizing it may still override these suggestions if necessary.

Note that an improvement with the disclosed structure is that the tactical layer (1102) is not strictly dependent on the strategy (1106) and meta-strategy (1108) modules. Also, these latter modules (1106), (1108) may be prepared for the tactical layer (1102) to not accomplish what was suggested.

For example, meta-strategy (1108) and strategy (1106) layers may be prepared for a landing to be aborted and to retry the approach. In this sense, this structure is similar to traditional OSI (Open System Interconnect) network layers: the Network Layer IP (Internet Protocol) on the Internet is “best effort” in the sense of delivering a packet if it can. The Transport Layer TCP (Transport Control Protocol) is prepared to verify whether the action was successful, for example, packets were received, and retry if necessary. Furthermore, the Application Layer is expected to detect if the Transport Layer indicates it may not have succeeded and then take action to handle and recover. In this analogy, the tactical layer corresponds to the IP Network Layer, the strategy layer is similar to the TCP Transport Layer, and the meta-strategy layer corresponds to the Application Layer.

Note that with such delegation, the complexity and cost of the tile sets in the tactical layer (1102) are reduced/improved because the number of inputs required for each layer is reduced. For example, tactical decisions require inputs that reflect short-term conditions whereas strategic decisions require inputs that indicate conditions over a longer term. The delegation in this case means the tactical control layer (1102), (1104) only needs the short-term condition inputs plus the strategic input (1106), not the inputs required to make the strategic decision.

For example, the instantaneous roll angle, pitch, airspeed, and/or windspeed may not be relevant to the strategic decisions with an aircraft so this decision module (1106) has fewer dimensions than if it were incorporated with short-term tactical control (1102). Similarly, the tactical TCMs (1104) do not need to know aspects of the next waypoint, airspace restrictions, and air traffic control input. Therefore, the number of inputs to each TCM is reduced, and thus the size of the tileset is reduced compared to if it directly has inputs that take longer term considerations into account.

The reduction in number of inputs in a layer improves/reduces the dimensionality and thus the number of tiles by an exponential amount. Thus, the K inputs required to make a strategic decision (1106) may be removed from a combined strategic-tactical layer when it is reduced to just tactical control (1102). The one or more strategic inputs (1110) are reduced through the module to a single input (1106) into this tactical layer (1104) provided by the strategic sequence output, namely its input logical objective. This reduction in number of inputs reduces the cost of producing the tiles as well as the cost of matching inputs to the tiles.

Another improvement of this modularizing is that the separate subsystems may be developed, tested, and updated independently. For example, a refined version of the strategic control (1106) may be developed without changing the tactical layer and thus without a need to retest/re-certify this layer.

A further improvement of the disclosed delegation is that a single instance of the strategic subsystem may be shared across all the modules of the tactical layer. This is a reduction/improvement in processing cost, memory, and communication over having the strategy being separately determined in each tactical module.

A further improvement of the disclosed modularity is that the different layers may be structured as separate processes so they may be executed in parallel and restarted after failure independently for high availability.

In one embodiment, a modularity to the decision making may be based on other criteria as well. For example, an autonomous aircraft autopilot system may be structured as three layers: the meta-strategy layer (1108) decides if it is feasible to get to the specified destination and then provides waypoints as input to the flight director (1106), the strategic layer. The flight director provides the strategy to get from one waypoint to the next, providing input to the tactical layer (1102). Then, the tactical control layer of the autopilot determines how to maintain safe flight and achieve the maneuvers as suggested by the input from the flight director.

In this example, a separate instance of a control system/TCM (1102) may be used for control of each actuator to achieve short-term safe flight that follows a specified trajectory, if that trajectory is safe to follow. Another instance/TCM (1106) may be used to generate suggested changes to the trajectory in order to follow the route identified by a conventional navigational system. The output of the latter (1106) is provided in some form of logical objective as input to the former (1102) to instruct it on the trajectory. For instance, the latter module (1106) may decide on a new heading that requires a right turn. This decision is input to a former module (1102) which then banks the aircraft to initiate the turn, assuming it is safe to do so.

Overall, note that delegation to separate subsystems improves/reduces the number of inputs, thereby improving/reducing the tileset size per decision module. It also improves/reduces the cost of tile matching by allowing the matching on each tileset to be performed in parallel and at different frequency, typically an improved/lower frequency in many cases.

Per-redecider Selection of Inputs and Thresholds. It is an improvement to minimize the number of actual inputs to a redecider in order to: minimize the number of tiles required; minimize tileset generation cost; minimize the tileset space cost; and/or minimize tile matching cost. It is also an improvement/beneficial to make the per-tile range for an input as large as acceptable for this redecider to make decisions that lead to acceptable control. In particular, note that the range for an input dimension ID for tile T may be such that a more extreme value for that input may result in a different logical objective/sequence.

For example, with an autonomous aircraft, tiles that correspond to “cruising” as a logical objective may reasonably correspond to the entire flight envelope of the aircraft in terms of airspeed and load factor. As illustrated above in FIG. 8, the tiles approximate a continuous function. It may be most efficiently done with different width of tiles on the same dimension. Thus, note that in FIG. 8, the width of tiles along the airspeed dimension, and thus in airspeed range, change as needed to best approximate the continuous curve.

Thus, note that considering logical objectives first, a redecider may require as input its own logical objective so it knows what it is supposed to achieve. However, in many cases, it may not need the logical objectives of other redeciders as input. It may instead be sufficient for it to have the corresponding process variables instead.

For example, the redecider controlling roll with an autonomous aircraft may need to know the actual airspeed, that is the process variable, but does not need to know the logical objective being provided to the redecider controlling the airspeed. This is because: the actual effect on the roll is based on the actual airspeed, not the objective, and/or; the airspeed objective may only change the airspeed incrementally over time so the roll redecider has time to adapt as necessary to changes in airspeed because of the airspeed TCM input logical objective.

Not including other logical objectives as inputs reduces the number of dimensions and thus the number of tiles but may also avoid considering cases that should not occur, such as the airspeed logical objective going from cruising speed to taxi speed or cruising speed to stopped.

For each redecider, the process variables and environmental inputs may also be reviewed to determine which ones are necessary, such as which ones a particular actuator is actually sensitive to. For example, a redecider for roll may be sensitive to airspeed and altitude so these two inputs may be included as inputs for the roll redecider. However, it may not be sensitive to the amount of crosswind in conditions of airspeed and altitude that it is prepared to go to a significant roll angle.

A redecider may not need an input I because the effect of this input I is reflected in another input that it already has. For example, the roll redecider example above may not need the rate of climb variable and/or pitch process variable because any significant pitch is expected to show up as an effect on airspeed. Similarly, it may not need inputs on faults because they are represented adequately by their effect on airspeed. Therefore, these inputs need not be included.

There are other inputs that may be provided directly to a TCM for its sequencer but not its redecider tileset, so the behavior of the TCM is sensitive to that input but that input is not required as input to the redecider, and so is not an input dimension for the tileset. In one case, the redecider may require this input but only as being in coarse ranges.

For example, with the roll redecider example above, the redecider may need to know the altitude only in terms of knowing if the aircraft is high enough to perform a bank, a hard bank, and/or an emergency hard bank, so there are effectively just four categories/different ranges to handle, including the case of the altitude being too low. On the other hand, the sequencer may use the altitude as a much more fine-grained set of values or even essentially the actual process variable value.

In summary, carefully selecting the inputs for each redecider tileset is an aspect of minimizing the number of tiles required for the redecider which improves/reduces the size and complexity of a tileset.

Carefully Discretizing the Inputs. Picking the thresholds for each selected input, that is discretizing the inputs, is also a technique to improve/reduce the size and complexity of a tileset.

The tileset approach described herein implicitly discretizes each input into a collection of ranges, per input, where the range corresponds to the length of the side of a tile, in a dimension corresponding to that input. For example, take-off speed may be defined for a given tile in the range of 120 km/h or higher for a small aircraft with normal load and altitude. Picking these ranges and the resulting number of tiles has a significant impact on the cost of generation, storage space, and matching.

There are five categories of input, each with different criteria for selecting the discretization, the categories being:

1. input logical objectives;

2. process variable feedback;

3. environment input;

4. temporal input; and/or

5. fault condition input.

Input Logical Objectives. The input logical objective for a redecider is discretized and in a preferred embodiment, simply selects one of a plurality of tilesets to use, as illustrated above in FIG. 9. For example, an autopilot may have the discrete logical objectives of: cruise at the current altitude/speed/direction, line up for landing approach; landing; and/or taxiing.

In general, there are a small number of objectives because these need to be understood and implemented by a human operator when under manual control. That is, there may be tens of objectives, not thousands or even hundreds. A small integer may be assigned to each objective as in a traditional computer implementation of an enumeration. With a tileset per logical objective, the total number of tiles is the sum of tiles required by each logical objective. Because there is a single high-level objective at any given time, the amount by which the higher-level objective input multiplies the number of input value combinations is relatively small, for example, 10×.

Note that a small number of high-level objectives depends on the logical objectives being parameterized. For example, the high-level objective of “fly from current location to airport A”, where A is a parameter, means that it is the same logical objective and thus same sequence choice independent of which airport. The sequencer may record the parameters and so cancel the current sequence and restart with a new sequence if a parameter changes, even if the logical objective has not changed.

Process Variable Feedback. Besides a high-level objective input, the redecider also may need to know some parameters associated with this current objective. For example, it may need to know whether it is maintaining the right altitude, speed, and direction when cruising. This pertains to process variable feedback.

In one embodiment, each redecider may require inputs that provide feedback from the controlled system that indicate how the controlled system is responding to the objectives provided to the sequencers. For example, an aircraft has a specified take-off speed. This take-off speed is a threshold which allows the redecider to make the take-off decision, that is raise the elevators and lift off. The associated redecider needs to know if the aircraft has achieved this take-off speed. However, it is sufficient to know that the actual airspeed is in the take-off speed range. A coarse range as the feedback on the process variable is sufficient because the associated sequencer is controlling the actual actuators as well as providing the sequencing. The redecider does not need to deal with the throttle position or the acceleration of the aircraft, for instance. Instead, the redecider requires sufficient input to make its discrete decisions correctly.

In one embodiment, the ranges used to discretize a process variable are made as coarse as acceptable to achieve adequate control. The use of coarse ranges means there are fewer ranges and therefore, multiplicatively fewer tiles.

In one embodiment, for an input process variable corresponding to the logical objective, the feedback is provided by the input preprocessing as an indication of the difference between the logical objective and the process variable. For example, with an autopilot, if the aircraft is instructed with the objective to take off, the input is an indication of the difference between the take-off speed and the current speed. Therefore, the redecider may not cause lift-off until this input is indicating a positive difference.

Note that using the difference means that the redecider may not require as input both the target value and the current value. It also may increase the accuracy of control for the same number of discrete feedback input values. Continuing the above example, the discrete values for the difference between the target airspeed and the corresponding process variable may be: far below, slightly below, equivalent, slightly above, far above. Thus, the inputs are mapped into ranges, providing a relatively small number for this input. This difference category approach recognizes that analogously a human operator makes decisions based on the category of difference, not the exact absolute value or even the exact absolute value of the difference.

A related approach is to identify and specify “lanes” as a technique to discretize the feedback, such as that described in U.S. patent application Ser. No. 16/795,236 entitled USING A LANE-STRUCTURED DYNAMIC ENVIRONMENT FOR RULE-BASED AUTOMATED CONTROL filed Feb. 19, 2020 which is incorporated herein by reference for all purposes.

Using lanes, environmental input for position may be reduced to the position within a lane and further to the difference between the actual position and the desired position within the lane. For example, if an aircraft is directed by air traffic control to a particular air lane, including altitude, the autopilot tileset/tilesets may have as input from the input preprocessing the difference between its current position and trajectory and that of the current air lane, with typically a separate difference for each dimension. Instead, the redecider may be required to redecide on how to reduce the difference from the target position and trajectory, discretized into a small number of difference category values as described herein, not dealing with the large number of absolute values for position, altitude, and trajectory.

In one embodiment, these discrete values designate a percentage difference rather than an absolute difference. For example, the feedback may indicate that the aircraft is at 5 percent below take-off velocity. This percentage difference accommodates the fact that the acceptable difference may vary, depending on the actual value. For example, being 20 km/h over the intended speed while taxiing may be an issue when navigating a corner whereas being 20 km/h over take-off speed is not. Using a percentage of difference in actual airspeed to intended airspeed, the earlier suggested discrete values map to percentages. For example, “equivalent” may correspond to within 3 percent of the intent, “slightly below” to at most 7 percent below, and “far below” corresponding to more than 7 percent below.

In one embodiment, the percentage difference approach together with a separate logical objective input that indicates the mode of operation, such as taxiing, take-off, cruising, or landing, allows each redecider to take different decisions that indirectly factor in the absolute value of a metric such as airspeed. For example, if the mode is “take-off”, the “equivalent” value as feedback on the airspeed indicates that the aircraft is close enough to take-off speed to go ahead with lift-off.

Note that using discretizing ranges of percentage difference between the process variable and intended value (SP), the number of discrete values required per actuator is relatively small, such as the five used in the above example. That fact combined with a limited number of such process variable inputs required by a redecider means that the amount by which the process variable feedback multiplies the number of input value combinations is bounded and practical. For example, with an aircraft, there may be altitude, airspeed, pitch, roll, and yaw, so with discrete values a multiplier of 625 may be used for the rest of the inputs. That is, 5 different inputs each with 5 different possible values equals 625 different input value combinations.

The method of tile generation, described below, basically starts with the fully known normal operating domain for the controlled system, and then incrementally extends the tileset to handle more extremes, without necessarily calling for intervention. In some cases, an existing tile is simply extended. In other cases, a tile is extended and then split according to what subregions have a common label or output logical objective. In this incremental extension process, one tile may have a different width on an input than another tile on that same input. Note that this variability of width, or any dimension, of a tile is the major difference between the tileset approach and a lookup table approach, where the entries are organized into rows and columns, thereby requiring the same range of input for the row input for every entry in a given row, similarly for columns.

Environmental Input. An input in the environmental category indicates some aspect of the environment of the controlled system. For example, the external air temperature, head windspeed, and cross wind speed are all examples of environmental inputs in the case of an aircraft autopilot.

As described above, the perception of the environment is delegated to a separate perception system that provides a simplified input to the appropriate redecider tilesets. For instance, the perception may indicate turbulence, storm activity, and other traffic in various quadrants around the aircraft at the same altitude or adjacent altitudes.

For other environmental input that is not handled by perception, discretization includes identifying thresholds at which a different decision result may occur between values below the threshold and values above the threshold. For example, if the crosswind is indicated as either none or present, and “none” is defined as less than 5 km/h, when the crosswind goes from 4 km/h to 8 km/h, the aircraft has to respond as though the crosswind has changed to some maximum value, such as jet stream speed. Therefore, it may be likely to overreact.

The solution is to provide adequate discrete values so that there is not an unsafe, uncomfortable, or inefficient transition in the control when an environment input value transitions between one range and another. In the above example, the crosswind may be classified as very low, low, medium, high, and very high, each with an associated threshold.

The threshold values of one input may be dependent to some degree on the values of other inputs. For example, the airspeed required during a turn may depend on both head wind and cross wind. As a continuous function, this may be visualized as a 3-D surface with the X and Y dimensions corresponding to headwind and crosswind and the Z dimension corresponding to the throttle setting. The discretization of these inputs and the surface may require that it be sufficiently fine-grained to adequately approximate this surface yet otherwise, as coarse-grain as possible to minimize the number of tiles. Such approximating is illustrated in FIG. 8 with boundary tiles.

The altitude is an example of an input that is both relevant as a process variable, reflecting a target set point, as well as an environment input to the redecider. However, as an environment input to a redecider other than the altitude redecider, it is needed as an absolute value, rather than just as a delta to the intended level. For example, flying below 200 feet in altitude may mean that any significant turn is too dangerous to execute so is immediately excluded by this threshold.

Therefore, the altitude may be discretized into “on the ground”, “low altitude” and one or more values corresponding to higher altitude. For example, at an altitude of 200 to 1,000 feet, the feasibility of safely doing a banked turn may be dependent on the airspeed being above some threshold whereas above 1,000 feet in altitude, a banked turn only depends on not being in a stall. As this example illustrated, the ranges and the semantics of the ranges may differ between different tilesets. The ranges may also vary within the same tileset for different values of the other inputs. Preprocessing of actual inputs may compute a difference or percentage difference or provide the absolute value as required by each tileset.

Note that because there is a relatively small number of environmental inputs and they can be discretized into a relatively small number of discrete values per input, the total multiplier in terms of input value combinations provided by environment inputs is also “small” for automation, that is on the order of 100 to 1000.

Temporal Input. In one embodiment, a tileset includes a dimension corresponding to the delta between the time required to achieve the objective and the time available to achieve the objective. For example, for an autonomous aircraft deciding whether to continue with the take-off objective, the time available is the time it has to reach take-off speed, based on the distance to the end of the runway and speed and expected acceleration, and the time required is the expected time to reach take-off speed, given the current airspeed and acceleration.

The time required may be computed by the temporal sequencer when it redetermines the parameters for the take-off sequence on a timestep. The sensor input preprocessing may compute the time available, based on the distance to the end of the runway at the current airspeed, and then compute the delta between these values and provide it as input to the redecider tileset. The redecider may thus map the current inputs to a tile that indicates whether to continue with the take-off sequence or abort the take-off. If an obstacle appears on the runway in front of the aircraft, the time available for take-off is reduced substantially so the matched tile would indicate aborting the take-off.

Note that the computation of the time required is delegated to the temporal sequencer because, in general, the time required is highly dependent on the specific steps to be taken in the temporal sequence. For instance, with an autonomous vehicle, travelling to a specific destination is dependent on determining the waypoints and how far each is apart amongst other factors, which the temporal sequencer is already tasked with determining. Moreover, it may need to redetermine periodically as the sequence is processed to determine the time remaining.

As with other inputs, the temporal input is discretized by thresholds as is the acceleration. In one embodiment, the thresholds are conservative. Therefore, it is possible that a take-off may be aborted when it is not strictly necessary. However, it is also possible that the current acceleration may reduce suddenly so it is possible the decision is optimistic. The inaccuracy introduced by discretizing the temporal input may be made comparable, if not subsumed by, the inaccuracies in the “required time” estimate because of unanticipated changes in the behavior of the controlled system, such as engine failure, or the environment.

The initial input of time required for a given input logical objective may be determined by communicating the take-off objective to the temporal sequencer, so that it computes the time required, and then redeciding in the next timestep based on this feedback input and the time available if the delta is negative. This approach leverages the fact that little is done to start the take-off sequence in the first 100 milliseconds or whatever the period is for the redecider.

In this example of take-off, each range of current speed effectively defines a subsequence of the overall take-off sequence. In particular, in a normal take-off sequence, the aircraft starts off at zero airspeed at the start of the runway. As it proceeds with take-off, it is both reducing the distance to the end of the runway, and thus the time available, as well as increasing the airspeed. Therefore, in the normal case, it progresses through a sequence of tiles that maintain the take-off decision. However, if it fails to accelerate as expected, the airspeed is less than required relative to the time available to match a tile for continuing with the take-off decision. Therefore, it matches to a tile that aborts the take-off, causing the sequence to change to aborting take-off. These take-off tiles may also be matched on aborting a landing because there is a “take-off” tile for a substantial airspeed and a relatively short time to take-off, as would arise if the landing is aborted after the aircraft has touched down but has not reduced speed significantly.

Note that this subsequence behavior is similar to what takes place in a more complex sequence using this system. For example, with an autonomous vehicle, to get around a slow vehicle in front, it needs to move to the passing lane, accelerate to pass the slow vehicle, and merge back into the original lane. The temporal requirement for taking this decision is the sum of the times for each of the steps.

Note that the same subsequence behavior applies. That is, once the vehicle is in the passing lane, the temporal requirement is reduced to that required to pass and merge. Therefore, the tile that is matched is a different tile, corresponding to the pass-and-merge sequence, with a different time requirement. Nevertheless, in the normal case, it is selecting a subsequence that is completing the original sequence, assuming the circumstances still indicate it should do so. As an example of a change of circumstances, the vehicle to pass may accelerate such that it is taking too long to pass or there is no need to pass. In this case, the tile that is matched indicates just to merge back.

Note that multiple actions may take place concurrently. For example, the sequence of landing on a runway involves aligning to the runway, descending to touch-down near the start of the runway, and reducing speed to taxi speed before the end of the runway, that is aligning and reducing airspeed may occur concurrently. In this case, the time required is the maximum of the times required by the concurrent sequences.

Fault Condition Input. In one embodiment, the fault condition input, as provided by a separate root cause analysis subsystem, is discretized by this subsystem as part of identifying the fault or the impact. Preprocessing of actual output of this separate subsystem may map its output to the actual input value appropriate for the redecider. For example, various faults that cause engine failure may be mapped to the single value corresponding to “zero thrust”, allowing the redecider to act on the single impact, rather than having tiles for each associated fault condition.

The input preprocessing in the control module itself may specialize the faults for those relevant to the module and even to the logical objective being handled. For example, with an autonomous aircraft, a simple indication of engine problem when the aircraft is taxiing is sufficient to indicate a return to hangar, wherein more details may be beneficial if the aircraft is cruising in flight to determine how urgent the situation is and how best to handle.

In summary, using one or all of the above five techniques, the number of input value combinations is generally in the low millions or less, making automatic exhaustive testing feasible.

Recognizing Operational Constraints. Note that for many controlled systems, there are combinations of logical objectives and other inputs that are not allowed or “not possible.” These combinations are excluded by operational constraints that are identified as part of the engineering design process.

For example, with an autonomous aircraft, the roll redecider should not accept a logical objective to bank if the airspeed is less than the speed required to fly or the altitude is too low. As another example, it makes no sense to bank left if the aircraft is stopped on the ground or taxiing. The “not possible” is in quotation marks because even though a combination should not occur, with unpredictable failures, it is possible for the redecider to receive such an input combination.

Operational constraints may also indicate the case of non-continuous behavior that arises in a controlled system, referred to herein as a discontinuity. For example, with an aircraft, when the wings stall, the lift forces that the wings are providing drop substantially quickly. The autopilot needs to respond immediately and appropriately to this exceptional condition. In these cases, the control often requires a recovery sequence, not a smooth modification to existing control. Moreover, it is often necessary to override normal behavior.

Furthering the example with a wing stall, the detection of wing stall may override the normal setting of the elevator control to ensure a nose-down orientation to the aircraft in order to recover airspeed and lift. This recovery sequence is normally defined as part of the engineering process so is known as the appropriate label for a tile/tiles that correspond to this condition. It does not need to be “discovered” by the prediction/simulation mechanism.

For example, with a nuclear power plant, it is not necessary to simulate the core exploding to know that a shutdown sequence needs to be initiated when the reactor overheats. Also, the prediction/simulation mechanism may not be highly accurate in simulating the behavior of the controlled system outside of its operating constraints, because it was not designed to operate in a predictable way outside of these constraints.

Note that a tile label may indicate a completely different behavior than its adjacent tiles. Therefore, an adjacent tile may indicate a normal operating sequence yet the current tile may indicate a recovery sequence because the threshold/thresholds that are crossed to get into this current tile indicate the system is outside its operating constraints and potentially represents a discontinuity in its behavior.

For example, a tile that corresponds to a stall condition may have a completely different output than the adjacent tiles that do not correspond to a stall. This is because there is no requirement in the described system herein for continuity between adjacent tiles. By contrast, a traditional continuous mathematics-based control system may require and assume continuity because of the use of continuous mathematics.

Note that an engineered system may not have a large number of discontinuities or unknown discontinuities. Otherwise, it is infeasible for a human operator to control. For instance, the human operator assumes that a little more throttle causes a slight increase in the rate of climb and airspeed, not a sudden large increase or decrease or other destabilizing behavior. Thus, because these discontinuities are known and relatively small in number, they do not add significant complexity to a tileset and may even be specified manually. Also, the handling of transitioning out of a discontinuity is handled by the overlap margin associated with the tiles, so that, in the case of an aircraft, the aircraft is significantly outside of a stall condition and thus overlapping with a tile corresponding to normal operation before the control transitions back to normal control behavior.

These operational constraints may define entire subspaces of tiles that should not occur or are not allowed and thus may immediately be marked as boundary tiles. For example, for the roll redecider, the entire subspace of airspeed being low or the altitude being low and the logical objective being other than level is in the category of not allowed. The operational constraints as applied to a given input logical objective may define the ultimate boundary tiles of the corresponding tileset. The term “ultimate” is used herein because initial versions of the tileset may use a more restrictive set of boundary tiles because the full range of input values allowed by the operational constraints have not been specified and tested.

In one embodiment, the tile label for all the tiles in a “not allowed” subspace corresponds to a neutral output corresponding to a neutral sequence, augmented with an error indication. For example, with the roll redecider, the neutral output is level, so zero roll and the error indication are simply reporting a not-allowed logical objective. The neutral output for the airspeed redecider may be cruising speed if non-zero altitude or else current airspeed if on the ground.

Note that operational constraints may also restrict the transitions between input logical objectives. For example, with an autonomous aircraft, it does not make sense to transition directly from cruising to stopped, or from stopped to cruising. The aircraft needs to go from cruising to landing to taxiing and then to stopped. With a multi-tileset redecider where the tilesets are partitioned based on input logical objective, the code to select the tileset may easily check that the new input logical objective is the same as the previous one or else corresponds to an allowed transition from the previous input logical objective. This code is another benefit of a multi-tileset approach. Checking the transition in explicit code is feasible and avoids having the tileset be complicated by having the previous logical objective as input, as would arise with a single tileset approach.

Note that using these operational constraints, identified during the engineering design (if not common sense for piloting in the above example), whole subspaces of tiles for each redecider may be pre-labelled/labelled, thereby reducing the number of tiles that need to be labelled based on more in-depth/expensive evaluation. Furthermore, all the tiles in a “not allowed” subspace may be merged into a single tile or a smaller number of tiles, thereby reducing the tile space and matching cost. Therefore, leveraging operational constraints reduces the cost to generate a tileset and also allows for efficient merging of tiles, thereby reducing the space and matching cost.

Decision Tree-based Matching and First Match Semantics. In a decision tree representation, the handling of a subspace may be represented as a single node subtree corresponding to the subspace.

The techniques described above allow a structuring of the overall control system as multiple redeciders so that a redecider needs a single result from each tileset lookup. This approach makes first match semantics acceptable, that is, return the tile that first matches because it has to be the only one. With a large number of tiles, the simple method of matching an input vector to one or more tiles by iterating over the collection of N tiles is expensive. First-match semantics make it feasible to convert each such tileset to a decision tree realization, thereby reducing the memory required to store the tileset and also reducing the cost to match an input value combination to the corresponding tile.

Note that first match semantics are expected with a redecider per actuator because a control application such as an aircraft autopilot needs to, at each interval, produce one control decision for each actuator, for example, whether to raise, lower, or keep constant the ailerons at each time interval. It would make no sense to have it “decide” to both raise and lower them. If a TCM produces two labels with a given set of inputs, it may not execute the two sequences concurrently if they are inconsistent so it is a problem to be corrected. If there are two sequences that are consistent for the same actuator, they are duplicative and again should be corrected. This contrasts with a coupled or MIMO control such as an autopilot needing to produce two actions for different control variables, such as raise the elevators as well as increase the throttle. The decoupling means that there is one decision output by each TCM redecider.

In one embodiment, the tileset is transformed into a decision tree, starting at a root node. An input dimension is selected and associated with each node. Each child node of a given node corresponds to a range of input values in the dimension associated with its parent. Each leaf node stores the tile label corresponding to the tile reached by the path from the root of the tree to this leaf.

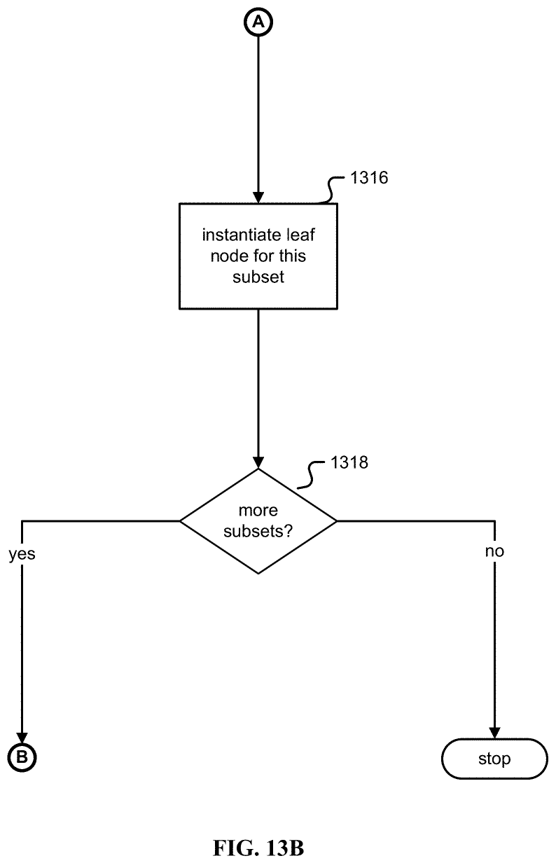

FIG. 12 is an illustration of a portion of a decision tree mapping inputs to an associated tile label. As shown in FIG. 12, the Altimeter node (1202) is generated with dimension corresponding to altitude and a range corresponding to greater than or equal to 200 meters. The input is a vector of input values, one for each of K input dimensions. In this example, the tile is defined by the throttle, altimeter, and airspeed values being within the range for each of the interior nodes on the path from the root to this leaf node and the label is “cruise airspeed”.

The resulting decision tree is referred to as a comparison-based decision tree (CBDT) because each interior node only performs a comparison, possibly a multi-way comparison. Note that a comparison-based decision tree, as the term is used herein, differs from a categorical decision tree because the latter branches strictly on categories, not continuous values, as a CBDT is able to. A CBDT is able to incorporate categories by considering the category identifier as a continuous value, as described earlier. Conversely, a categorical decision tree may be regarded as a restricted form of CBDT in which the only form of comparison allowed is comparison for equality. A CBDT effectively incorporates the discretizing of inputs by mapping each input value to a range, a discrete concept.

A CBDT may represent a tileset because each tile may map onto a path through the CBDT from the root to a leaf labelled with the tile label, wherein each dimension occurs as a node along this path with the matching range referring to the next child node on the path. The CBDT representation of a tileset typically significantly reduces the space required because the dimensions and thresholds are specified a smaller number of times compared to a list of descriptions of the tiles. For instance, as a simple example, if the root of a decision tree for an autonomous aircraft specifies airspeed and thresholds to determine which airspeed range maps to which child nodes, the airspeed and thresholds are specified once in total for the decision tree rather than once per tile as required if each tile is being specified independently.

In one embodiment only supporting binary comparisons, the multiple comparisons in the interior node may be replaced by a binary search tree of comparisons that map the input value for that dimension to the right child node.

Note that a CBDT has the property that test cases may be hierarchically enumerated and are proportional to the number of leaf nodes in the CBDT. In particular, the tests are first classified into a subset of the tests for each child of the root of the CBDT with each subset corresponding range mapping to this child. For example, as shown in FIG. 12, the tests are first classified into two categories corresponding to the subset with the throttle being less than max (1204) and the subset for the throttle equal to max (1206). Then, the subset of the tests that correspond to the throttle being less than max is divided into sub-subsets corresponding to the altimeter reading less than 200 meters (1208) and for the altimeter reading more than or equal to 200 meters (1210). This subdividing continues down to each leaf node, for example (1212), which then corresponds to an individual test case.

Note that the restriction to a CBDT is important for testability because, if a decision tree node uses any deciding expression or computation that is not equivalent to a comparison, the above testing property no longer necessarily holds. For example, if a decision tree node uses the expression “input1+input2<fooThreshold”, and input1 and input2 can take on arbitrary floating point values, dividing the test cases into those below this threshold and those above does not eliminate input 1 or input 2 from further consideration in the resulting subsets. More complex decision expressions may be even harder to determine the partitioning. Therefore, each subset entails considering a large number of values for each input, so the number of test cases may not be significantly reduced by considering such a subset. Note that, if an interior node branches on an expression that only uses one variable, such as “input1+constant4<barThreshold”, this is equivalent to “input1PlusContant4<barThreshold”, where input1PlusConstant4 is a new threshold that is equal to “input1+constant4”. Therefore, the above test classification property still holds.

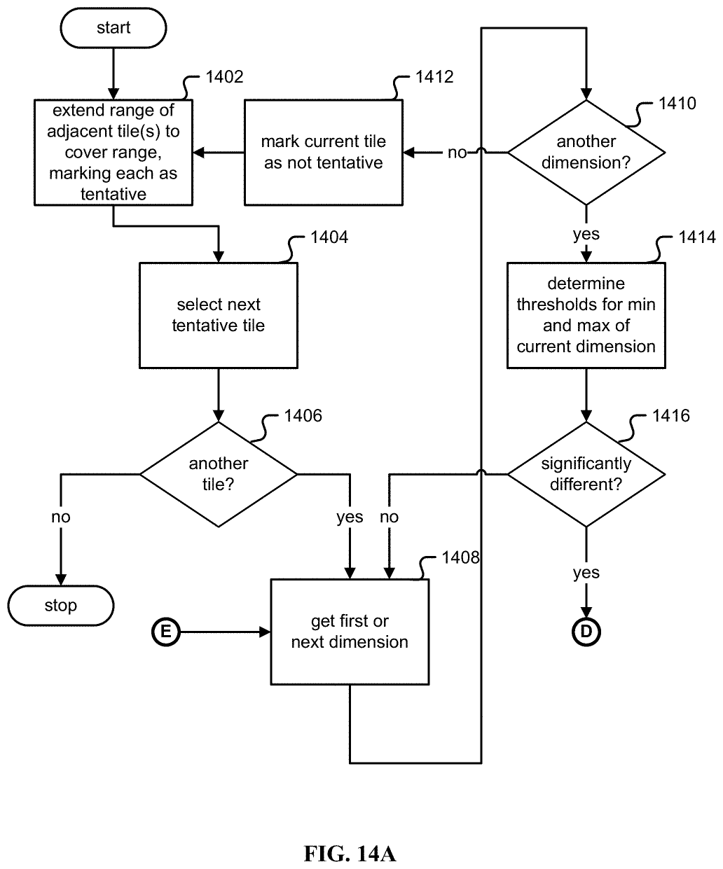

Decision Tree Generation. FIGS. 13A and 13B are a flow diagram illustrating an embodiment of a process of generating a decision tree from a tileset. In one embodiment, the process of FIGS. 13A and 13B is carried out by a control system, for example (322j) of FIG. 4A, (372) of FIG. 4B, or any system, for example FIG. 1.

In step (1302), a labelled tileset is received, and is established as the “current” tileset in step (1304). In the event that the current subset is not considered sufficiently reduced in step (1306), control is passed to step (1308).

The dimension selected in step (1308) to branch on at each interior node may be determined by developer input based on knowledge of the domain, empirical information, and/or by a traditional decision tree generation algorithm, such as “RBDT-1: a New Rule-based Decision Tree Generation Technique” by Amany Abdelhalim, Issa Traore, Bassam Sayed. Each interior node performs a decision or branch based on comparing the input value for that dimension to the possible ranges.

After selecting a dimension in step (1308), the instantiating of a new interior node is performed in step (1310), creating this node as a child of the current parent and setting its dimension attribute to that of the selected dimension in step (1308). The thresholds are the ordered collection of all the thresholds for this dimension occurring in the tile subset for this child subtree.

In step (1312), partitioning of the current subset of tiles is performed by creating a sub-subset for each range for this dimension, and adding to each sub-subset those tiles in the current subset that match this range for this dimension. Each such sub-subset is recorded with its parent node and its associated range relative to that parent, for subsequent processing. For example, referring to FIG. 12, the Altimeter node (1202) is generated with a dimension corresponding to altitude and a range corresponding to greater than or equal to 200 meters (1210). A next “current” subset is selected in step (1314) and control is passed to step (1306).

In the event that the current subset is sufficiently reduced in step (1306), control is passed to step (1316), wherein a leaf node is instantiated for the current subset. In the event that there are more subsets (1318) to process, control is passed to the next current subset in step (1314); otherwise the process is ended.

In one embodiment, a decision tree is built incrementally as tile labels are generated, assuming some criteria are available to select the order of dimensions in the tree for each path. For example, to repeat an earlier example, consider a three-dimensional tile for a roll decision corresponding to the dimensions: logical objective [13,14), airspeed [150,200) and altitude [200,500) labelled with 30 degrees. For this example, the first dimension for the tree is logical objective, then airspeed, and then altitude. On generating a label for this tile, corresponding to the 30 degrees, a path is defined in the decision tree from a logical objective root node that has a child node corresponding to [13,14), with that child node selecting on airspeed, creating this child node if it does not exist.

In this example, this child node has a subchild node corresponding to the airspeed in the [150,200) range, and this subchild node does a comparison based on altitude. This subchild node itself may have another sub-subchild node corresponding to the altitude being in the [200,500) range. This sub-subchild node is a leaf with a value or label corresponding to 30 degrees. After generating this path in the decision tree, the tile record may be discarded, thereby avoiding having to store a large number of labelled tiles, as is required when the tileset is generated in advance.

In this example, if a subsequent tile label is generated for a logical objective in the [13,14) range, this path uses the same child of the root for its path as the earlier tile. If this subsequent tile label has a different logical objective, a new child node of the root is instantiated with the correct/different tile label. If a new tile is determined to be adjacent to an existing path and has the same label, the path for the new tile can be merged into this existing path. For example, if the new tile specifies logical objective [13,14), airspeed [150,200) and altitude [500,1000) labelled with 30 degrees, the decision node for the altitude for the first path described above may be extended to have the range [200,1000) and map to the original leaf labelled 30 degrees. Note that this situation may arise because the 500 meter threshold is required for a different maneuver or set of subconditions. By merging in paths in this way, the number of nodes in the CBDT is reduced, with an improvement being a savings on space and time for lookup.

In this example, if the tile has a range for a current dimension that overlaps with the current ranges, the current node comparisons may be revised so that there are additional ranges, including those that correspond to the thresholds on the current dimension for this tile. For example, if the current tile has airspeed range from [100,300), the current node comparison handling [150,200) is revised to handle [100,150), [150,200), and [200,300). The current tile then is used to generate a path for the child nodes selected by each of these ranges.

Constructing a CBDT concurrently with tile generation may have an improvement in saving on space and processing to generate and store all the tiles. However, it may not be feasible to base the determination of the best dimension to select at each interior node based on the best information gain as done in effect in RBDT-1. This is because all tiles may not be available to review at the time the next attribute or input dimension needs to be selected. Therefore, the efficiency of resulting CBDT from this concurrent approach is more dependent on other means of selecting the dimensions at each interior node such as knowledge of the application domain. This knowledge may be specified to the decision tree generator as a priority of a dimension. In many applications, it is feasible to store each entire tileset and subsequently regenerate the decision tree for a tileset whenever that tileset changes.

If efficiently generated, matching using a decision tree may be logarithmic as a function of the number of tiles N rather than linear, as with the simple iteration approach. For instance, if N=1 million, that is, a million tiles, the lookup cost with a balanced binary decision tree is roughly 20 levels whereas it is worst case 1 million with a simple iteration. The improvement in efficiency of lookup is important for example to achieve fast response to changes. It is also important for overall efficiency if the decision making is a significant part of the overall control processing overhead.

Decision Tree Implementations. A decision tree may be implemented by translating a sequence of nested “if . . . then . . . else” constructs into executable code. For example, the tree of FIG. 12 may be viewed as a flow chart implemented in partial pseudo-code as:

```
if(throttle==high) {
  checkAltimeter( );
}
else {
  if(altimeter . . .
```

Such code generation is straight-forward for a person having ordinary skill in the art because a decision tree is equivalent to an expression tree used in the standard implementation of a compiler or interpreter, and/or the basis for generating code, including various optimizations. One possible disadvantage of this approach is that code size may be significant, causing processor i-cache misses to limit performance.

One alternative implementation is a tree data structure realization with a fixed procedure that walks down the tree data structure, locating the leaf corresponding to the input values. For example, each node may store a dimension and a list of thresholds and pointers to child nodes. The fixed procedure starts at a root node and then determines the dimension and the current input value associated with this dimension. It maps the input value to a range defined by a threshold Ti below or equal to this value and Ti+1 above this value and selects the pointer to the child node associated with Ti and Ti+1 that is stored between these two thresholds. This approach may be more efficient because the number of d-cache misses by the processor is proportional to the depth of the tree (log N), which may be harder to achieve with generated code given the code is proportional to the number of leaves in the decision tree. Various further optimizations are available using traditional techniques for both data structure representation and processing code.

This decision tree generated from a tileset differs from traditional decision trees generated from rules because the tileset guarantees that all legal values of each input are covered. This generation of decision trees also differs from traditional generation because traditional generation generates the decision tree from statistical data, rather than using strict ranges with the generation of a decision tree from a tileset.

Sequencer Design and Implementation. Each sequencer (402) of FIGS. 4A and 4B is specified as part of the engineering design of the controlled system or is known as part of the general operation of the category of the controlled system. In particular, the designer may identify the logical objectives required by the application as well as how the controlled system may achieve those objectives using a human/manual and/or automated controller, that is, the sequence of steps for each objective.

For example, in the case of a controlled system being an aircraft, the designer considers the airspeed objectives of: taxiing, take-off, climbing, cruising, approaching, and landing. For each objective, the engineering design designates the sequence of steps to achieve that objective. This set of logical objectives may be augmented by additional application requirements. For example, there may be an emergency climb, emergency descent, and/or emergency bank left/right required in order to avoid traffic in dangerous situations. There may also be a fast cruising speed required to meet schedule when running late or trying to avoid a developing weather system. The designer may also define, for each logical objective, the operational sequences to achieve it. Otherwise, there is no way to ensure that the engineered system is able to meet each objective. That is, how would one know that an aircraft can handle an emergency descent unless the operational procedures are defined for how to cause it to do so within the limits of the aircraft design?

Note that, with automatic control, there is no need for arbitrary values. For example, a fully autonomous aircraft is not at the whims of a human pilot who may have an old habit of flying at a particular airspeed. Instead, automatic control performance is considered adequate if it selects an airspeed that is a safe efficient choice for the aircraft that achieves the intent of the operator. Therefore, if discrete values are selected to provide key functional levels, such as suggested herein for the aircraft example, tile labels are adequate.

The engineer/designer in a typical design process also ensures that the controlled system may achieve the required logical objectives and describes constraints that apply in doing so. For example, different take-off airspeeds may be required depending on passenger/cargo load, temperature, and altitude of the runway. Moreover, there is a constraint on the amount of weight the aircraft may handle at take-off. Therefore, if an autonomous autopilot has access to these parameters by temperature sensor and altimeter, its airspeed sequencer may use the formula used by the designer to compute the take-off speed. The sequencer may then generate a series of steps to achieve this take-off speed and the time required to do so. The sequencer may then incrementally change the throttle at an acceptable rate and amount so as to converge on the specified airspeed or higher.

Other controlled systems may have similar logical objectives. For instance, an autonomous vehicle may use a sequencer for lateral position that receives a logical objective to change lanes. The objective is logical rather than specified to precise values because the width of a lane can vary. The logical objective may include desired tempo/cadence to achieve the objective, such as “normal” or “rapidly”.

As referenced above, a sequence may be implemented by a coroutine or as an actual thread, thereby being able to wait or suspend for specified time periods and conditions during the sequence. A sequence may also be implemented as a conventional state machine with the state keeping track of the step in the sequence that it is engaged in. However, a sequence is typically a sequence of steps and the state machine structure is more general and thus less indicative of the sequence actually being performed. That is, one has to look at the transition function for a given state to determine the next step from that state, and also require that there not be multiple transitions out of that state, so that it is actually a sequence. A sequence may also be programmed as a suspendable thread that executes these steps, using thread suspension and resumption to wait after each step for a fixed period or else until a given condition becomes true.

Overall, the logical objectives of each actuator-level sequencer may be specified by the controlled system designer, including the means to achieve them, in order to ensure the system meets application requirements. Therefore, the associated sequencer may be implemented by a person having ordinary skill in the art.

To make a sequence be preemptable, it may be sufficient to release any resources associated with the current sequence. For example, if there is a data structure storing the trajectory for the current sequence, that structure may be released or re-purposed to the new sequence when the current sequence is preempted. Most of the state associated with the sequence may be the state of the controlled system as reported by the input processing and thus independent of the particular sequence being executed.

Sequences may be developed from simple to more complex. For example, with an autonomous vehicle driving on a freeway, the strategy sequencer may first be developed with a sequence that implements the objective to switch to the passing lane, pass, and then merge back. Then, the pass-and-merge sequence is simply doing a pass, and then deciding to do the merge back. Then, the whole sequence is implemented by changing to the passing lane and then doing the pass-and-merge-back. The time required for the whole sequence is the sum of the time for each of the change to passing lane, pass, and merge-back sequence. One reason for identifying the full sequence of change to passing, pass, and merge-back is for this sequence to prompt the feedback data of the time cost for the whole sequence.

A sequence may simply terminate when it achieves its objective, relying on the redecider to select a new objective and thus a new sequence. Some objectives however are on-going. For example, with an autonomous aircraft, level cruising is a sequence that continues indefinitely until cancelled, that is it is non-ending. Note that the level cruising sequence may need to iterate to continue to detect if level flight is not being achieved because of some failure; it cannot just stop.

In one embodiment, sequences are made non-ending, in that each sequence causes the controlled system to converge to its logical objective and then simply maintains it indefinitely until cancelled, or else reports a problem with doing so. This is accomplished by specifying the logical objective as absolute, not relative. For example, the target airspeed is specified rather than indicating an increase or decrease relative to the current airspeed. Therefore, after the controlled system achieves a logical objective, it stabilizes there and waits for a change in logical objective, with the possibility that the new logical objective mainly indicates to stay with the logical objective. For example, if the sequence selected is “climb to cruising altitude”, once the aircraft reaches cruising altitude, it has reached its logical objective so it just continues to control to maintain that altitude. Thus, if the redecider changes to a “level flight” sequence, there may be no change to behavior of the aircraft at this point. In this approach, a non-ending sequence continues until cancelled and is replaced by another sequence. Consequently, there is no gap or race condition between the current sequence ending and the redecider selecting a next sequence.

As dynamically adaptive temporal sequences, the sequencer may adjust its actual output control values based on additional inputs, in addition to the associated decision module input, for example as part of a step. For example, different take-off airspeeds may be required depending on passenger/cargo load, temperature, and altitude of the runway. Similarly, an automated HVAC system may have a daytime label and a nighttime label, both of which are translated through a simple table to the actual configured temperature values for each setting. Note that this translation may not involve a decision per se. It mainly requires a translation using a pre-specified computation that is specified in the design of the controlled system and/or in its configuration, in the case of HVAC.

In summary, logical objectives/tile labels are determined by the designers/engineers of the controlled system and the requirements of the application of this controlled system. The sequence of steps associated with logical objectives is also specified along with any associated parameters and constraints.

Tile Generation. Tile generation involves generating, for each redecider with K inputs, a set of labelled K-dimensional tiles covering the range of possible K-dimensional vector input values, with each tile assigned a label that indicates the correct logical objective to provide to the associated sequencer for any input value combination that lies within this tile, which may be extended with margins except for edges adjacent to singularities. Such techniques reduce the number of tiles required in a tileset and may make the matching to the tiles efficient. How to generate a tileset is now considered.

As a note, consider a control system providing fully autonomous operation, starting with the tactical layer, then the strategy, and then meta-strategy layers, assuming that each is implemented according to that described herein, for example, a TSIR with the redecider using one or more tilesets. Without limitation, the description of control in terms of meta-strategy, strategy, and tactical with a regular example of an autonomous aircraft is only an example of the disclosed; this approach is not only applicable to control of vehicles. Meta-strategy is generally identifying a point in some P-dimensional space designating the state of a controlled system. The navigational aspect to a designated destination attempts to get the controlled system to a revised state while recognizing the constraints on the controlled system and required “waypoints” as intermediate states to get it from its current state to this destination state while recognizing the constraints and costs for the controlled system in doing so.

Meta-strategy may be required with other applications such as control of a manufacturing plant, navigating it from the production of one type of product to a different one, recognizing that there may be required “waypoints” between the current state of the manufacturing line and the next desired one.

In the following subsections, it is assumed that the sequencer has already been implemented or may be extended on demand to handle additional sequences. For example, with an autonomous aircraft, it would be implemented according to the normal pilot procedures, flying instructions for the aircraft, and the engineering specifications and constraints.

Tactical Laver Tileset Generation. One task is to develop a tileset per input logical objective per actuator to provide the redecider portion of the per-actuator TCM. This assumes the sequencer portion for each actuator of the controlled system has been designed and implemented, based on engineering design and specification of the controlled system.

In one embodiment, the approach to generation starts with a single input logical objective that corresponds to “normal” and/or common operation of the controlled system, a corresponding normal range input, and a fixed/trivial redecider for the TCM for each actuator. The approach to generation continues with incrementally extending the range of inputs and adding additional input logical objectives.

For example, with an autonomous aircraft, the “normal” mode of operation is cruising at a reasonable altitude and specified cruising speed with no faults or other traffic and with reasonable/initial inputs for cruising. Similarly, with a self-driving car, the “normal” operation is driving along a straight lane at the speed limit with no other vehicles or obstacles around and no faults in the system. Note that the “normal” input logical objective is not the initial logical objective typically. For instance, the initial state of an autonomous aircraft is stopped and on the ground. However, the “normal” state is flying/cruising from one waypoint to the next.

Because a redecider is initially fixed, the sequencer in each TCM is fixed at executing a single sequence. For example, with an autonomous aircraft, the sequence for the roll/aileron TCM when cruising would be to recognize when the target roll is significantly different from the current roll angle and then adjust the ailerons to bring the roll to the target. Thus, it relies on its sequencer to keep the roll angle close to the target roll angle. This sequence may also detect when there is excessive delay in achieving the target roll. However, it may not “decide” to effectively override the input logical objective, for example, resort to level flight instead of the roll angle because it is unsafe to perform this target roll because of the presence of other traffic. Similarly, it may not decide to override the target roll because the current airspeed is too low or the aircraft pitch is too high. Any of these constitute a different sequence in this TCM which may not be selected by the initial fixed redecider.

Initial Tactical Control Layer Tilesets. The fixed redecider for the one input logical objective, for example “cruising” in an aircraft, in each TCM may be replaced by a tileset that takes all or a subset of the K inputs as input dimensions and has a tile defined by the “normal” range of each input that is labelled with the same sequence as the corresponding original fixed redecider.

For example, with an autonomous aircraft, there is a range of cruising airspeeds, a normal range of roll angle for cruising, and a normal altitude range for cruising. A multidimensional hyperrectangle or tile defined by these ranges on each of the respective input dimensions and labelled with the same sequence as the fixed redecider would produce the same behavior as the original fixed redecider in each TCM. Therefore, it is feasible to produce an initial set of tilesets, one for each TCM, that replaces the original fixed redecider with one that uses the corresponding initial tileset for the current single input logical objective.

Note that these initial “normal” ranges may be conservative and not necessarily the extreme for which the controlled system was designed for the current input logical objective. For example, the lowest airspeed for cruising might be 100 km/h and the largest cruising roll angle may be 30 degrees. However, a conservative safe subrange may be 150 km/h or higher and roll angle less than 10 degrees. Using a safe subrange for each may avoid inter-input trade-offs that may require multiple tiles. For example, continuing the above example, 100 km/h may only be safe with a roll angle of 5 degrees or less. One alternative is to define multiple tiles in the tileset to handle this trade-off. However, the next step in developing the TCM layer is to extend the input ranges, so the preferred method is to start with a restricted range for the inputs that requires one tile and extend.

The normal range may include input scenarios in which multiple corrections to the controlled system are required. For example, with an autonomous aircraft, a scenario may be that its airspeed is slightly low and its altitude is slightly low. In this case, the sequencers for airspeed and for altitude/pitch may react concurrently to correct the airspeed and the altitude to produce reasonable control. As described herein, “reasonable control” includes efficient, stable, reliable, comfortable, industry-standard, established practice, and/or substantive control. In one embodiment, reasonable control is an autonomous level of control that produces a response similar to that expected of a human operator for a similar scenario.

In contrast, continuing this example, if the airspeed is too low to attempt any increase in altitude, a temporal sequence may be required for the pitch TCM that waits for the airspeed to increase before attempting to correct the altitude. In the extreme, the pitch TCM may sacrifice altitude temporarily to help recover airspeed and avoid a stall. These scenarios are outside the “normal” operating domain and are handled as part of extending the input ranges, as described below.

In one embodiment, each initial redecider tileset is extended with boundary tiles to provide complete coverage of the input ranges. Each boundary tile indicates an error and calls for intervention when the input values are outside of the initial input range. For example, continuing the above example, a boundary tile would match if the airspeed as input was below 150 km/h. Therefore, the situation of the control system is receiving input that is outside of its operating domain is detected. The use of these boundary tiles is preferred over simple limit checks on each input because in some cases, the boundary is defined across multiple inputs. For example, the lower limit on airspeed may be dependent on altitude and not be a strict constant boundary, as shown in FIG. 8.

Note that it is not necessary to incorporate every input at this initial stage. This is because if the input is assumed to be in a normal range, it is essentially fixed and so equivalent to a single “normal range” for that input so does not change the redecider output if it is within this normal range. Also, in some cases, the input has no effect on the redecider output for certain input logical objectives.

For example, with an autonomous aircraft, with a tileset for taxiing, the flap position may not be relevant because its value does not change the decision of the tileset for any set of inputs. As another case, an input is not required for a given tileset because the associated TCM may react to the effect of this input without having this input as a direct input dimension. For example, with an autonomous aircraft, if the aircraft goes to pitch down, it means that the airspeed is going to increase, causing the sequencer mechanism for the throttle to decrease the throttle in order to maintain target airspeed without having the pitch as an input. Similarly, pitch up means the airspeed is decreased, causing an increase in throttle, again without having the pitch as an input. Thus, it may be sufficient for the airspeed TCM to respond to the change in airspeed without explicitly knowing the degree of pitch. Moreover, the airspeed TCM should report an error if it is failing to control the airspeed. If the pitch is too severe, it may violate the operational constraints, exceeding the ability of the aircraft to control its airspeed, causing the sequence mechanism to report an error. Therefore, although the pitch is relevant to the setting of the throttle, the airspeed TCM can set the throttle based on the airspeed process variable without having pitch as an actual input to its tilesets. Minimizing the input dimensions reduces the number of tiles, and therefore gains the improvement of reducing the resource cost of matching as well as the difficulty in generating the tileset.

For an initial version, each input is restricted to an artificially limited range, thereby defining its initial operating domain. For example, with an autonomous aircraft, the airspeed may be restricted to being between the lower bound for cruising and the maximum normal cruising speed. Similarly, the altitude may be restricted to being in a reasonable range for cruising; roll and pitch are also restricted to being relatively close to level. The boundary tiles cover the complement of the initial operating domain, as shown in FIG. 8. Therefore, inputs outside of the initial operating domain match to a boundary tile that indicates an error and need for intervention. The defining of the boundary tiles is feasible; the regions of the K-dimensional space that are not covered by the operational tiles. For example, if the initial tile for an autonomous aircraft only covers airspeeds greater than or equal to 100 km/h, the range of airspeed from 0 to 100 is part of the boundary. Therefore, it is feasible to redefine the boundary tiles as the operating domain of a tileset is expanded.

With these restricted ranges defining the initial operating domain, the initial control system may only be required to handle control of the aircraft from initial conditions that are within these restricted ranges. Therefore, the control system may be presented with an initial state indicating the airplane has an airspeed below target but not so low that some emergency behavior is required to recover. Similarly, it may be presented with the initial conditions that the aircraft is above or below the cruising altitude and then correct for this discrepancy but not so low or high that a different sequence is required such as an emergency altitude correction.

Note that the actual value of the process variable for the actuator is input to the TCM for its sequencer component, but the input to the tileset for this dimension may be a discretized delta between this process variable and the target for the input logical objective, possibly expressed as a percentage difference, as discussed in a previous section.

The determination of this initial version of a tileset for each actuator and input logical objective is feasible because each is necessarily specified as part of engineering the controlled system, for example, engineering a controlled system for a human pilot to fly a plane. This engineering design typically includes determining the operational constraints for the controlled system and how it behaves when it is within its operational constraints. Also, the initial input logical objective as the “normal” operation of the controlled system is the most fully specified as part of engineering the controlled system.

For example, with an autonomous aircraft, “normal” operation is cruising at a constant speed with constant tracking towards the next waypoint, assuming no system faults and no external environmental conditions warrant changing the normal flying behavior. With a manufacturing plant, “normal” operation occurs when the assembly line is up and running for a particular product that there are no faults or external impediments.

At this stage, the control system may be tested, controlling the controlled system when the controlled system is within its initial operating domain. Typically, this initial testing is performed using a simulation of the controlled system. However, subsequently, this testing may be validated on the real system.

For example, with an autonomous aircraft, assuming that it allows for control by an operator, either locally or remotely, the operator may handle the take off and climb to a reasonable altitude, attitude, and airspeed and then turn the control over to this initial version of the control system, monitoring the aircraft, and intervening if the control system misbehaves or some fault or environment condition arises that goes beyond that handled by the control system. This intervention is triggered by the boundary tiles defining the operating domain, as described above, assuming the inputs are provided that detect all such conditions.

Once this initial version of the tactical control is implemented and tested, the next stage is to incrementally extend the operating domain of the control system by incrementally: 1) adding input logical objectives; 2) adding to the set of inputs; and 3) adding to the range of an input. This process may also require the introduction of additional thresholds for inputs. The extension to additional input logical objectives is considered next.

Extending Tactical Control with an Additional Input Logical Objective. Extending tactical control with an additional input logical objective may require adding a new tileset to each TCM to which the new input is relevant, assuming a separate tileset per input logical objective in each TCM. For example, with an autonomous aircraft, its initial tactical layer may support the “cruising” logical objective, as described above. The “climb” input logical objective may be added to extend this initial operating domain. Each actuator TCM may have to be extended to be able to receive a “climb” logical objective as input from the strategy subsystem.

Certain input logical objectives may be adjacent to an existing logical objective in the sense that the engineering of the system supports a transition from a logical objective to an adjacent one. For example, with an autonomous aircraft, the logical objective of “climb” is adjacent to “cruising” because an aircraft typically climbs to its cruising altitude and then changes to cruising where it is simply maintaining the cruising altitude. Similarly, “descending” is adjacent to “cruising” because it follows from “cruising” to bring the aircraft down to a lower altitude, usually in preparation for landing. In contrast, “take-off” is not adjacent to either “cruising” or “descending” because there is not an allowed transition between “take-off” and these other logical objectives.

One preferred method is to start with an initial version of the tactical control layer that handles the normal operating domain and then repeatedly incrementally add a new logical objective, adjacent to an existing support logical objective, to the tactical control layer. By adding an adjacent logical objective, it is feasible to test the transition between these logical objectives. Moreover, there are necessarily overlap input combinations between those for the new logical objective and an existing logical objective because of this adjacency. For example, “climb” to some target altitude is the same as “cruising” doing a small correction in altitude when the difference between the target altitude and the current altitude is relatively small.

Thus, to add a new logical objective, a first step is to identify an initial operating domain for this logical objective. For example, with “climb”, the operating domain may be airspeed of take-off speed or higher and an altitude of 200 meters or more and far less than the maximum altitude for the aircraft plus a close to level pitch and roll. This is basically the “normal” situation for the “climb” logical objective.

The next step is to define the corresponding tileset for each actuator TCM, assuming this normal operating domain. For example, the airspeed TCM may have a tileset for the “climb” logical objective that maps to a sequence that slightly increases the airspeed initially to anticipate an increase in pitch and to contribute to the climb. It then reduces to the target airspeed after maintaining the airspeed at the new pitch. The elevator tileset for this objective keeps the elevators at 0 degrees until the airspeed exceeds the target airspeed. For the aileron TCM, it primarily needs to keep the aircraft level.

Continuing this example, the “climb” logical objective may be expanded to include “turn” to allow the aircraft to climb and turn at the same time. For a given TCM, this “climb and turn” logical objective may use the same sequence in the sequencer, treating the case of no turn as a 0 degree turn, similarly for no climb. The airspeed TCM tileset for “climb and turn” may be aware there is a non-zero turn involved in the climb by having an input corresponding to the degree of the turn, perhaps discretized to four ranges for example. This may allow it to anticipate that more airspeed is going to be required because the aircraft is going to be banking as well as climbing.

An initial operating domain corresponds to the normal situation for this input logical objective so that the sequence or sequences are those specified by the engineering design of the controlled system and thus are known in advance. For instance, with an autonomous aircraft, the take-off sequence is specified as part of the engineering of the aircraft or else adapted from known piloting sequences. The initial operating domain does not include inputs that provide a reason to abort a current sequence and/or switch to another one. For example, with the “take-off” logical objective, the initial operating domain may not include inputs indicating external obstacles or system faults and assumes unbounded time for the take-off. In some cases, the initial operating domain may be handled by a single tile corresponding to the take-off sequence, optionally plus the boundary tiles that delimit this operating domain.

At this initial stage, the TCMs may be extended as described above to handle the input logical objectives that are used in the normal operation of the controlled system. This is made feasible because the normal case is defined as no faults and no externalities complicating the choice of sequences. Also, there is also a small, well-known set of logical objectives for the TCM layer to support normal operation. For example, with an aircraft in normal operation, it cruises, it climbs and turns, it descends and turns, it takes off and lands, it taxis and it stops. Therefore, it is typically feasible to incorporate the normal logical objectives handled by the TCM layer so that the controlled system can go through its normal operating behavior. In particular, a test may at this stage of development execute the control system through the normal sequence of take-off, climb, cruise, descend, land, and stop.

Extending Tactical Control by Adding to the Range of an Input. One next step is to extend the range of each input so that it handles more of the operating domain required by the application. Adding to the range of an input comprises either adding new tiles to cover the additional range, extending the range of one or more existing tiles to cover the range, and/or a combination of these two actions. For example, with an autonomous aircraft, if the airspeed is extended to lower values that then introduce stall conditions, additional tiles may be required that are labelled to indicate a stall-handling sequence. On the other hand, if the airspeed operating range is extended to a higher value, it may be that the same sequence is adequate to deal with it so the existing tile may be extended so that its airspeed range includes this higher value.

To extend an input dimension ID to a new maximum value MV, a first step is to determine, for a tile T that has the current maximum value for input dimension ID, whether it may feasibly be extended to this new maximum MV or whether an additional tile/tiles may be required. Additional tile/tiles are required if the label for a vertex V on the minimum edge for dimension ID of tile T has a different label than a potential vertex V with the same coordinate values as V except with the value for dimension ID replaced by the new proposed maximum value MV. Therefore, one technique is to evaluate the controlled system with this vertex V and determine the preferred tile label for that vertex. If this preferred tile label differs from the tile label for tile T, a new threshold may be required.

The new threshold may be determined by, without limitation and as one approach, a binary search between the old maximum and the new maximum, using the controlled system simulation/prediction to evaluate the tile label for each candidate threshold to find the one where the tile label changes from one value to the other.

In one embodiment, a technique to determine a new threshold comprises these steps:
1. make the candidate threshold CT be half way between the old maximum value and the new proposed maximum value;
2. evaluate the controlled system at the candidate threshold for this vertex V, i.e. using the values of vertex V with just the value in the extended dimension replaced with CT;
3. if the evaluation indicates this candidate threshold puts the system into a known characterized singularity, revise the CT threshold to be at the edge of this singularity and return the threshold value for this “edge”;
4. if the selected tile label is the same as the original label, if CT plus margin evaluates to the same tile label as that for the proposed maximum, or CT plus margin is greater than the proposed new maximum value, use this CT and exit. Otherwise, if it evaluates to a label that differs from the original one and from the label for the proposed maximum, return an indication of CT as the new lower bound. Otherwise, revise CT to be halfway between the new proposed maximum value and CT and return to step 2.
5. if the selected tile label is different from the original label, revise CT to be halfway between the previous maximum value and CT and return to step 2.

The search returns a new lower bound for the search if there needs to be more than one threshold between the old maximum and the new proposed maximum. The search is then repeated for range from this new lower bound to the new proposed maximum, but the result is handled as replacing the new maximum rather than as a new threshold. That is, this result indicates the threshold at which the tile label changes from the new label to yet another new label. Therefore, it ensures that the final new maximum that is used only requires one threshold between the old maximum and the ultimately selected new maximum. In effect, this method finds the threshold such that it transitions from one tile label to another, also reducing the proposed maximum threshold if necessary so there is at most one threshold required between the old maximum and the new maximum, or else indicates no threshold is required.

A similar method is used to determine a new threshold if the input range is extended to a new minimum value, adapting the steps above to minimum.

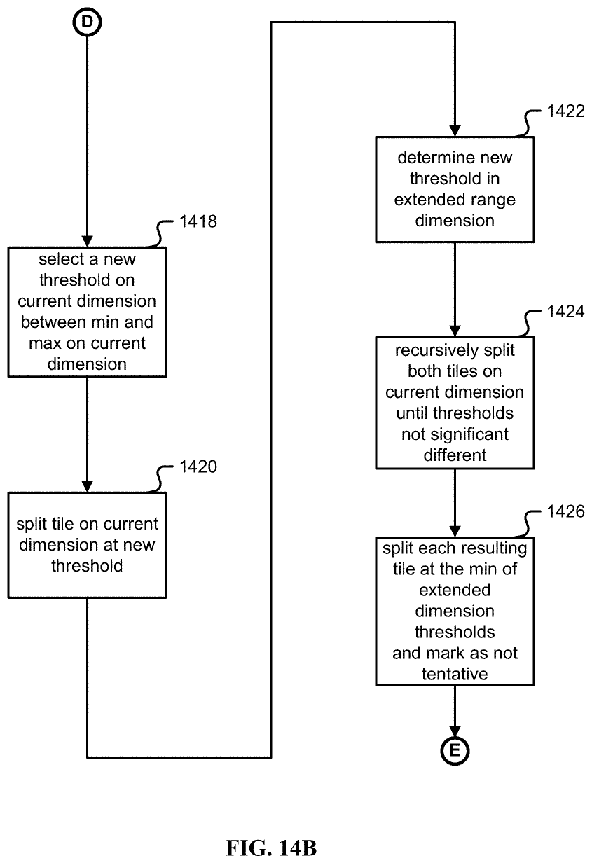

FIGS. 14A and 14B are a flow diagram illustrating an embodiment of a process of extending an input range. In one embodiment, the process of FIGS. 14A and 14B is carried out by a control system, for example (322j) of FIG. 4A, (372) of FIG. 4B, or any system, for example FIG. 1.

In one embodiment, when an input range is extended for a given input dimension and TCM, the steps are as illustrated in FIGS. 14A and 14B. Assuming the minimum value of the input range to be extended is being extended:
1. In step (1402), extend the adjacent tile/tiles that are adjacent to the extended range to include the new range, marking each as tentative on the new extreme of this extended dimension;
2. In steps (1404) through steps (1426), iterate over these tentative tiles, that is, for each tentative tile selected in step (1404) determine if another tile is to be processed in step (1406). In the event there is not, the process of FIGS. 14A/14B ends, otherwise, control is transferred to step (1408):
   A. In step (1408), get the next dimension, which may be the first dimension for a newly processed tentative tile, and for said dimension. For the current dimension selected in step (1408) determine if another dimension is to be processed in step (1410). In the event there is not, control is transferred to step (1412); otherwise, control is transferred to step (1414):
      1. In step (1414), the thresholds for the min and max vertices for this current dimension are determined using the technique described above, reducing the new extended range minimum if necessary so there is at most one new threshold per min and max;
      2. In step (1416), determine if there is a significant difference between these thresholds for the min and max for the current tile. In the event there is not, control is transferred to step (1408) for the next dimension; otherwise, control is transferred to step (1418):
         i. In step (1418), select a new threshold for the current dimension between the min and max for this current tile on this dimension;
         ii. In step (1420), split the current tile (into two parts) on the current dimension based on this new threshold;
         iii. In step (1422), determine new threshold in extended range dimension. For example, evaluate the controlled system with input corresponding to the vertex using this new threshold for the selected dimension to select a new extended dimension threshold for this vertex;
         iv. In step (1424), if the new extended dimension threshold is significantly different from the threshold for the min, recursively repeat this splitting for the tile on the current dimension between the previous min on the selected threshold and the new threshold. Recursively do the same comparing this threshold to that of the max threshold, for example, until thresholds are not significantly different; and/or
         v. In step (1426), define the new extreme on the extended dimension for the first split tile as that of the threshold at max for the tile. That is, the split of the original tile is extended to this new threshold, and make this first split the current tile. Define the new extreme for the second split tile as that of the threshold for the new threshold on the extended dimension. Mark the resulting tile as no longer tentative for the current dimension;
   B. In step (1412), mark the current tile as no longer tentative.
3. As the process of FIGS. 14A/14B ends, output the resulting revised tileset.

Informally, this technique may find, for each tile adjacent to the extension, a threshold in the extended range for each extreme of each dimension other than the extended dimension and splits the tile as necessary so that the resulting tiles reasonably accurately track the boundary between the current label on the tile and a new labelled tile, respecting the allowed limit for the input.

Note that this means that each new threshold is selected per extended tile so is specific to the input ranges associated with this tile. Therefore, the tileset may have tiles of various sizes based on the different ranges generated by these selected thresholds. It is not restricted to the row/column structure of a lookup table, where each entry in a row may have the same range for the input dimension associated with the row, for instance.

The new threshold on the current dimension in the above iteration may be simply halfway between the min and max of the range on that current dimension. Alternatively, it may be picked by application-specific knowledge. As another alternative, it may be selected by searching for the farthest threshold for the minimum on the current dimension before there is a significant difference in the threshold from the minimum. The latter may be more expensive in evaluations but may produce a better result in minimizing the number of tiles. Because the difference between the extremes on a revised tile is decreasing on each iteration, because the singularities are known and may be avoided, and/or because it has a bounded number of vertices with the new extreme value, a given original tile may only require a bounded number of iterations to terminate in the above method.

This technique allows for the case that the split is required at a different point than the previous limit of the input range. For example, with an autonomous aircraft, if the airspeed is extended from a lower limit of 200 km/h to a lower limit of 50 km/h and the stall speed is actually 80 km/h, the new threshold should be at 80 km/h. Therefore, after extending an existing tile from a lower limit of 200 km/h to 50 km/h, the evaluation as the new extreme of 50 km/h provides a different label than the upper limit of this tile, 500 km/h. Therefore, the technique finds a new threshold at 80 km/h and splits this tile into one that extends from the 80 km/h to 500 km/h with the previous tile label and one with the airspeed range from 50 km/h to 80 km/h. It marks this latter tile as tentative on the airspeed with the new extreme of 80 km/h. The technique then iterates on this new tentative tile.

Each of these new thresholds may be specific to the input dimension being considered and need not cause revision of any other tiles. Adding this new threshold splits the specific tile being considered for this case into two, with one having one label and the other having another label. This new threshold does not necessarily imply that other tiles using the original range in this dimension also need to be split. Therefore, the extra threshold for this dimension may be specific to specific ranges for the other dimensions.

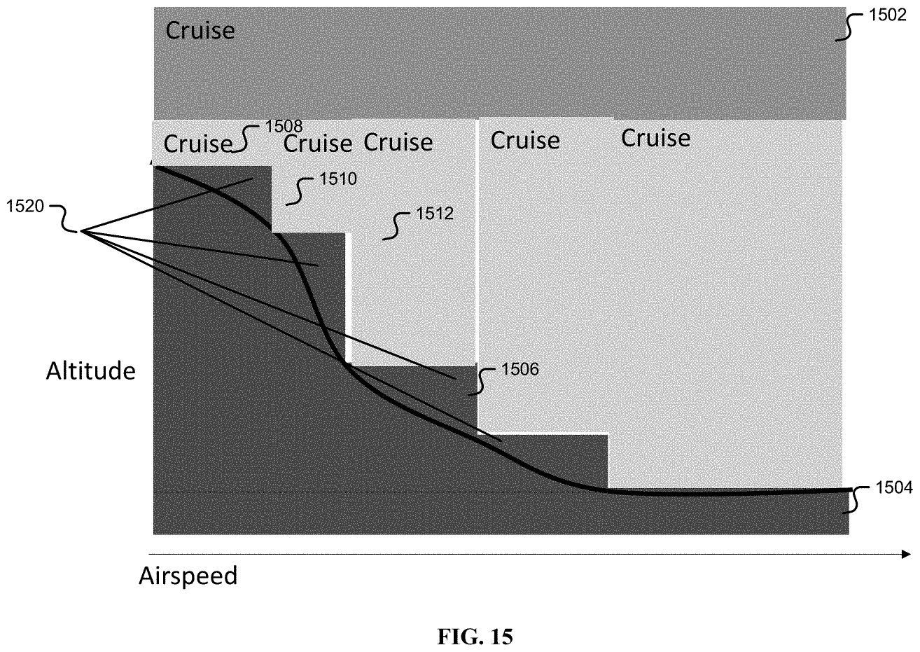

FIG. 15 is an illustration of input dimension range extension. Similar to the example shown in FIG. 8 with boundary tiles for a simplified example of an autonomous aircraft with input logical object “Cruise”, FIG. 15 illustrates the boundary between the Cruise operating domain and outside of the operating domain considering two dimensions of altitude and airspeed, and illustrates this input dimension range extension of altitude.

In the example shown in FIG. 15, the previous minimum limit for altitude is noted as the darker shaded tile (1502) and was such that no value of airspeed made a difference so the “cruise” label is applied to the single large darker shaded tile (1502). Then, the altitude range is extended down to the low value indicated by the top of the (1504) tile on the far right. This stage determines that the threshold for low airspeed is different from the threshold for higher airspeed and the difference between these speeds is significant. Therefore, the threshold is determined for an airspeed between these two values, such as halfway, corresponding here to the top of the middle tile (1506) in FIG. 15. The difference in airspeed between this value and that of the lower minimum is determined. If this difference is not significant, the airspeed value at the threshold defines a split point of the tentative tile. If this were the case for this example, the first three shared tiles from the left (1508), (1510), (1512), would be one tile. However, in this example, the difference is significant, so another threshold is determined and the tile is split further into the three tiles on the left (1508), (1510), (1512), as illustrated in FIG. 15. Similarly, difference in the airspeed between the value at the threshold and the maximum is determined, and if significant, the same splitting is employed, thereby producing the tile that is second from the left (1510). In this simple example, there are only two dimensions. In the general case, with more dimensions, each of these split K-dimensional tiles may be split further on additional dimensions.

The definition of “significant difference” may be application and even deployment specific. The larger the difference is before it is considered significant, the smaller the number of tiles required and the less optimal the control is. The portions that are above the curved line (1520) in FIG. 15 indicate the areas of less optimal control. The tighter the bound on significant difference, the more optimal the control is but the larger the number of tiles. Therefore, an application may trade-off between tile overhead and optimality of control.

A controlled system may not be expected to be in such a boundary case often or remain in one for long once there, so an approximation to optimal control is normally adequate. Also, with the dynamically changing conditions, some uncertainty in the actual state of the controlled system and the fidelity of the simulation means that even the optimal decision according to the simulation/prediction may not be significantly better than the approximation that is used. Finally, it may not be reasonable for a human pilot or operator to carefully track the exact trade-off between multiple inputs so it is not necessary to implement the exact shape of the curve to be comparable to, or better than, a human pilot. Fundamentally, the K-dimensional tiles at the thresholds, hyper-rectangles, are approximating a K-dimensional continuous surface. However, this K-dimensional continuous surface is not generally known. Instead, points on this surface are determined by the controlled system simulation/predication and engineering knowledge about the design of the controlled system and related technology.

This approach of making the tiles in a tileset as large as feasible subject to adequate control has the improvement of reducing space required for a tileset and reducing the cost of matching. It also means that the redecider may be restricted to transitions between adjacent tiles in the tileset. With this restriction, the amount of testing is reduced because there is no need to test the control system for transitions between tiles because the edge of one tile is effectively part of the adjacent tile. This approach also has the improvement that transitions are less frequent than with smaller tiles, allowing the pre-matching to avoid the full decision tree match most of the time. It also has the improvement that the frequency of preempting the current temporal sequence for a different temporal sequence is reduced, thereby providing for efficient stable control under normal circumstances.

In some cases, there is limited benefit to using simulation to support the labelling for tiles representing input values that are outside operational constraints of the controlled system. This is because engineering design may not have an accurate understanding of the behavior of the controlled system when outside the operational constraints and simulation may not provide an accurate indication of the controlled system behavior in this case. In some cases, there is an understanding of the behavior when an input indicates being slightly outside of the operational constraints but not when far outside the operational constraints. In this case, an additional threshold may be added that creates tiles that correspond to these two cases and simulation may be used to determine the appropriate labelling for the case of being slightly outside of operational constraints. As with the above-described introduction of new thresholds, this threshold may be specific to a given tileset and tile being considered and need not cause revision of any other tilesets. Extending the range of an input may mean revising the boundary tiles that define the operating domain for the control system.

With some controlled systems, it may be important to extend the range of some inputs before others. For example, with an autonomous aircraft, the airspeed is critical to the control of the aircraft. Therefore, the airspeed operating domain for the control system may be first extended from the normal range to closer to stall speed so that the airspeed TCM behavior is determined outside the normal range before extending others. For example, when later the pitch TCM is extended for altitudes below the normal cruising range, the pitch control TCM choices may be evaluated, incorporating how throttle is going to behave if this operating domain includes low airspeed. In particular, if the airspeed and altitude are both significantly below normal, the pitch TCM may need to defer increasing the pitch until the airspeed has increased. Similarly, if the roll is excessive, it is best to correct the roll before attempting to climb significantly.

In general, the decoupled TCMs may recognize that there is effectively a coupling through their connection with the same controlled system. Expert knowledge of this coupling of different actuators may be used to provide tiles that act according to this coupling, as illustrated by these examples. Note that because computer-based control may react to changes in the controlled system often 10 times or even 100 times faster than a human operator, it is usually feasible to rely on reactionary control rather than needing anticipatory control.

Moreover, autonomous control may be sensitive to much smaller changes in inputs than a human operator may notice. For instance, an increase in pitch typically means a reduction on airspeed unless the throttle is increased at the same time. A human pilot may anticipate the need for more throttle. However, with autonomous control, it is often sufficient in this example for the throttle TCM to react to the reduction in airspeed and increase the throttle because it can react to smaller changes in airspeed as well as react in a tenth of a second or less whereas human reaction times are normally assumed to be at least ten times longer.

Extending the limits of an input range may mean in some cases that the redecider needs to select a different sequence than used prior to extension. For instance, with an autonomous aircraft, if the logical objective is that it is “cruising” yet at an excessively low altitude, the tile label should correspond to an emergency climb sequence. Assuming this sequence is already implemented in the associated sequencer, it may be sufficient to use the corresponding tile label. Otherwise, the sequencer may need to be extended to provide this additional sequence, guided by the engineering design and operational constraints.

Testing the Tactical Control Layer. The prediction/simulation of a controlled system may be used to validate the choice of tile label, that is using the controlled system's simulation and prediction mechanisms and an objective function to determine how well the controlled system behaved under this control.

In one embodiment, the tile label is evaluated at each of the vertices of the tile. One form of test is to initiate the simulation in the scenario corresponding to the input values of each vertex and simulate forward from there. This testing may also initialize the state that is present in the sequencers. In particular, if a sequencer is using extrapolation to be less dependent on low latency feedback on its process variable, the extrapolation logic may also be initialized. Because the extrapolation logic is expected to be and required to be reasonably accurate, it is typically sufficient to initialize it so that it is predicting the initial conditions. For example, with testing of an autonomous aircraft, the previous timestep airspeed may be initialized with a value that predicts the current airspeed as approximately that of the initial airspeed given the throttle setting and the attitude of the aircraft. The handling of scenarios that include events that significantly disrupt the extrapolation such as a fault may be tested by having the fault occur at or after the start of the simulation. These fault or exception tests may warrant running the evaluation simulation for an extra number of timesteps.

In one embodiment using pre-matching, each vertex is extended by the extra margin or overlap amount to be used in pre-matching. To illustrate, if the overlap is 10 percent, if the airspeed range for a tile is 200 to 500, the choice of label is verified to work with an airspeed as low as 180, rather than 200, and as high as 550. By the continuous nature of the controlled system, the successful evaluation at the overlapped vertices may mean that the controlled system behaves adequately anywhere within this expanded tile. Note that, as described earlier, no margin is applied in pre-matching if the margin takes the controlled system into a region corresponding to a singularity.

In one embodiment, the testing uses at least in part the same simulation/prediction mechanism as used to determine the thresholds, as described above, except for those determined from the engineering design. Therefore, the testing primarily detects errors in the engineering specification or the simulation. However, testing may execute a longer sequence of steps than used to determine the thresholds. Therefore, testing when the simulation runs over numerous timesteps may sometimes detect a problem with a threshold or tile label that manifests itself over these timesteps.

For example, with an autonomous aircraft, a vertex that is close to a stall condition may show with one or a few timesteps that the airspeed TCM reacts correctly as does the pitch TCM. However, it may require more timesteps to recognize that aircraft will not avoid the stall with the normal airspeed TCM handling of the throttle. Such a case may be re-evaluated to revise the tile set using the input range extension method described above, but using a longer simulation evaluation time. Thus testing may be viewed as the means to identify when a given scenario requires a longer simulation to evaluate the behavior of the controlled system using the candidate thresholds and tile label.

With testing using a longer simulation and necessarily testing long enough for the controlled system to achieve its objective in the appropriate cases, testing may be used to determine the expected time for achieving the input logical objective. If this expected time indicates the sequence is taking too long to achieve its objective, this can be a basis to further revise the tileset/tilesets used by the sequence.

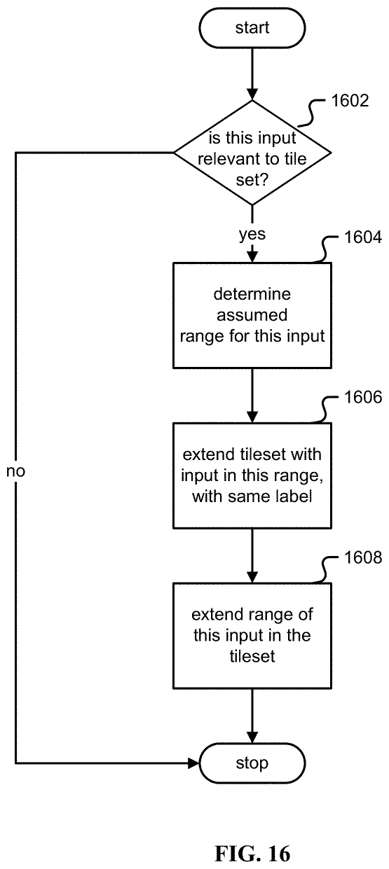

Extending Tactical Control with an Additional Input. FIG. 16 is a flow diagram illustrating an embodiment of a process of adding an input to a tileset. In one embodiment, the process of FIG. 16 is carried out by a computing system beforehand such as that shown in FIG. 1.

To add an input to a tileset TS, first step (1602) determines if a new input I is relevant to the tileset TS. In the event new input I is not relevant, the process is done. Otherwise, control is transferred to step (1604) to determine the assumed range for I in the existing version of TS. This is because, in part, it may be the case that some range of values was assumed for the input with the current tileset TS. For example, with an autonomous aircraft, if the new input is indicating the presence/non-presence of other traffic in front of the aircraft, the initial TCM likely assumed there was no traffic in front in the vicinity. (Otherwise, the initial TCM would have had provision to take evasive action.)

In step (1606), the tileset TS is revised to include this input as a new dimension with the same label as previously for tiles with this new input dimension within this assumed range. For example, continuing the above example, the assumed range for traffic in front might be “beyond five miles”, that is, far away. The existing tileset then has the added input dimension with their range corresponding to traffic in front being five miles or more away. Similarly, if the new input is indicating the possible presence of a fault condition, the assumed input would correspond to “no fault”. The tiles corresponding to this input being outside of the assumed range are labelled as boundary tiles, indicating the control system may not handle these cases and they are outside of the current operating domain. In effect, this step makes the operating domain for the tileset explicit with the new input.

In step (1608), the operating domain range for this input is extended using the approach described above. For example, with the input being a value indicating the presence of incoming traffic in front of the aircraft, closer in traffic calls for a sequence that changes course to avoid the traffic. Even closer in traffic requires a sequence that takes an emergency action to avoid the traffic, such as a sudden dive to a lower altitude. The operating domain may be incrementally extended until it has been expanded to correspond to that required by the application. Similarly, an input indicating the detection of internal faults is extended to include a common fault condition, with the associated tiles indicating the best sequence to select when this common fault is detected.

There may be no need to extend the range of a new input to its full eventual range before incorporating other inputs. In one embodiment, a normal simple operating domain is a preferred start, with incrementally extending all inputs to support a slightly more complete operating domain, incrementally extending this operating domain over time, and relying on intervention when the control system detects it is outside of the current operating domain. That is, starting with coverage of the normal operating domain, the input ranges may be incrementally extended to handle more exceptional/unusual scenarios, thereby reducing the frequency and urgency for intervention.

Extending Tactical Control with an Additional Actuator. An initial version of the tactical control layer does need not to include a TCM for every possible actuator. Moreover, a new instance of the controlled system may include an additional actuator that was not present in the previous version used to develop the control system, for example in two cases: 1) a new actuator is essential/critical for control of the controlled system, and; 2) a new actuator is an optimization that improves the performance of the controlled system. As an example of the latter with an autonomous aircraft, the initial version may not include a TCM for the flaps. Flaps may not be essential for operation of the aircraft but rather allow it to take-off and land more efficiently and with a shorter runway.

For a new actuator being essential for the control of the controlled system, the controlled system may be a new system with a different simulation. Therefore, the development sequence for the control system described above may be repeated. This is because the control that has been validated previously may not be valid with the new controlled system. In some cases, this case may be transformed into one that can be handled as an optimization. For example, with an autonomous aircraft, if an initial version is developed for a single-engine aircraft and thus one throttle, the control system may be adapted to a two-engine aircraft by duplicating the throttle TCM for each engine and defining the operating domain as when both engines are performing correctly. Thus, the engine failure input indication is set to true if either engine is not performing correctly. Then, fully adapting to two engines may be handled as an optimization, that is, handling the case of one engine has failed but not the other is a better way than treating it as though both engines have failed.

When a new actuator is an optimization, the existing tileset may be treated as having this actuator in some fixed or default setting. For example, using the flaps example, the flaps may be fixed initially as not deployed. Then, after the initial version has been developed, a TCM may be added for this actuator with a tileset that keeps the flaps not deployed. Then, the tileset may be extended to deploy the flaps based on inputs indicating scenarios in which the deployment improves the operation of the controlled system, again determined either by engineering knowledge of the controlled system and/or as determined by simulation of the controlled system. For example, the flaps TCM may be extended to deploy half flaps in response to the take-off input logical objective.

As an actuator outside of the initial actuators, the absence of this TCM is equivalent to the TCM being present but with one tile that selects the neutral or undeployed sequence in all situations. Furthermore, the additional actuator when active normally just changes the timing and possibly efficiency of operation. For example, with aircraft flaps, when deployed they provide additional lift during take-off and also additional drag to reduce the time to descend and reduce airspeed when landing. Other actuators such as rocket boosters on take-off and reverse thrusters on landing have similar properties. With an autonomous vehicle, a TCM for explicit gear control may gear-down to slow down and thus reduce wear on the brakes.

To add more detail, a first step may be to introduce a new TCM for this additional actuator that has a tileset per input logical objective that selects the non-deployed or default sequence in every case.

A second step may be to identify an input scenario in which it may be active or deployed. For example, with flaps on an autonomous aircraft, the tileset may introduce a tile for the “landing” input logical objective that matches when the aircraft is at a suitable altitude and airspeed, causing the flaps to deploy at that point and remain deployed until the aircraft is stopped. Therefore, this tileset is defined with input dimensions corresponding to airspeed and altitude. The tiles covering the input space outside of the region in which the flaps may be deployed remain the default of non-deployed.

Third and/or subsequent steps may identify additional input scenarios, such as ranges of input values, in which this actuator and what it controls may provide improved operation. This process may continue beyond the initial release of the control system, providing refinements in subsequent releases.

The introduction of a new actuator introduces a new potential input, namely the process variable associated with the new actuator. This potential new input may then be evaluated to see if relevant to any of the other TCMs using the method described earlier for adding an input.

A case that may affect the behavior of the controlled system is when the new actuator misbehaves and acts incorrectly. For example, with an aircraft, if the actuator for reverse thrust initiates reverse thrust on take-off, it can have severe consequences for the aircraft. Rather than have this process variable as input to all tilesets to handle faults of this nature, the separate fault detection system may be used to root cause faults and provide a fault indication to the relevant TCMs, as described above.

Refining Input Thresholds. Extensions to the actuators, the logical input objectives, and the input ranges may mean there are opportunities to improve the performance of the control system by the introduction of additional thresholds on the inputs in some cases, with corresponding refinement of tile labels.

This refinement may take place by re-evaluating the system performance in the input value region of interest. For example, the tilesets for “take-off” input logical objective in a TCM may be refined with additional temporal thresholds for take-off because the addition of flaps provides more lift allowing take-off on a shorter runway. To use this refinement/optimization reliably, these tilesets may be extended to accept an input indicating that the flaps have been deployed if there is the possibility of taking off without the flaps being deployed. Note that this input may be simply a Boolean value indicating deployed or not, not necessarily all the values associated with the flap position.

In one embodiment, the effect of the additional actuator is to change the time for a given sequence. For example, the deployment of flaps may reduce the landing airspeed and thus reduce the time from touch-down to slowing the aircraft to taxiing speed. In one embodiment, it may be known in advance that a given actuator does not directly affect the decisions and activity of another TCM, so the whole step of re-evaluating the associated tileset is skipped. For example, the deployment of the flaps may have no real effect on the yaw so there is no need to extend the tileset used to control yaw.

There may be incremental refinement of the granularity of an existing input. For example, with an autonomous aircraft, the initial engine fault input may simply indicate true or false. However, this may be refined into no fault, loss of power, and overheating, thereby recognizing the case that the engine is still providing thrust but is experiencing a problem. To add a refinement of this nature, an additional range corresponding to the new value is added to the associated input dimension and a new tile is added for each input combination for which there is a different tile label. For an existing tile in which there is the same label for either loss of power or overheating, the tile range for that input dimension may be extended to include the values of these two possibilities, assuming they are numerically adjacent, such as “correspond to 1 and 2”, so the range is [1,3).

In practice there may be limited benefit to refining the thresholds that result from the overall process described in this section to improve efficiency. This is because the redecider is determining the logical objective; the sequencer and selected sequence are designed to achieve that objective as efficiently as possible based on the engineering design of the system. Moreover, the efficiency of the controlled system may be typically dominated by its operation in its normal operating domain. For inputs in the domain, the tileset is picking the corresponding “normal” operation sequence. That sequencer may be designed according to the engineering design for normal operation.

The primary area of refinement may therefore be in the boundary areas. For example, the tileset for controlling the flaps may be modified to deploy in a stall condition to provide additional lift at low speed. Thus, these refinements are likely in practice to provide better behavior in bad conditions, rather than strictly general improvements.

Summary Of Tactical Layer. In general, the development of the tilesets for the tactical control layer may start with one input logical objective and a restricted operating domain, restricted to the safely normal scenarios. It may then be incrementally extended to handle more input logical objectives, each initially restricted to its “normal” operating domain. The boundary tiles defined around the normal operating domain cause intervention when inputs are outside of this supported operating domain. Then, the operating domain for each input logical objective may be expanded by extending the range of inputs being handled by the logical objective until it handles the entire operating domain that is required for the controlled system. Adding a new input may typically be done without disturbing the existing control because there is a range for that input that was assumed by the existing control realization. Therefore, this input may be added and then the range extended as above. The addition of a new actuator and associated TCM may be handled similarly.

In a typical case in practice, an initial version of a product may have a restricted operating domain. It may then be extended incrementally in subsequent releases of the control system. The, for example non-boundary, tile input space may be incrementally expanded in the range of inputs considered as well as the number of dimensions. A key aspect is that these incremental expansions do not require retesting of the previous tile set, because the previous set of tiles is not changed other than to possibly extend a tile when a new adjacent tile has the same tile label.

For autonomous operation, one improvement is a system feasible for a human operator to take over after some notification, but without great urgency and without expecting the operator to be paying continuous attention to the system and without a significant failure unless it is a catastrophic situation. That is, the control system is able to take the system into some safe state when it ends up outside its operating domain, allowing time for the operator to be notified and take control. The extending from the normal situation to more unusual situations as described above improves the level of autonomy measured by the frequency of intervention as well as the urgency of intervention.

Strategy Layer. In one embodiment, the strategy module is designed and/or implemented following a similar method as described for the tactical layer, including in developing the associated tileset/tilesets. Unlike the tactical layer, it is normally sufficient to have a single strategy module or subsystem for the entire controlled system. This is because the strategy applies to the overall controlled system, not individual actuators.

In one embodiment, the strategy module is structured as the TSIR structure described herein, similar to the structure of the modules in the tactical layer. The sequencer implements the various strategy sequences that a human pilot may apply. For instance, a strategy to avoid a storm may be to fly further to the left around the storm and then return to a flight path towards the next waypoint once passed the storm. In essence, each temporal sequence is a strategy, structured as a temporal sequence of steps. In one embodiment, there is a clear distinction between deciding on a strategy and executing the steps of the strategy, and/or there is clear provision for rapidly and repeatedly re-evaluating the strategy/sequence that was previously decided on and changing to a different strategy/sequence if changes in inputs warrant that change.

As a first step, the sequencer may be implemented according to the sequences and control determined as part of designing the controlled system. The initial version of the redecider is implemented with the single input logical objective of “normal” operation, therefore a single tileset that maps to this sequence. For example, with an autonomous aircraft, a basic sequence is the “cruise” logical objective of cruising at the assigned altitude and cruising airspeed with a heading that corresponds to a location of the next waypoint, and there being no other traffic around, no interfering weather conditions, and no faults with the aircraft. Any other input logical objective may map to a boundary tile. Therefore, an initial version of the strategy redecider may select this sequence when its input logical objective is specified as “cruise to this next waypoint.”

This initial version may be relatively simple to implement in practice because it is a matter of programming the sequence that was specified as part of engineering the controlled system or part of normal human operation, for example pilot training. Also, the redecider tileset is a single tile that selects the “cruise” sequence.

After completing this initial version of the strategy redecider, it may be extended with additional inputs that indicate faults, temporal conditions, and environmental conditions as well as additional input logical objectives. Additional input logical objectives may be handled the same as for the tactical level, that is by adding a tileset for each additional input logical objective.

One particular input to add is an indication of the status of the controlled system to determine if the “normal” input logical objective is feasible as an objective. For example, with an autonomous aircraft, if the aircraft is at a low altitude, the tileset with this additional dimension selects “climb” as the sequence rather than “cruise” to correct to the right altitude. The tileset may also indicate an error condition if the input logical objective is completely inconsistent with the current state of the controlled system.

For example, if the input logical objective is “cruise” yet the aircraft is on the ground, the strategy module may indicate an error, rather than trying to duplicate a meta-strategy module to get the aircraft into the air. In this particular example, the thresholds for this input may be quite coarse because the issue is whether altitude is significantly above the ground. In fact, the input may be potentially reduced to a Boolean input that indicates whether the aircraft is “safely in the air” or not, where “safely in the air” includes altitude as well as airspeed.

In general, adding a new input may also be handled the same; adding a dimension to each tileset for which this input is relevant, then making the original tiles correspond to those in which this input is a default or normal value. For example, with an autonomous aircraft, a new input may indicate traffic in the same lane as this aircraft, with a default or normal value of “no traffic”. The range of this input may then be extended to include, for instance, a value indicating traffic ahead that is being overtaken. The tiles with this input dimension matching this value are then labelled with a sequence that avoids this traffic. For example, it may select a sequence that causes the aircraft to climb to a higher altitude in order to pass the overtaken traffic above it and then descend to the normal cruising altitude. As before, the tileset is replicated for each range of the new input dimension with the original tileset still labelled the same with its value for each original tile in this input dimension being “no traffic”. The remaining new tiles may be labelled according to standard flight procedures in response to traffic. This extension may result in the addition of sequences to the corresponding sequencer. For example, there may be a sequence corresponding to emergency descent to avoid traffic.

A key difference in the handling of the strategy layer is that decisions may be well-known and general, independent of a particular controlled system. This is because specifics are handled by the tactical layer. For instance, the strategy to climb to a higher altitude to avoid traffic that the aircraft is overtaking may be used with essentially any aircraft, parameterized by the aircraft limit on altitude. Moreover, trying to evaluate a choice of sequence by simulation/prediction with the strategy layer is expensive because a strategy may take many timesteps to play out to determine whether it is a good choice or not. For example, the strategy to climb above traffic being overtaken may take tens of seconds to play out.

In one embodiment, the strategy tileset is manually specified and then validated by testing. An alternate variant is specifying the tiles for the cases that are obvious and then using the simulation-based evaluation to fill in between these points. For example, if the aircraft is far from the traffic it is overtaking, it may be preferred to climb to avoid it whereas if the aircraft is close to the traffic it is overtaking, it may be safer to descend to avoid it. By explicitly specifying the cases in which it is clear the aircraft may climb and when it is clear that the closing time is so short that descent is essential, simulation may determine at which threshold is it better (or necessary) to descend rather than climb.

The inputs may also be refined to have additional thresholds/ranges. For example, the fault system input may initially just indicate fault or no-fault. Thus, on “fault”, the aircraft tries to land immediately. However, this input may be refined to indicate faults that limit the aircraft range or altitude, such as loss of cabin pressure.

In some cases, a new input/input value may require other additional inputs. For example, the strategy sequence to climb above another aircraft that this aircraft is overtaking may require knowledge of the current altitude or at least the difference between the current altitude and the maximum altitude of the aircraft.

In an autonomous aircraft use case, the input logical objectives that correspond to on-ground control indicate the benefits of having a separate tileset. This is because the inputs and sequences are significantly different from when in the air. On the ground, the waypoints indicate ground waypoints to get to the runway or from the runway landing point to the parking area, if just landing. Therefore, the strategy for each waypoint on the ground indicates a sequence to taxi to the next one. The strategy layer may thus be extended incrementally to handle more and more relevant inputs as part of its decision making.

Meta-strategy Laver. In one embodiment, the strategy and tactical layer delegates navigation to a separate meta-strategy module/layer. The meta-strategy layer takes a high-level objective that specifies an application end goal and produces a “navigation” in its sequencing to that end goal if possible, and otherwise reports the problem to a user/operator. The navigation is simply identifying the specific waypoints to be implemented by the temporal sequence. For example, as above, a fully autonomous aircraft may have the top-level input objective: fly from current location to a specified airport. This example is used to further illustrate the process below.

On receiving this logical objective, the meta-strategy layer/module decides whether it is feasible to fly to that location based on weather conditions, available fuel, any sensor or mechanical problems with the aircraft, and other factors. If it decides to fly, its sequencer module may have a navigational submodule that determines the route to the destination, the flying time, and any complications along the way. The redecider may have a tileset that has dimensions for flying time, fuel in the aircraft/the flying time equivalent, fault conditions in the aircraft, environmental risks such as weather systems, traffic congestion, and other factors. After the sequencer determines the sequence, inputs to the redecider may determine whether to keep with this sequence or redecide based on its inputs. For example, if flight time exceeds the available fuel, it may redecide against proceeding to take-off.

If it decides to proceed, its sequencer then continues to step through waypoints that are generated as part of the routing to this destination. These waypoints may include the taxi waypoints/which runway to go to, which may influence the total travel time. The sequencer may handle getting input on the hold points on the way to the runway and getting permission from the tower to proceed, including getting clearance for take-off. These are part of the conditions for proceeding to a next step. Again, the “decisions” are relatively simple for the sequencer, deciding whether the input/permissions are sufficient to allow going to the next step. The sequence for getting to a specified destination is generic in the sense that the waypoints are provided as parameter values to this sequence, so the sequence is iterating over the waypoints, going to the next one when arriving at the current target waypoint, and finally reaching a runway waypoint on which to land and taxi.

After it decides to proceed to the destination, at each timestep for the meta-strategy layer, it is re-deciding if there is sufficient fuel to reach the destination, whether faults in the aircraft warrant changing the objective, and whether changing environmental conditions warrant changing the sequence. In some cases, the redecider may decide to return to the airport of departure, for instance. That is, it re-decides on the sequence, changing it to make the new destination be the original point of departure.

In developing a tileset for this layer, an initial version may simply act on the input logical objective, invoke routing to determine the parameters/waypoints, and then invoke the waypoint sequencing. That is, it has no fault inputs or environment inputs. This version is a practical improvement because it simply implements the sequence required for normal flight, which is already specified as part of the engineering design.

This initial version is then incrementally extended by adding a new input dimension, one after another. For instance, a fault-reporting input may be added that indicates a particular type of fault. This dimension is added by replicating the current tileset for each value of the fault-reporting input. The original tileset corresponds to the fault-reporting input of “no fault” for the new input dimension. The tiles in this subset of the tileset remain labelled the same as before. Each of the tiles with another value for this new input dimension, the fault input, is then labelled as to the correct sequence to follow for the given fault condition and its other inputs ranges. The correct sequence is specified as part of the training for a human pilot for this aircraft, so may be leveraged without requiring significant judgment and/or analysis. For example, with an engine overheating, the tile may override the input logical objective and reset the course to the closest location in which to do an emergency landing, similar to how a human pilot would be trained.

The addition of this fault input may require an additional input to the tileset to make the right decision. For example, the meta-strategy redecider for an autonomous aircraft may select a different sequence of actions if the aircraft is on the ground versus in the air. For example, with an engine overheating on the ground, the redecider may just decide to shut off the engine. However, if in the air, the best course of action is to land at the nearest opportunity. To take in this new input, the tileset may be extended by an additional dimension corresponding to this input, the altitude in this example. However, the thresholds associated with this new dimension may be defined to be the minimal number required to make correct decisions. For example, in the current example, there may be just two ranges for altitude, corresponding to on-the-ground and in-the-air. Therefore, there are separate tiles corresponding to these different ranges of the altitude input.

Once the tileset is extended with this additional input, the redecider tileset may be extended again with another additional input, again increasing the dimensionality of the tileset by replication. For example, the fault input may be partitioned into two inputs corresponding to an engine problem and a flight surface control problem. The dimensions of the tiles are again increased to handle this new input, and the number of tiles is increased corresponding to the number of ranges for the new input. As another example, a new input may be added that corresponds to the environment. For instance, a new input may indicate weather conditions in the immediate vicinity.

As part of labelling these new tiles, if two adjacent tiles have the same label for a given fault input value, these two tiles may be merged into one tile, thereby reducing the number of tiles. For example, for the case of both an engine problem and a flight surface control problem, the decision may be the same as just an engine problem if in the air. Also, as part of labelling with a new input, it may be recognized that this new input provides the basis for different decisions with a given existing tile. For example, if an airspeed indication is added, that may suggest different decisions based on high airspeed versus low or zero airspeed. This recognition may lead to splitting an existing tile into two or more tiles, so each can be labelled with the appropriate decision.

In a similar way, one or more inputs may be added corresponding to environment conditions that might interfere with the flight. For example, a developing storm may preclude using the generated route.

The meta-strategy layer is thereby incrementally developed by adding new input dimensions, one at a time, replicating the existing tileset for each range of the new input dimension, and retaining the labels on the original tiles for the new input dimension when its value is the default or neutral value. Thus, its development may follow the same sequence as for the tactical layer.

Ternary Matching. In one embodiment, ternary matching, as described in U.S. Pat. No. 10,761,921 entitled AUTOMATIC ROOT CAUSE ANALYSIS USING TERNARY FAULT SCENARIO REPRESENTATION which is incorporated herein by reference for all purposes, is used to match inputs to a tile. Each “root cause row” described in U.S. Pat. No. 10,761,921, corresponds to a tile as described herein, and each “symptom” or “column” described in U.S. Pat. No. 10,761,921 corresponds to a range or threshold for a range for a particular input as described herein.

For example, if the flaps on an aircraft are either up, partially down, or fully down, there is a column for each of these ranges. The input preprocessing then sets the corresponding entries in the “actual fault scenario” vector described in U.S. Pat. No. 10,761,921 according to the actual position of the flaps and the tile matching is performed according, in part, to the position of the flaps. This encoding assumes that the ranges used for this input across the set of tiles are not overlapping.

For example, if there is a tile that should match on either the flaps being partially down or fully down, this tile requires a separate row for each of these subranges. Note further that, for a given row, if it requires an input I to be in a given range corresponding to column C, the row may be specified “don't care” for other columns in this row that correspond to other ranges that are outside this range. This is because the entries for these other columns in the actual fault scenario vector input are false so there is no need to match against these other columns. Specifying these entries as “don't care” has the practical improvement of reducing the space requirements for the table. In the special case of an input that is typically binary, it may be matched by a single column that indicates true, false, or don't care.

To avoid unnecessary oscillations, the same pre-matching as described before may be used, that is, checking before using the ternary matching if the inputs are in the extended range of that of the previous match, and if so, use that, else perform the ternary matching again.

There may be different overlapping ranges for a given input. To handle multiple overlapping ranges on the same input, the encoding for a particular input of the associated columns corresponding to thresholds may be used, with two columns per input threshold corresponding to: 1) less than the threshold and 2) greater than or equal to the threshold. For example, column 42 may correspond to the airspeed threshold of less than 150 km/h, column 43 may correspond to the airspeed threshold of greater than or equal 150 km/h, column 46 may correspond to the airspeed threshold of less than 200 km/h, and column 47 may correspond to the airspeed threshold of greater than or equal to 200 km/h. Thus, by setting both column 43 and 46, the row/tile only matches if the input is between 150 and 200 km/h. If there are intermediate thresholds in that range, say 175 km/h for column 44 and 45, these may be set to “don't care” in the row.

The input vector indicates every range that the input value is contained in that is used in a row. Thus, if the airspeed is measured as 167 km/h, it sets column 43, column 44 and column 46. Therefore, a row that requires this input to be in the range of 150 to 175 has columns 43 and 44 set, so matches to the input vector for this input. If an input has no subranges of another range, the encoding into the table may use a single entry/column per threshold, thereby saving on space and columns. Subranges may be allowed if there is a separate row for each super range and the input indicates each subrange and each containing super range. Overlapping non-nested ranges may be avoided by splitting the ranges and replicating the rows.

In one embodiment, there are overlapping tiles and a prioritization mechanism of which tile to select out of the matched tiles to determine the output. In one embodiment, priority is given to one of multiple tiles by choosing the matching tile that is the same or closest to the tile that was matched previously. In particular, the matching algorithm checks if the previously matched tile still matches and if so, uses that one; if not, it checks adjacent tiles for a match; otherwise it does a full search for a match. This approach has the practical improvement of reducing the cost of matching by frequently avoiding the full search.

Using Machine-learning Datasets. If a labelled “training” dataset for a controlled system is available, similar to what might be used with a machine learning realization, this dataset may be used to test the tile-based realization enabled herein. In particular, each data sample of inputs is evaluated by matching to the matching tile/tiles, and the behavior associated with the tile label is compared to that associated with the sample. If the behavior is not consistent, the tile label may be modified to that expected by the data sample. If another data sample maps to the same tile and expects a label that is similar but still different than expected, the tile may be split so that both values are provided by their respective tiles, thereby becoming consistent with the “training” dataset, now used for testing. This process terminates at least when there is a separate tile for each data sample, if not before.

In one embodiment, the tile refinement with a training dataset proceeds as follows:
1. Select the next data sample;
2. Use this data sample as input to select a tile with each tileset. This assumes the data sample includes all the inputs to determine the starting state of the controlled system or else that the data sample is part of a sequence of data samples that provide this information over time;
3. If the training label is not operationally consistent with the discretized label, add this tile to the collection of “to be refined” tiles and record this sample; and/or
4. After processing all the data samples, refine each “to be refined” tile by:
   i. If the desired value for a sample corresponds to what may have been produced by a sequence selected by the adjacent tile and the input thresholds defining the tile may be tuned without conflicting with other data samples, tune those input thresholds;
   ii. Else, tune the value of the tile to what may satisfy all recorded samples associated with this tile, if possible; and/or
   iii. Otherwise, split the tile so the resulting tiles may satisfy all the samples or else ignore the data sample as erroneous.

The term “operationally consistent” is defined herein such that the tile label would achieve a behavior that is similar to that associated with the data sample. In particular, the behavior is significantly different from that achieved by the data sample if the effect of the control values is not the same as the sample values over a period of time. For example, with an autonomous aircraft, if the data sample values cause the aircraft to climb whereas the control system initialized with this data sample results in it descending, the behavior is not operationally consistent. The “operationally consistent” term is used as it is not sensible to expect that the control values generated are exactly the same numerically or temporally as those in the data samples.

After this process has produced a set of tiles that is consistent with the dataset, it performs as well as ML on the input samples. However, in contrast to an ML-based implementation, it also exhibits predictable behavior on nearby datapoints. That is, if the same tile, the same control value, and if in a separate tile, then the output is the label associated with that tile. In essence, the ML training set being used as described above is being used to test the tilesets and provides a basis to correct or refine these tilesets, typically manually.

A training dataset may be generated by recording the inputs and control variable values during the manual operation of the controlled system. For example, an aircraft may be manually operated with its inputs and outputs recorded along with the high-level logical objective to be communicated to the automatic control system, for example, “climb to cruising altitude”. For example, the climb indication may be followed by a significant increase in throttle before the elevators are tuned to increase the pitch of the aircraft. Developing these initial tiles, some inputs may be pre-recognized as not relevant to the setting of the output for a tileset.

In one embodiment, as an optimization, an input is identified as not significant or “don't care” with a given set of parameters or beyond a given range. For example, if the altitude is greater than 500 feet, the specific altitude may not matter for the control variable. In this case, the tiles from across that dimension may be pre-combined into a smaller number of tiles, rather than each evaluated separately as above. Similarly, if the airspeed is zero, a number of the inputs have no meaning. As another example, the longitudinal position of the stick is not concerned with the position of the ailerons because the longitudinal position of the stick may not compensate for incorrect positioning of the ailerons. That is, it has to assume that they are set correctly. In general, not all inputs are required by every control variable in all cases.

Recent work in ML to reduce the amount of data required for machine learning has looked at so-called “soft labels” associated with scenarios. One example is “Less Than One-Shot Learning: Learning N Classes From M&N Samples” by Sucholutsky and Schonlau. These soft labels are similar to the tile labels, but result in a probabilistic control system that is not explainable or exhaustively testable, unlike the disclosed.

Automatic Generation. Automatic generation of a control system based on that described herein is focused on generating tilesets for each redecider. This is because, as described above, the engineering design process of the controlled system specifies the sequences required to operate the controlled systems, and characterizes actuators such that the sequences are known. Therefore, the sequencers are a matter of converting these specifications into executable software. This step is practically simple. Moreover, it is feasible, and more precise, to specify these sequencers in software so these specifications are automatically translatable into an executable form. For example, if these sequences are specified in a programming language such as Python, the sequences may be compiled into a conventional system language such as C, for fast efficient execution in production/operation.

In one embodiment, automatic generation is focused on the tactical layer rather than the strategy or meta-strategy layers. This may be because:
1. There are more tactical control modules/TCMs and correspondingly more tilesets at the tactical layer, so there may be more benefit at the tactical layer;
2. The meta-strategy and strategy layers are typically common across a wider range of controlled systems whereas the tactical layer may vary more between controlled systems. For example, with an autonomous aircraft, different aircraft may have different actuators, different capabilities, and different fault conditions; and/or
3. The tactical layer may be more critical to the safe operation of the controlled system because it may react to sudden changes in inputs, where human intervention is far more difficult to achieve.

In one embodiment, automatic generation, as described in U.S. patent application Ser. No. 17/156,378 entitled AUTOMATIC GENERATION OF CONTROL DECISION LOGIC FOR COMPLEX ENGINEERED SYSTEMS FROM DYNAMIC PHYSICAL MODEL which is incorporated herein by reference for all purposes, is applied to provide automatic generation of tilesets, including tile definition and label, and/or TCMs. In particular, automatic generation for a given actuator and input logical objective comprises:
1. Provide a prediction function and an objective function for the controlled system with inputs plus an initial set of thresholds for each of the inputs and the set of sequences for this actuator. The initial/unlabeled tileset is then defined by these initial thresholds;
2. For each unlabeled tile T in the tileset:
   a. For each vertex of this tile T:
      For each candidate tile label;
         a. Score the tile label using the objective function when the tile label-associated control is applied to the prediction function for the inputs associated with this vertex; and/or
         b. Record the tile labels with acceptable scores for that vertex, if any;
   b. Select a label that has acceptable scores for all vertices if there is one and use that as the tile label; and/or
   c. If no tile label with an acceptable score for all the vertices of the tile was found, split this tile into multiple tiles by adding one or more new input thresholds and add these new tiles to the tileset as unlabeled; and/or
3. Output the labelled tileset.

In the above, the inputs are the process variables, environmental inputs, and fault conditions that the given actuator behavior is dependent on. For example, aileron control is dependent on the current roll angle, airspeed, and altitude. The thresholds for each of these input dimensions define the tiles. The iteration over all of the tiles corresponds to the iteration over input combinations specified in U.S. patent application Ser. No. 17/156,378. Each vertex of a tile indicates a particular input combination. The tile label corresponds to the action being selected in U.S. patent application Ser. No. 17/156,378. Finally, the generated rule corresponds to the labelled tile in the sense that the rule is implicit: if the input values viewed as a K-dimensional position are contained within a tile T, then the action is to output the label associated with this tile.

The prediction function may be realized using a simulation of the controlled system. The objective function evaluates how well the controlled system is performing based on the candidate label currently being evaluated. Because the tileset is for the tactical layer, the simulation may require a relatively small number of timesteps to provide an indication to the objective function. For example, with an autonomous aircraft, evaluating raising the elevators has an effect after less than one second, so less than 10 timesteps using a 100 ms timestep period may be required.

In the above, the evaluation at each vertex of a tile T uses the vertex computed using the extra margin to be used by the pre-matching step in the input mapping to avoid unacceptable oscillation.

The above “adding one or more new input thresholds” action is performed by a procedure that may be specific to the type of controlled system or that uses the method described above to select new thresholds as part of extending the range of an input. Given the controlled system is assumed/required to be engineered for predictable and piece-wise continuous stable behavior, input thresholds may eventually become a sufficiently good approximation to the required control actions to achieve the desired performance, assuming the objective function is consistent in its scoring with the engineering requirements for the system. That is, an objective function that requires more precise or efficient performance than the controlled system was designed to achieve may not be satisfied.

A similar approach may be used with the strategy layer. However, a much larger number of timesteps is required to evaluate a strategy. For example, with an autonomous aircraft, the strategy of flying around a large storm may take minutes, if not hours. Therefore, the number of timesteps to evaluate can be 1000 to 10,000 times more than for the tactical layer.

Summary. The autonomous control as described herein supports ensuring correctness of a control system by extensive, possibly exhaustive, testing rather than relying on “control theory”, the correctness of floating point calculations, or relying on statistical behavior as a result of extensive “training” as with ML. It has several benefits, including:
1. Fast Response to Changes: a redecider selects a potentially different sequence on each timestep, so may be designed to react immediately to a changing situation. By contrast, a planning-based approach such as used in traditional AI planning needs to evaluate the plan at each stage and dynamically generate a new plan if needed before reacting, Also, traditional control approaches assume continuous behavior yet changes can produce or require discontinuous behavior in the controlled system;
2. Non-linear Mapping from Input to Output to Handle Singularities: Using tilesets in the redecider, the choice of tile boundaries and the label for each tile is arbitrary from the tile specification and matching standpoint. By contrast, a traditional rule-based approach combines decisions for sequencing, and sometimes basic control, with the redecider role. As well, traditional control theory for MIMO generally requires the control to be linear or at least differentiable and is normally trying to compute the output with some closed-form computation. This is at odds with the fact that many controlled systems have singularities;
3. Complete, Deterministic, and Predictable/Explainable: The described tileset provides a mapping from all possible input values to a given tile or tiles, that is, it is complete. As well, the control system behavior is deterministic and predictable or explainable based on the inputs and the specified collection of tiles, and behaves according to the engineering design/specification in the absence of failures. This explainability contrasts with a traditional ML approach;
4. Efficient to Develop: The sequencer and redecider both incorporate knowledge from the design of the controlled system and experts, based on the logical objectives, constraints, and requirements for the controlled system. It thereby avoids the costs of generating very large training sets and labelling these training sets, as required by traditional ML/DL approaches. Moreover, the modular separation of critical decision making in the redecider separates out the critical and most complex decision making from the rest of a control module, while being off-loaded from the other aspects of control by the sequencer;
5. Fewer and Identifiable Test Cases: Testing of a redecider may only need to cover the boundary conditions of the tiles, that is the vertices of each tile. Although this may still be a large number of cases, it is less than when using continuous inputs and continuous computation where completeness is impossible. The boundary conditions effectively define the complete set of necessary test cases. By contrast, the dynamic plan generation of a traditional planning approach is far harder to test, and also more expensive. Consistency with design for testability and test-driven development is an improvement. There are no round-off effects or floating point inaccuracies in the mapping from input to output. The determination of the output control values is based on integer comparisons;
6. Incrementally Extensible: Allowing direct handling of the “normal” case and then incremental extensions to expand the operating domain of the control system without revising the portion handling the current operating domain and all the while, maintaining the ability to identify when the system is outside the supported operating domain is an improvement. A change to one tile only affects the behavior of the control system when the inputs are contained within the tile input dimensions and the adjacent tiles. Therefore, the control system may be evolved incrementally without re-testing the entire range of inputs. Also, a new dimension/input may be added in many cases by treating the existing tiles as a projection of the new tiles with this new dimension in a default or normal range. That is, the existing tiles may be extended to this new dimension by specifying thresholds for this new dimension but without retesting all the input combinations where the new dimension is neutral, corresponding to not having this dimension. By contrast, changing the control formula with a traditional control theory approach means retesting all the cases. Similarly, with traditional ML, a new feature/dimension can have unknown effects on the existing test cases, so they all need to retest; and/or
7. Adaptable to Different Controlled Systems: The control system may also be more easily adapted to a new controlled system of a similar class by changing the input preprocessing and the sequencer parameters or logic, without modifying the redecider. This is because the logical objectives are the same across different systems within the same class, for example, across single-engine aircraft. Thus, the most challenging part of the control system, the tilesets, does not have to change or may have to only be modified slightly.

Feasibility of Control with Timing. The feasibility of providing adequate control using tiles/discrete tiles is based on the controlled system being engineered/designed to be controllable under manual control and the piece-wise continuous behavior of physical systems. These aspects imply three useful properties for the controlled system, namely it:
1. is relatively stable;
2. is relatively predictable; and/or
3. has a relatively small number of discontinuity points to be concerned with, and they are known.

The first aspect, stability, means that the system is able to operate reasonably with the same settings of control across some significant variation of inputs. That is, it is designed to be stable within certain operating parameters. For example, a slight change in airspeed of an aircraft, say because of headwind, does not require an immediate change on controls to avoid loss of control of the aircraft. Otherwise, it would be infeasible for a human to control the system. That is, if a slight decrease in airspeed required an immediate rapid change in control variables to maintain control, a human operator could not operate the controlled system.

Similarly, a small change in some control variable does not normally destabilize the controlled system. Otherwise, a human operator could destabilize the controlled system by a slight error in setting the controls. This also means that normally, if the logical objective determined by the tile is feasible at each vertex of a tile, it is feasible/acceptable at any points within the tile. This is because a small incremental change in any input does not normally require a change in control values. Otherwise, in manual operation, the controlled system would require significant rapid actions by the operator.

This intrinsic physical smoothing allows the controlled system to be efficiently controlled by suitable discrete decisions and discrete sequencing, relying on a subcomponent level such as a PID controller for fine-grain tunings. Some of the smoothing is provided by the intrinsic delay between changing the actuator settings and achieving the desired end result with the controlled system. Therefore, this separation into logical objective decision and logical objective sequencer does not introduce latency beyond what is necessarily present because of this indirect effort of the actuator. Moreover, the sequencing provided by the sequencers ensures smooth operation even with significant discrete changes to the logical objective.

The second aspect, predictability, means that the system behavior is predictable in the sense that the result of changing some control variable in a particular way has a known effect. Therefore, the control system may know in advance what changes to the control variables are necessary to achieve a particular end result. For instance, increasing the throttle and increasing the pitch of the aircraft normally causes an increase in altitude. Similarly, an incremental increase in the aileron angle results in an incremental increase in the rate of roll. Therefore, the control setting for a tile for a given controlled system state, as indicated by the inputs, may be determined in advance. That is, labeling the tiles in advance is feasible.

The system behavior is also predictable in the sense that the result of a change normally takes place over a somewhat predictable period of time. For example, changing to full throttle from a stop normally takes an aircraft on the ground from stopped to take-off speed in a documented period of time, dependent to some degree on head winds and cargo load. The performance is also predictable in that the changes resulting from a change in control variables normally takes place smoothly over time. That is, an aircraft on take-off does not suddenly change from one velocity to another. This is intrinsic because an instantaneous change requires effectively infinite acceleration which is impossible. These properties arise because a physical system, particularly, an engineered one, is piece-wise continuous in behavior.

The third aspect, limited discontinuities, means that exceptions to this stable predictable continuous behavior are known and relatively small in number. Because there are a small number of such exceptions or instability and they are known, the occurrence of an exception may be handled by a separate tile without causing an excessive number of tiles. For example, a completely separate tile may be provided to match in a wing stall condition and have a completely different label and effect on the controls to handle this exception condition. There are relatively few singularities that may arise with an aircraft. The engineer designing the controlled system and the user operator both need to be aware of all of them so it is practical to represent these in the disclosed control system. Note that it is not necessary to verify that transitions between tiles cause the controlled system to perform adequately, for several reasons:
1. The set of tile labels is chosen to provide adequate control of the controlled system to efficiently achieve the intent;
2. The tile label selection ensures that the tile label is a reasonable logical objective for the controlled system, so a transition from one tile to another is a transition from one safe setting to another. The prediction/simulation mechanism for the controlled system detects if some tile, and its associated input range, is not achieving adequate performance. It would then split the associated input tile until the tile label is adequate at all of its vertices;
3. The separate sequencer per actuator ensures smooth operation and transition between tiles in any case; and/or
4. A transition may be limited to an adjacent tile within the tileset. This is because the actual change in the controlled system cannot be so large as to transition beyond an adjacent tile, using suitably large tiles, as provided by the tile generation and the adaptability provided by the sequencer portions.

Therefore, there is no transition within a tileset that is not safe or efficient and/or comfortable, in the normal case. The transitions between tilesets with different input logical objectives are checked for adjacency and suitable input conditions based on the boundary tiles. That is, the TCM may report an error if the change in input logical objectives is not supported or the inputs map to a boundary tile indicating the inputs are outside that supported for this input logical objective.

On the testing aspect, each vertex, with margin especially, is effectively a member of each of its impinging tiles so by the above evaluation, the controlled system is adequately controlled with the label of impinging tile.

Not needing to verify every tile transition comprises feasibility because with K input dimensions, there is 2^{k-1} different transitions per vertex, assuming transitions just to the adjacent/impinging tiles. This number becomes a large number of tests, given there are 2K vertices per tile and a large number of tiles. For example, with k equal to 10, that is 10 input dimensions, testing transitions may increase the number of tests by a factor of over 1000.

In summary, a controlled system such as a self-driving car or autonomous airplane needs to be designed to be stable and predictable with a relatively small number of discontinuities and these discontinuities need to be known to allow for human/manual operation. These properties are provided by the careful engineering of the controlled system and they allow for a tile-based TSIR approach as described herein. The separation of control decision from execution using a logical objective-directed sequencer reduces the complexity and number of tiles required and allows fine-grain tuning/tracking mechanisms such as the PID controller technology to be practical in implementation.

Executive Summary. One important idea as described herein is taking complex control and decomposing it into at least two pieces: Temporal sequencing, wherein a temporal sequence is a sequence of controlled actions over time, and an immediate redecider which informally asks “which temporal sequence should currently be executed?”

Simple vs Complex Control. Simple control traditionally assumes no faults in a controlled system and no unpredictable externalities and no temporal/resource limitations. For example, there may be no dynamic obstacles or no faults in vehicles. Inputs may just be the process variables. Control may just implement the operating sequences designed as part of engineering. Examples of simple control include traditional autopilots for an air-based vehicle, or adaptive cruise control and/or lane departure warning/lane keeping/lane centering systems on a ground-based vehicle.

By contrast, complex control such as controlling an autonomous ground-based vehicle/an autonomous air-based vehicle/an autonomous space-based vehicle/an autonomous water-based vehicle comprises faults, externalities, and/or temporal limitations. There may be a need to deal with: unpredictable externalities such as other vehicles or inclement weather; detecting and responding to internal faults; and/or detecting not enough fuel to reach a destination. These inputs may be out of a user's control and difficult to know: what obstacles are around the vehicle and what is their behavior; what faults are occurring in the vehicle and what are the impacts; and/or how much fuel is available to reach a destination. Note that the inputs from the process variables are only a subset of the required inputs.

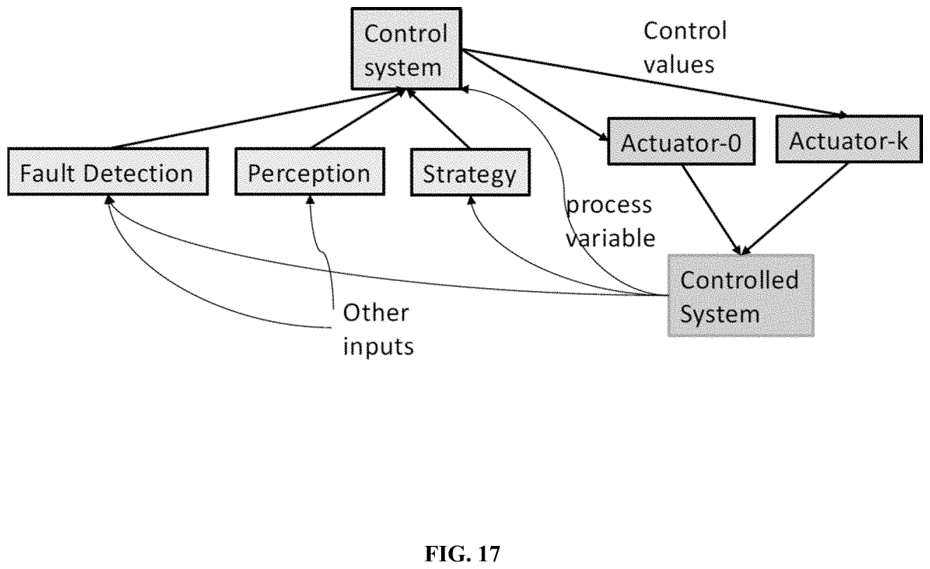

Delegation to Simplify Complex Control. FIG. 17 is an illustration of delegation to simplify complex control. As shown in FIG. 17, delegation includes delegation of fault detection to a separate fault detection subsystem; delegation of perception (of external objects) to a perception subsystem; and delegation of strategy to a separate strategy subsystem, wherein each provides a pre-processed “need-to-know” input to the control system.

In one embodiment, a control system produces control values for passing to actuators, which assert to the individual controlled elements actual control. Delegation of complex systems is analogous to delegation in operating systems down to basic device drivers, for example, at the filesystem level, if a filesystem decides to write a given block to a given disc at a given location, the device driver can be accessed by a programming interface from the filesystem to tactically write it for a particular disc hardware.

Fault detection may be delegated to a separate system, which may use for example automated root cause analysis to look at the controlled system and periodically assess whether everything is performing without issue, and if not, determine the fault and/or root cause. Perception may also be delegated away from control and assess, for example, external traffic in the area and its location. Strategy may also be delegated as a longer term element. One aspect of strategy is navigation as a longer term decision that takes place over a long period of time. Each of the delegation elements may have different time scales. By contrast to a bottom-up approach in traditional control theory, where the instructions/actuators work their way up from setting control variables, and for example a PID controller that sets them, and then an overarching controller for PID controllers, the delegated system permits an element that is strategic, analogous to a CEO role for a corporation.

Provide Immediate Reaction to Discontinuities. A discontinuity, when a situation has suddenly changed significantly, often requires an immediate or near-immediate reaction. An example includes conflicting traffic suddenly appears in front, with a need to go from cruising to hard braking quickly/swerving. Discontinuities have a need to avoid phantom reactions, and severe frequent unnecessary reactions for the example of vehicular complex controlled systems are hard on vehicles, passengers, and/or cargo. Note that control reaction time is additive to perception processing time, and may need to be integrated with smooth operation outside of discontinuities, that is “normal” operation rather than being a separate control system.

A traditional analogy may be an emergency system that may implement an emergency brake. The tension is having two automated “brains” driving a car, where one like an adaptive cruise control is not smart enough to recognize an emergency, but the other one like an emergency system is smart enough to recognize an emergency, but cannot do normal driving. It may not be easy to resolve which brain wins in a given situation, especially for in between situations where in traffic, a car pulling out may not warrant a hard brake via the emergency system, wherein a human pilot might change lanes to get around the car pulling out.

Control Theory may not be Fully Adequate/Useful. Note the control theory focuses on a continuous control system, such as “continuous” in the mathematical sense, because the controlled system is “continuous”. For example, continuously increasing brake pressure continuously/smoothly increases the de-acceleration. Control theory also may assume feedback, for example as a process variable, is fast and reliable.

One issue with control theory is real-world systems may only be piece-wise continuous. For example, hard braking may lock up wheels so there is little or no de-acceleration. Discontinuities are often the most critical to recognize/handle/react to quickly, for example, when an obstacle suddenly appears in front of a vehicle being piloted. Discontinuities require discrete/non-continuous changes in control, not continuous changes, that is to quickly switch to totally different behavior. Faults and external changes may cause discontinuities and unreliable feedback. Thus control may have to be discrete at discontinuities. As described herein, one improvement in consistency is to make control discrete in the easy cases, the continuous regions or other regions of “normal”/cruising control.

Temporal Control Sequence. One important observation is that a controlled system is typically engineered to go through a sequence over time to achieve an objective. For example, to accelerate an automobile a sequence may be to “move left”, “follow lane”, and “adjust speed to merge onto a freeway”. The sequence may include performing a series of steps over time with each step waiting for the precondition for a next step to become true. For example, to continue the automobile example, one may “move left” only after the car is parallel with an opening in the left lane.

A general sequence is designed/known as part of the engineering design of the controlled system, for example, the engineer of an automobile or an airplane. A human driver is taught how to merge onto the freeway using a sequence. It is thus practical that the parameters of the sequence to be computed, for example waypoints, may be used with the sequence for automated control. Multiple control sequences may then be used with an automated complex controlled system.

Solution to Complex Control. By separating the control system into a temporal sequencer and an immediate decider/redecider, the sequencer explicitly implements the set of control sequences. Each sequence may rely on the controller portion to translate logical objectives into specific control values. The redecider may decide which sequence to execute, redeciding quickly if conditions change such that a different sequence should be executed. Delegation provides an improvement to make the automated control practical by simplifying the redecider by delegating sequencing to the sequencer, and simplifying the sequencer by delegating decision on sequence to the redecider.

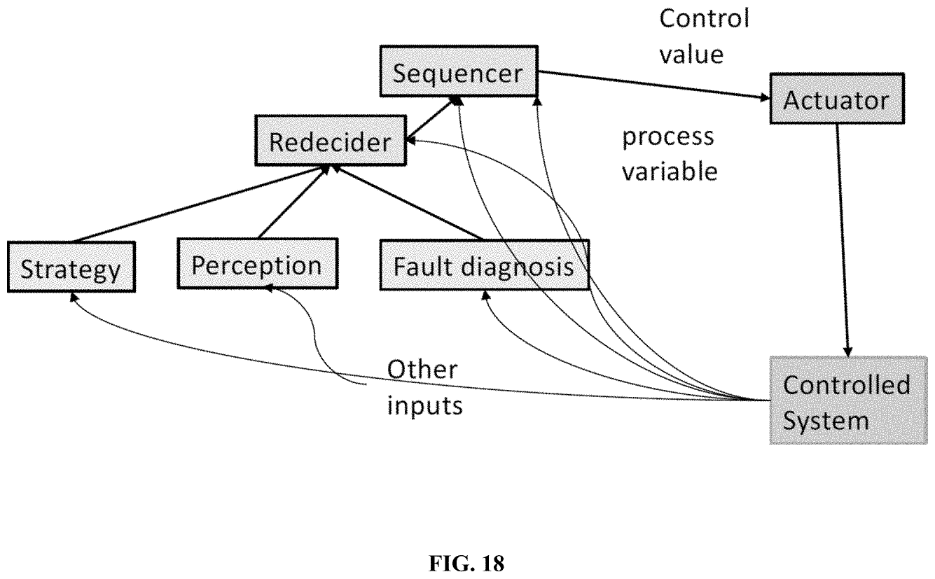

Temporal Sequencer-Immediate Redecider Delegation-based Control. FIG. 18 is an illustration of a temporal sequencer-immediate redecider delegation-based control to simplify complex control. As shown in FIG. 18, the TSIR delegation-based control includes: a controller which delegates to a sequencer to implement sequencing; a sequencer which delegates to a redecider to decide on a current sequence; and/or a redecider which delegates determining fault diagnosis, perception, and strategy to separate subsystems. Note that this may invert the hierarchy vs. conventional control thinking.

TSIR Roles. As described above, a temporal sequencer may assign parameters and then execute a sequence of steps, selected out of the set of sequences defined as part of engineering the original system, over time. For example, for an autonomous car, moving to a passing lane, passing another car, and merging back. This sequence is needed because no goal is achieved with the control system instantaneously, so there is a need for steps. One example is a sequence for passing on the left in an opposing lane. The temporal sequencer may also write control variables each timestep to adjust to a specified target. One example is how much throttle to achieve/maintain for a specified speed.

As described above, an immediate redecider may on each timestep, redecide on a control sequence to be executed by the sequencer. If the sequence is the same as a current sequence/objective, the sequence is continued at the current step. If the current objective is no longer appropriate or achievable, (re)deciding on a new sequence/objective is performed.

Note that the sequencer may be considered “dumb” as it relies on the redecider to decide if conditions warrant change. For example, an approaching vehicle in the opposing lane is close means aborting the “pass on the left in opposing traffic” sequence. That is, a redecider switches at the next (millisecond) timestep to specify the “merge-to-right-lane” sequence.

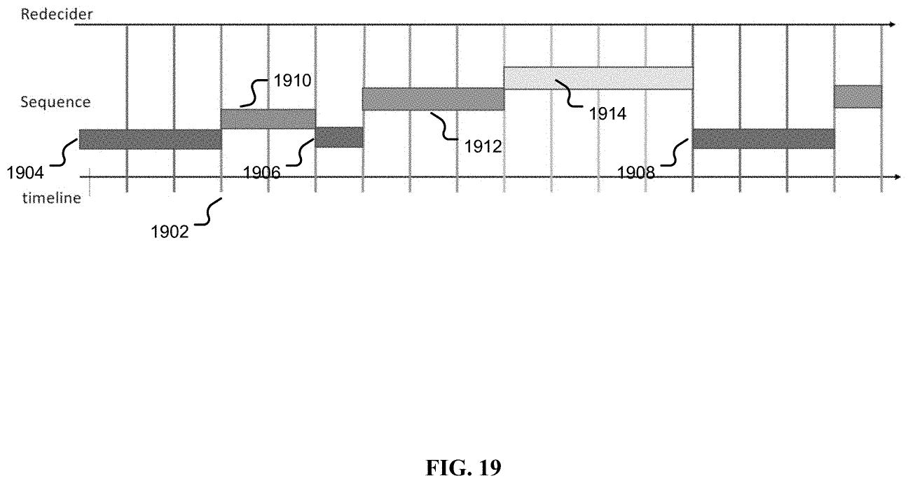

Redecider-Sequencer Time Line. FIG. 19 is an illustration of a redecider-sequencer time line. As shown in FIG. 19, the redecider may generate a decision on the sequence every timestep. If it is the same decision as a last timestep, the current sequence continues. If it is a different decision, the new sequence starts immediately. A redecider may need to know the time for a sequence to complete from its start.

As shown in FIG. 19, each vertical line such as line (1902) represent a regular time interval, such as 10 ms. The sequence chosen is the one shaded, for example, starting at the first time at the left of the graph with sequence (1904), which may be a “cruising” sequence, and is the same sequence as sequence (1906) and (1908). The immediate redecider may see a potential discontinuity and switches to “bank left” sequence (1910) to avoid an obstacle, but then returns to “cruise” sequence (1906) after, then switches to a “bank right” sequence (1912), and “accelerate temporarily” sequence (1914) to return on course, eventually returning to “cruise” (1908).

Delegation View of Control. As described above, a sequencer as the writer of control values is a “real controller” in that it controls the system because it controls actuators. Note that a sequencer may perform a sequence of steps over time, subject to conditions, and each step may refine/revise control values, as the sequencer delegates selection of the sequence to perform and parameters to a redecider module.

As described above, a redecider module revisits a decision every timestep based on inputs, in particular, the uncontrolled inputs such as faults, externalities, and/or timing. Note that a redecider may delegate preprocessing of some inputs to separate subsystems, for example, delegating fault diagnosis to a separate fault detection subsystem, delegating perception of externalities to a separate perception subsystem, and delegating strategy to a separate subsystem on how to deal with externalities.

Analogy to Internet Delegation Structure. One analogy to help describe delegation is a computer network delegation model for the Internet. The IP layer is the “real” communication layer that moves data using a “best effort”, wherein externalities (other traffic) and faults may cause it to fail. The IP layer delegates fault detection, retransmission, rate control, and packetization to the TCP layer. The TCP layer handles “sequencing”, and itself delegates name to host mapping to DNS, as the TCP layer delegates navigation/routing to a meta-strategy layer. Furthermore the TCP layer delegates connection failure to an application layer. Note that as the Internet has faults and externalities like other traffic, it also requires the same complex control and delegation as that described herein.

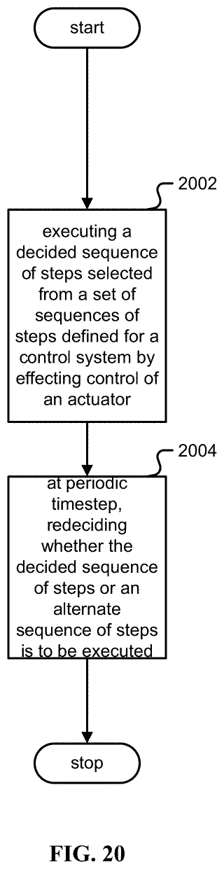

FIG. 20 is a flow diagram illustrating an embodiment of a process for autonomous control of complex engineered systems. In one embodiment, the process of FIG. 20 is carried out by a control system, for example (322j) of FIG. 4A, (372) of FIG. 4B, or any system, for example, FIG. 1.

In step (2002), a decided sequence of steps selected from a set of sequences of steps defined for a control system to effect control of an actuator is executed. In one embodiment, execution includes writing the control variable to the actuator, for example to adjust to a specific target at a specified timestep. In one embodiment, the duration between timesteps is designed based at least in part on an ability to react quickly to anomalous or discontinuous situations. In one embodiment, a plurality of sequences in the set of sequences of steps is pre-determined prior to an operation of the control system. In one embodiment, the plurality of sequences in the set of sequences of steps is based at least in part on an engineering specification of the control system. In one embodiment, the plurality of sequences in the set of sequences of steps provides efficient stable reliable control under normal circumstances.

In one embodiment, a sequence of steps from the set of sequences of steps is based at least in part on an engineering specification of the control system, which may be designed based at least in part on providing efficient stable reliable control under normal circumstances.

In one embodiment, execution comprises executing the decided sequence of steps selected from the set of sequences of steps defined for the control system by writing a coupled control variable to a coupled actuator. In one embodiment, writing the control variable to the actuator and writing the coupled control variable to the coupled actuator is based at least in part on having a decision result map to a vector of decision values, one entry for each actuator.

In step (2004), at a periodic timestep, for example each timestep, it is redecided whether the decided sequence of steps or an alternate sequence of steps is to be executed. In one embodiment, redeciding is based at least in part on new input data. In one embodiment, redeciding is based at least in part on a determination of a discrete logical objective.

In one embodiment, redeciding is based at least in part on determining a tileset, wherein the tileset has a number of dimensions matching a number of inputs, and wherein each tile is associated with a label sequence such that executing the label sequence with associated tile sensor inputs at a current time is sufficient to provide control of the control system at the current time.

In one embodiment, prematching is used, wherein prematching determines a match in the event a current tile input maps to a tile matched in a previous time when extended in one or more tile dimensions by a margin, at least in part to damp out oscillations. In one embodiment, a tile is associated with each conjunction of ranges defined by thresholds on inputs, one range from each input.

In one embodiment, redeciding is based at least in part on a prediction mechanism of the control system based at least in part on providing efficient stable reliable control under normal circumstances. In one embodiment, the prediction mechanism comprises using a dynamic simulation.

In one embodiment, redeciding is based at least in part on a training set of data. In one embodiment, the control system controls at least one of the following: an autonomous complex controlled system; an autonomous ground-based vehicle; an autonomous air-based vehicle; an autonomous space-based vehicle; and an autonomous water-based vehicle.

In one embodiment, redeciding further comprises providing a parameter range for the redecided sequence of steps to be executed by the temporal sequencer. In one embodiment, redeciding further comprises refining a parameter value within the parameter range based at least in part on a dynamic simulation of the controlled system over a relevant period of time. In one embodiment, redeciding further comprises refining a parameter value within the parameter range based at least in part on a midpoint of the parameter range and a last parameter value from a last timestep.

In one embodiment, executing a decided sequence of steps includes using a dynamically adaptive temporal sequence. In one embodiment, executing a decided sequence of steps includes adjusting actual output control values based on additional inputs.

In one embodiment, a plurality of sequences in the set of sequences of steps is pre-determined prior to an operation of the control system, and wherein the plurality of sequences are dynamically adaptive temporal sequences.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A control system including:
a temporal sequencer that executes a decided sequence of steps selected from a set of sequences of steps defined for the control system to effect reasonable control of an actuator; and
an immediate redecider that, at a periodic timestep, redecides whether the decided sequence of steps or an alternate sequence of steps is to be executed by the temporal sequencer.

2. The control system of claim 1, wherein the temporal sequencer effects writing a control variable to the actuator.

3. The control system of claim 1, wherein the immediate redecider redecides based at least in part on new input data.

4. The control system of claim 1, wherein the immediate redecider redecides based at least in part on a determination of a discrete logical objective.

5. The control system of claim 1, wherein the control system controls at least one of the following: an autonomous complex controlled system; an autonomous ground-based vehicle; an is autonomous air-based vehicle; an autonomous space-based vehicle; and an autonomous water-based vehicle.

6. The control system of claim 1, wherein a duration between timesteps is designed based at least in part on an ability to react quickly to anomalous or discontinuous situations.

7. The control system of claim 1, wherein a plurality of sequences in the set of sequences of steps is pre-determined prior to an operation of the control system.

8. The control system of claim 7, wherein the plurality of sequences in the set of sequences of steps is based at least in part on an engineering specification of the control system.

9. The control system of claim 7, wherein the plurality of sequences in the set of sequences of steps provides efficient, stable, reliable control under normal circumstances.

10. The control system of claim 1, wherein the immediate redecider redecides based at least in part on determining a tileset, wherein the tileset has a number of dimensions matching a number of inputs, and wherein each tile is associated with a label sequence such that executing the label sequence with associated tile inputs at a current time is sufficient to provide reasonable control of the control system at the current time.

11. The control system of claim 10, further comprising a prematcher, wherein the prematcher determines a match in the event a current tile inputs maps to a tile matched in a previous timestep when extended in one or more tile dimensions by a margin at least in part to damp out oscillations.

12. The control system of claim 10, wherein a tile is associated with each conjunction of ranges defined by thresholds on inputs, one range from each input.

13. The control system of claim 1, wherein the immediate redecider redecides based at least in part on a prediction mechanism of the control system based at least in part on providing efficient stable reliable control under normal circumstances.

14. The control system of claim 13, wherein the prediction mechanism comprises using a dynamic simulation.

15. The control system of claim 1, wherein the immediate redecider redecides based at least in part on a training set of data.

16. The control system of claim 2, wherein the temporal sequencer is further configured to execute the decided sequence of steps selected from the set of sequences of steps defined for the control system by effecting writing of a coupled control variable to a coupled actuator.

17. The control system of claim 16, wherein writing the control variable to the actuator and writing the coupled control variable to the coupled actuator is based at least in part on having a decision result map to a vector of decision values, one entry for each actuator.

18. The control system of claim 1, wherein the immediate redecider is further configured to provide a parameter range for the redecided sequence of steps to be executed by the temporal sequencer.

19. The control system of claim 18, wherein the temporal sequencer is further configured to refine a parameter value within the parameter range based at least in part on a dynamic simulation of the control system over a relevant period of time.

20. The control system of claim 18, wherein the temporal sequencer is further configured to refine a parameter value within the parameter range based at least in part on a midpoint of the parameter range and a last parameter value from a last timestep.

21. The control system of claim 1, wherein executing a decided sequence of steps includes using a dynamically adaptive temporal sequence.

22. The control system of claim 1, wherein executing a decided sequence of steps includes adjusting actual output control values based on additional inputs.

23. The control system of claim 1, wherein a plurality of sequences in the set of sequences of steps is pre-determined prior to an operation of the control system, and wherein the plurality of sequences are dynamically adaptive temporal sequences.

24. A method, comprising:
executing a decided sequence of steps selected from a set of sequences of steps defined for a control system to effect reasonable control of an actuator; and
at a periodic timestep, redeciding whether the decided sequence of steps or an alternate sequence of steps is to be executed.

25. A computer program product embodied in a non-transitory computer readable medium and comprising computer instructions for:
executing a decided sequence of steps selected from a set of sequences of steps defined for a control system to effect reasonable control of an actuator; and
at a periodic timestep, redeciding whether the decided sequence of steps or an alternate sequence of steps is to be executed.
